(19) United States
(12) Patent Application Publication
(10) Pub. No.: US 2005/0084013 A1
(43) Pub. Date: Apr. 21, 2005

(54) Frequency coefficient scanning paths

(76) Inventors: Limin Wang, San Diego, CA (US); Yue Yu, San Diego, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/686,465

(22) Filed: Oct. 15, 2003

(51) Int. Cl. H04N 7/12

(52) U.S. Cl. 375/240.18; 375/240.24

(57) ABSTRACT

A method of scanning frequency coefficients from an original two dimensional array into a one dimensional array of the frequency coefficients. The frequency coefficients correspond to pixels in a block that are to be encoded. The method includes dividing the original two dimensional array of the frequency coefficients into a number of four by four blocks of frequency coefficients and successively scanning the frequency coefficients in each of the number of four by four blocks with a pre-determined scanning order starting at 0 and ending at 15.

### RELATED APPLICATIONS

The present application claims priority under 35 U.S.C. § 119(e) from the following previously-filed Provisional Patent Application, U.S. Application No. 60/416,139, filed Oct. 4, 2002 by Limin Wang et al., entitled “Scans for ABT+CAVLC,” and which is incorporated herein by reference in its entirety.

### BACKGROUND

Video compression is used in many current and emerging products. It is at the heart of digital television set-top boxes (STBs), digital satellite systems (DSSs), high definition television (HDTV) decoders, digital versatile disk (DVD) players, video conferencing, Internet video and multimedia content, and other digital video applications. Without video compression, the number of bits required to represent digital video content can be extremely large, making it difficult or even impossible for the digital video content to be efficiently stored, transmitted, or viewed.

Digital video content comprises a stream of pictures that can be displayed as an image on a television receiver, computer monitor, or some other electronic device capable of displaying digital video content. A picture that is displayed in time before a particular picture is in the “backward direction” in relation to the particular picture. Likewise, a picture that is displayed in time after a particular picture is in the “forward direction” in relation to the particular picture.

Video compression is accomplished in a video encoding, or coding, process in which each picture is encoded as either a frame or as two fields. Each frame comprises a number of lines of spatial information. For example, a typical frame contains 480 horizontal lines. Each field contains half the number of lines in the frame. For example, if the frame comprises 480 horizontal lines, each field comprises 240 horizontal lines. In a typical configuration, one of the fields comprises the odd numbered lines in the frame and the other field comprises the even numbered lines in the frame. The field that comprises the odd numbered lines will be referred to as the “top” field hereafter and in the appended claims, unless otherwise specifically denoted. Likewise, the field that comprises the even numbered lines will be referred to as the “bottom” field hereafter and in the appended claims, unless otherwise specifically denoted. The two fields can be interlaced together to form an interlaced frame.

The general idea behind video coding is to remove data from the digital video content that is “non-essential.” The decreased amount of data then requires less bandwidth for broadcast or transmission. After the compressed video data has been transmitted, it must be decoded, or decompressed. In this process, the transmitted video data is processed to generate approximation data that is substituted into the video data to replace the “non-essential” data that was removed in the coding process.

Video coding transforms the digital video content into a compressed form that can be stored using less space and transmitted using less bandwidth than uncompressed digital video content. It does so by taking advantage of temporal and spatial redundancies in the pictures of the video content. The digital video content can be stored in a storage medium such as a hard drive, DVD, or some other non-volatile storage unit.

There are numerous video coding methods that compress the digital video content. Consequently, video coding standards have been developed to standardize the various video coding methods so that compressed digital video content may be rendered in formats that a majority of video encoders and decoders recognize. For example, the Motion Picture Experts Group (MPEG) and International Telecommunication Union (ITU-T) have developed video coding standards that are in wide use. Examples of these standards include the MPEG-1, MPEG-2, MPEG-4, ITU-T H.261, and ITU-T H.263 standards.

However, as the demand for higher resolutions, more complex graphical content, and faster transmission time increases, so does the need for better video compression methods. To this end, a new video coding standard is currently being developed. This new video coding standard is called the MPEG-4 Part 10 Advanced Video Coding (AVC)/H.264 standard.

Most modern video coding standards, including the MPEG-4 Part 10 AVC/H.264 standard, are based in part on universal variable length codeword (UVLC) coding, context-based adaptive variable length coding (CAVLC), or context-based adaptive binary arithmetic coding (CABAC). In UVLC coding, a UVLC table with fixed entries is used to encode and decode the syntax, or events, associated with a particular picture, slice, or macroblock. CAVLC, on the other hand, uses a table with entries that are varied based on the syntax associated with the picture, slice, or macroblock that is to be encoded or decoded. UVLC, CAVLC, and CABAC are all explained more detail in the MPEG-4 Part 10 AVC/H.264 standard.

Most modern video coding standards, including the MPEG-4 Part 10 AVC/H.264 standard, are based in part on a temporal prediction with motion compensation (MC) algorithm and on a transform domain coding algorithm.

Temporal prediction with motion compensation is used to remove temporal redundancy between successive pictures in a digital video broadcast. The temporal prediction with motion compensation algorithm typically utilizes one or two reference pictures to encode a particular picture. By comparing the particular picture that is to be encoded with one of the reference pictures, the temporal prediction with motion compensation algorithm can take advantage of the temporal redundancy that exists between the reference picture and the particular picture that is to be encoded and encode the picture with a higher amount of compression than if the picture were encoded without using the temporal prediction with motion compensation algorithm. One of the reference pictures is in the backward direction in relation to the particular picture that is to be encoded. The other reference picture is in the forward direction in relation to the particular picture that is to be encoded.

Transform domain coding is used to remove spatial redundancy within each picture or temporally predicted residual picture. A residual picture is the difference between a picture and a picture that is temporally predicted from that picture. Each picture or temporally predicted residual picture comprises a number of blocks of pixels. Each block refers to an N by M group of pixels where N refers to the number of columns of pixels in the block and M refers to the number of rows of pixels in the block. Each block in the picture or temporally predicted residual picture is represented by an N by M array of luminance and chrominance coefficients which correspond to each pixel in the blocks' N by M grid of pixels. Each luminance coefficient represents the brightness level, or luminance, of its corresponding pixel. Each block in the picture or temporally predicted residual picture is also represented by an N by M array of chrominance coefficients which correspond to each pixel in the blocks' N by M grid of pixels. Each chrominance coefficient represents the color content, or chrominance, of its corresponding pixel. The term “picture” will be used hereafter and in the appended claims, unless otherwise specifically denoted, to mean either a picture or a temporally predicted residual picture.

Most pictures have smooth color variations, with the fine details being represented as sharp edges in between the smooth variations. The smooth variations in color can be termed as low frequency variations and the sharp variations as high frequency variations. The smooth variations in color, or low frequency components of the picture, constitute the base of an image. The edges which give detail to the picture, or high frequency components, add upon the smooth variations in color to refine the picture. The combination of low and high frequency components results in a detailed image.

Typically, the values of luminance and chrominance coefficients only vary slightly between most of the pixels in a particular picture. Consequentially, in many pictures, most pixels contain more low frequency components than high frequency components. In other words, most of the energy of a signal containing the digital video content lies at low frequencies.

Transform domain coding takes advantage of the fact that most of the energy of a signal containing the digital video content lies at low frequencies. Transform domain coding transforms the luminance coefficients in each N by M array from the spatial domain to the frequency domain. The transformed N by M array comprises coefficients which represent energy levels in the frequency domain. As used hereafter and in the appended claims, unless otherwise denoted, the coefficients of the transformed N by M array will be referred to as “frequency coefficients.” Once the luminance and chrominance coefficients have been transformed into frequency coefficients, various compression techniques can then be performed on the contents of picture in the frequency domain that would otherwise be impossible to perform in the spatial domain.

The N by M array of frequency coefficients is two dimensional and must be converted into a one dimensional array of frequency coefficients so that an encoder can use the frequency coefficients to encode a picture, slice, or macroblock. The encoder generates the one dimensional array of frequency coefficients by scanning the two dimensional array of frequency coefficients using a particular scanning path. The scanning path refers to the order in which the frequency coefficients in the two dimensional array are scanned and output by the encoder into the one dimensional array. A decoder may then decode the one-dimensional array of frequency coefficients. After they are decoded, the frequency coefficients are typically mapped back into a two dimensional array of frequency coefficients.

If a picture is to be coded using UVLC, its frequency coefficients can be scanned from various block sizes of frequency coefficients. However, CAVLC is currently only designed for four by four arrays of frequency coefficients. Thus, there is a need in the art to scan larger block sizes than 4 by 4 pixels that are going to be coded using CAVLC.

### SUMMARY

In one of many possible embodiments, the present invention provides a method of scanning frequency coefficients from an original two dimensional array into a one dimensional array of the frequency coefficients. The frequency coefficients correspond to pixels in a block that are to be encoded. The method includes dividing the original two dimensional array of the frequency coefficients into a number of four by four blocks of frequency coefficients and successively scanning the frequency coefficients in each of the, number of four by four blocks with a pre-determined scanning order starting at 0 and ending at 15.

Another embodiment of the present invention provides an encoder and decoder for scanning the frequency coefficients from a two dimensional array into a one dimensional array and for mapping the frequency coefficients from the one dimensional array back into the two dimensional array, respectively.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an exemplary sequence of three types of pictures according to an embodiment of the present invention, as defined by an exemplary video coding standard such as the MPEG-4 Part 10 AVC/H.264 standard.

FIG. 2 shows that each picture may be divided into slices consisting of macroblocks, according to an embodiment of the present invention.

FIG. 3 shows that a macroblock may be further divided into smaller sized blocks, according to an embodiment of the present invention.

FIG. 4 is a flow chart illustrating an exemplary method of transform domain coding of a block's N by M array of luminance coefficients, according to an embodiment of the present invention.

FIG. 5 shows a scanning path and an alternate scanning path that are preferably used to scan frequency coefficients from a 4 by 4 two dimensional array of frequency coefficients to a one dimensional array of frequency coefficients, according to an embodiment of the present invention.

FIG. 6 illustrates that the scanning path may be applied to a 4 by 8 pixel block's frequency coefficient array to scan all of its 32 frequency coefficients in frame mode, according to an embodiment of the present invention.

FIG. 7 illustrates that the scanning path may be applied to an 8 by 4 pixel block's frequency coefficient array to scan all of its 32 frequency coefficients in frame mode, according to an embodiment of the present invention.

FIG. 8 illustrates that the scanning path may be applied to an 8 by 8 pixel block's frequency coefficient array to scan all of its 64 frequency coefficients in frame mode, according to an embodiment of the present invention.

FIG. 9 illustrates that the scanning path may be applied to an 8 by 16 pixel block's frequency coefficient array to scan all of its 128 frequency coefficients in frame mode, according to an embodiment of the present invention.

FIG. 10 illustrates that the scanning path may be applied to an 8 by 16 pixel block's frequency coefficient array to scan all of its 128 frequency coefficients in frame mode, according to an embodiment of the present invention.

FIG. 11 illustrates that the scanning path may be applied to an 16 by 16 pixel block's frequency coefficient array to scan all of its 256 frequency coefficients in frame mode, according to an embodiment of the present invention.

FIG. 12 illustrates that the alternate scanning path may be applied to a 4 by 8 pixel block's frequency coefficient array to scan all of its 32 frequency coefficients in field mode, according to an embodiment of the present invention.

FIG. 13 illustrates that the alternate scanning path may be applied to an 8 by 4 pixel block's frequency coefficient array to scan all of its 32 frequency coefficients in field mode, according to an embodiment of the present invention.

FIG. 14 illustrates that the alternate scanning path may be applied to an 8 by 8 pixel block's frequency coefficient array to scan all of its 64 frequency coefficients in field mode, according to an embodiment of the present invention.

FIG. 15 illustrates that the alternate scanning path may be applied to an 8 by 16 pixel block's frequency coefficient array to scan all of its 128 frequency coefficients in field mode, according to an embodiment of the present invention.

FIG. 16 illustrates that the alternate scanning path may be applied to an 16 by 8 pixel block's frequency coefficient array to scan all of its 128 frequency coefficients in field mode, according to an embodiment of the present invention.

FIG. 17 illustrates that the alternate scanning path may be applied to an 16 by 16 pixel block's frequency coefficient array to scan all of its 256 frequency coefficients in field mode, according to an embodiment of the present invention.

Throughout the drawings, identical reference numbers designate similar, but not necessarily identical, elements.

### DETAILED DESCRIPTION

A method of scanning frequency coefficients from a two dimensional array of frequency coefficients that are to be encoded into a one dimensional array of frequency coefficients is described herein. The method further entails mapping a one dimensional array of frequency coefficients into a two dimensional array of frequency coefficients after the frequency coefficients have been decoded. In particular, the method may be used to scan frequency coefficients of a 4 by 4 transform array of frequency coefficients. The method may also be used to scan frequency coefficients of a transform array of a large size, such as 4 by 8, 8 by 4, 8 by 8, 8 by 16, 16 by 8, or 16 by 16, for example. The method may be implemented in any digital video coding standard, including the MPEG-4 Part 10 AVC/H.264 video coding standard.

As used hereafter and in the appended claims, unless otherwise denoted, the terms “transform array” and “transform block” will be used interchangeably to refer to an array of frequency coefficients corresponding to a block of pixels.

As noted above, the MPEG-4 Part 10 AVC/H.264 standard is a new standard for encoding and compressing digital video content. The documents establishing the MPEG-4 Part 10 AVC/H.264 standard are hereby incorporated by reference, including the “Joint Final Committee Draft (JFCD) of Joint Video Specification” issued on Aug. 10, 2002 by the Joint Video Team (JVT). (ITU-T Rec. H.264 & ISO/IEC 14496-10 AVC). The JVT consists of experts from MPEG and ITU-T. Due to the public nature of the MPEG-4 Part 10 AVC/H.264 standard, the present specification will not attempt to document all the existing aspects of MPEG-4 Part 10 AVC/H.264 video coding, relying instead on the incorporated specifications of the standard.

Using the drawings, embodiments of the present invention will now be explained.

As shown in FIG. 1, three types of pictures are used in many video coding processes. The three types of pictures are intra (I) pictures (100), predicted (P) pictures (102a,b), and bi-predicted (B) pictures (101a-d). An intra picture (100) provides an access point for random access to stored digital video content. Intra pictures (100) are encoded without referring to reference pictures and can be encoded with moderate compression.

A predicted picture (102a,b) is encoded using an I, P, or B picture that has already been encoded as a reference picture. The reference picture can be in either the forward or backward temporal direction in relation to the P picture that is being encoded. Predicted pictures (102a,b) can be encoded with more compression than the intra pictures (100).

A bi-predicted picture (101a-d) is encoded using two temporal reference pictures. The two temporal reference pictures may be in the same or different temporal direction in relation to the B picture that is being encoded. Bi-predicted pictures (101a-d) can be encoded with the most compression out of the three picture types.

Reference relationships (103) between the three picture types are illustrated in FIG. 1. For example, the P picture (102a) may be encoded using the encoded I picture (100) as its reference picture. The B pictures (101a-d) may be encoded using the encoded I picture (100) and the encoded P pictures (102a,b) is its reference pictures, as shown in FIG. 1. Encoded B pictures (101a-d) may also be used as reference pictures for other B pictures that are to be encoded. For example, the B picture (101c) of FIG. 1 is shown with two other B pictures (101b and 101d) as its reference pictures.

The number and particular order of the I (100), B (101a-d), and P (102a,b) pictures shown in FIG. 1 are given as an exemplary configuration of pictures, but are not necessary to implement the present invention. Any number of I, B, and P pictures can be used in any order to best serve a particular application. The MPEG-4 Part 10 AVC/H.264 standard does not impose any limit to the number of B pictures between two reference pictures nor does it limit the number of pictures between two I pictures.

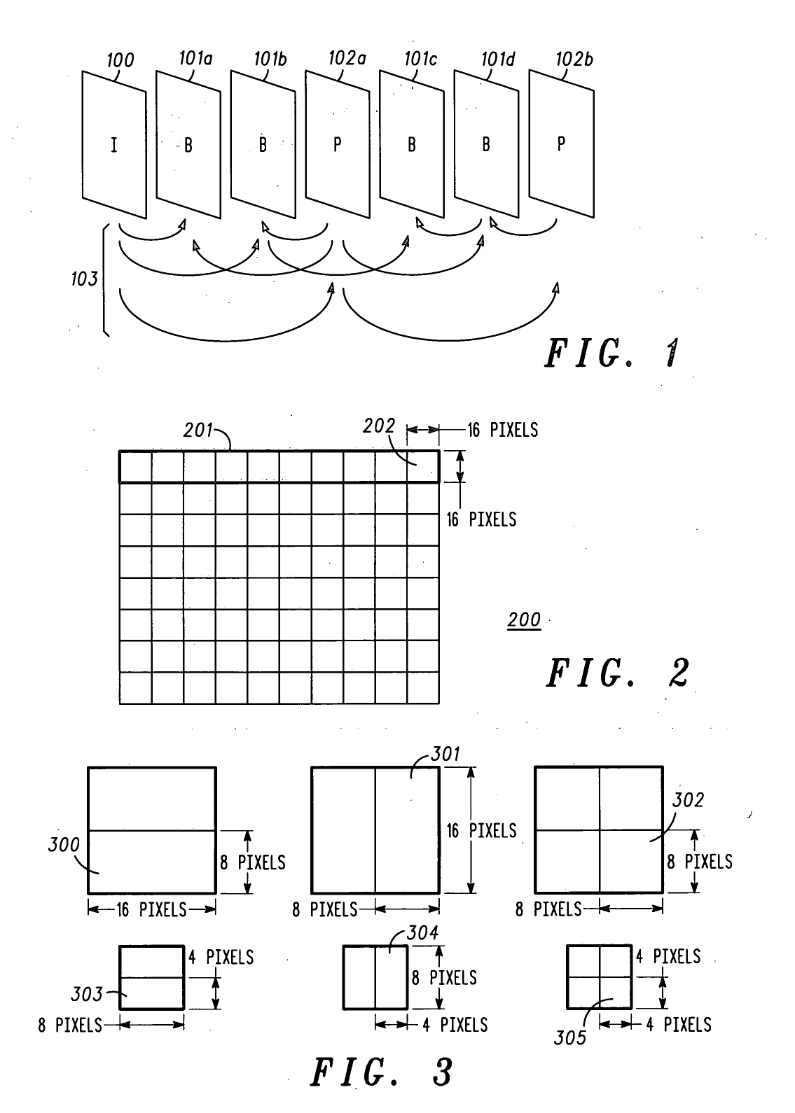

FIG. 2 shows that each picture (200) may be divided into slices consisting of macroblocks. A slice (201) is a group of macroblocks and a macroblock (202) is a rectangular group of pixels. As shown in FIG. 2, an exemplary macroblock (202) size is 16 by 16 pixels.

Each interlaced picture, slice, or macroblock in a stream of pictures that is to be encoded may be encoded using adaptive frame/field (AFF) coding. In AFF coding, each picture, slice, or macroblock in a stream of pictures that is to be encoded is encoded in either frame mode or in field mode, regardless of the encoding mode of the previous picture, slice, or macroblock. If a picture, slice, or macroblock is encoded in frame mode, the two fields that make up an interlaced frame are coded jointly. Conversely, if a picture, slice, or macroblock is encoded in field mode, the two fields that make up an interlaced frame are coded separately. The encoder determines which type of coding—frame mode coding or field mode coding—is more advantageous for each picture, slice, or macroblock and chooses that type of encoding for the picture, slice, or macroblock. The exact method of choosing between frame mode and field mode is not critical to the present invention and will not be detailed herein.

FIG. 3 shows that a macroblock can be further divided into smaller sized blocks for more efficient coding. FIG. 3 shows that an exemplary 16 by 16 pixel macroblock can be further divided into block sizes of 16 by 8 pixels (300), 8 by 16 pixels (301), or 8 by 8 pixels (302). A block size of 8 by 8 pixels (302) can be further subdivided into block sizes of 8 by 4 pixels (303), 4 by 8 pixels (304), or 4 by 4 pixels (305).

A picture that is to be encoded using transform domain coding can sometimes be encoded with better picture quality or more compression efficiency if the transform domain coding is performed on the smaller block sizes of FIG. 3 rather than on the macroblock itself. The transform block size for a macroblock can be fixed or variable. If the transform block size is variable, transform domain coding can be performed on transform blocks of varying sizes. For example, exemplary transform block sizes may be, but are not limited to 4 by 4, 4 by 8, 8 by 4, 8 by 8, 8 by 16,16 by 8, or 16 by 16, depending upon motion and textures of local areas. Transform domain coding on the following block sizes may be implemented according to an embodiment of the present invention: 4 by 4 pixels (305), 8 by 4 pixels (303), 4 by 8 pixels (304), and 8 by 8 pixels (302), 8 by 16 pixels (301), 16 by 8 pixels (300), and 16 by 16 pixels (202). However, as will be understood by one skilled in the art, other pixel block sizes may also be used in transform domain coding.

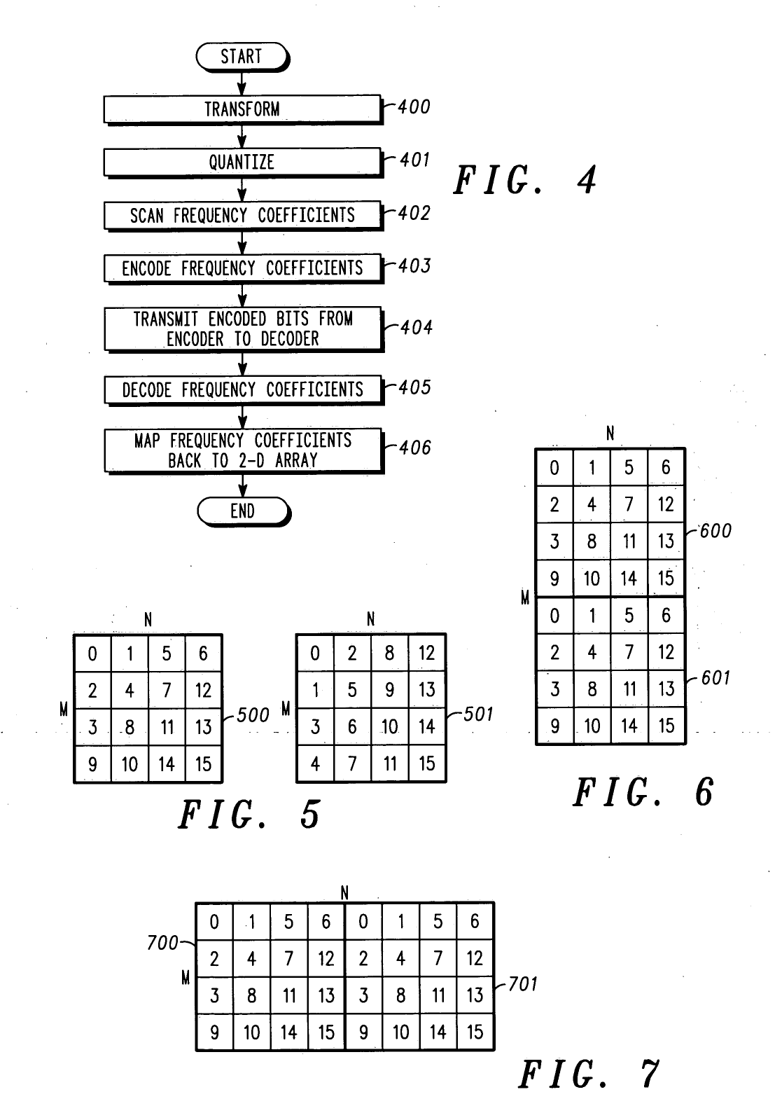

FIG. 4 is a flow chart illustrating an exemplary method of transform domain coding of a block's N by M array of luminance coefficients, according to one embodiment of the present invention. The exemplary method of FIG. 4 will be described using an N by M array of luminance coefficients for explanatory purposes. However, it will be understood that the method of FIG. 4 may also be applied to an N by M array of chrominance coefficients in a like manner. The N by M array of luminance coefficients comprises coefficients that represent the luminance of the pixels in the N by M block. The N by M arrays of luminance coefficients may be, but is not limited to, a 4 by 4 array, 4 by 8 array, 8 by 4 array, an 8 by 8 array, an 8 by 16 array, a 16 by 8 array, or a 16 by 16 array, according to an exemplary embodiment. However, transform domain coding may be performed on any other array size of luminance or chrominance coefficients, as will be understood by one skilled in the art.

As shown in FIG. 4, a block's N by M array of luminance coefficients is first transformed into the frequency domain (step 400). A number of different transforms may be performed according to an exemplary embodiment. For example, a discrete cosine transform (DCT) may be performed on the array of luminance coefficients. The DCT is similar to the discrete Fourier transform. The DCT transforms the N by M array of luminance coefficients from the spatial domain to the frequency domain. The general equation for a two dimensional N by M DCT can be defined by the following equation:

$$F ( u , v ) = {( \frac{2}{N} )}^{1 / 2} {( \frac{2}{M} )}^{\frac{1}{2}} {\sum }_{i = 0}^{N - 1} {\sum }_{j = 0}^{M - 1} Λ ( i ) \cdot Λ ( j ) \cdot cos [ \frac{π \cdot u}{2 \cdot N} ( 2 i + 1 ) ] cos [ \frac{π \cdot v}{2 \cdot M} ( 2 j + 1 ) ] \cdot f ( i , j )$$

$$where Λ ( ξ ) = \{ \begin{matrix}\frac{1}{\sqrt{2}} & for ξ = 0 \\ 1 & otherwise\end{matrix} .$$

In the above equations, f (i, j) represents the luminance value of the pixel in column i and row j of the N by M array of luminance coefficients. F(u, v) is the corresponding frequency coefficient in column u and row v in the N by M array of frequency coefficients. For most images, much of the signal energy lies at low frequencies. In general, the low frequency coefficients appear in the upper left corner of the N by M array of frequency coefficients. The high frequency coefficients usually appear in the lower right corner of the N by M array of frequency coefficients.

After the luminance coefficients have been converted to frequency coefficients by the transform, the frequency coefficients are quantized (step 401), as shown in FIG. 4 Quantization (401) is performed on the frequency coefficients so that the number of bits that must be encoded is reduced. This allows for more compression.

One example of the quantization process consists of dividing each F(u, v) by a constant, q(u,v). A table of q(u,v) is called a quantization table. An exemplary, but not exclusive, quantization table for an 8 by 8 array of frequency coefficients is shown in Table 1 below:

TABLE 1
Eight by eight quantization table

| | | | | | | | |
|---|---|---|---|---|---|---|---|
| 16 | 11 | 10 | 16 | 24 | 30 | 51 | 61 |
| 12 | 12 | 14 | 19 | 26 | 58 | 60 | 55 |
| 14 | 13 | 16 | 24 | 30 | 57 | 69 | 56 |
| 14 | 17 | 22 | 29 | 51 | 87 | 80 | 62 |
| 18 | 22 | 37 | 56 | 68 | 109 | 103 | 77 |
| 24 | 36 | 55 | 64 | 81 | 104 | 113 | 92 |
| 49 | 64 | 78 | 87 | 103 | 121 | 110 | 101 |
| 72 | 92 | 95 | 98 | 112 | 100 | 103 | 99 |

Similar quantization tables may be constructed for the other sizes of the N by M frequency coefficient array. As shown in exemplary quantization table, the constants that divide each F(u, v) are larger in value in the lower right corner of the quantization table than they are in the upper left corner. An important result of the quantization process is that many of the high frequency coefficients are quantized to a value of zero.

Returning to FIG. 4, after the frequency coefficients are quantized, the frequency coefficients are scanned to convert them from a two dimensional array of quantized frequency coefficients to a one dimensional array of quantized frequency coefficients (step 402). According to one embodiment, an encoder performs the scanning of the two dimensional array into the one dimensional array of frequency coefficients. The scanning process, along with preferable scanning paths, will be described in more detail in connection with FIGS. 5-11.

After the quantized frequency coefficients have been scanned into a one dimensional array, they are encoded by an encoder (step 403), as shown in FIG. 4. An exemplary, but not exclusive, encoding process encodes the quantized frequency coefficients in the one dimensional array into a sequence of run-level pairs. The run is defined as the distance between two non-zero quantized frequency coefficients in the one dimensional array. The level is the non-zero value immediately following a sequence of zeros. This type of coding produces a compact representation of the quantized frequency coefficients because a large number of the quantized coefficients have a value of zero. The run-level pairs can be further compressed using entropy coding. The coding may be CAVLC, UVLC, or CABAC, according to an exemplary embodiment. The coding may also be a different type of coding as best serves a particular application.

After the frequency coefficients have been encoded, they may be transmitted to a decoder (step 404). The decoder may be part of a decoding system. The transmission may be over a network such as the Internet, a wide area network (WAN), or a local area network (LAN). In an alternative embodiment, the transmission is over a cable system or is transmitted via satellite. Other modes of transmission may also be used, as will be understood by one skilled in the art.

After the frequency coefficients have been transmitted to the decoder, the decoder may decode the frequency coefficients (step 405). The decoding process is beyond the scope of the present invention and will not be explained in detail. After the frequency coefficients have been decoded, the frequency coefficients are mapped from the one dimensional array back into a two dimensional array (step 406). According to one embodiment, the decoder performs the mapping of step 406. In an alternative embodiment, a system of which the decoder is a part performs the mapping of step 406. The mapping of the frequency coefficients back into a two dimensional array will be described in more detail further below.

FIG. 5 shows a scanning path (500) and an alternate scanning path (501) that are preferably used to scan quantized frequency coefficients from a 4 by 4 two dimensional transform array of quantized frequency coefficients to a one dimensional array of quantized frequency coefficients. The scanning path (500) is preferably used to scan frequency coefficients that represent a picture, slice, or macroblock that is to be coded in frame mode (frame coding). The alternate scanning path (501) is preferably used to scan frequency coefficients that represent a picture, slice, or macroblock that is to be coded in field mode (field coding).

As shown in FIG. 5, scanning path (500) is used to scan frequency coefficients of a 4 by 4 transform array corresponding to a 4 by 4 block of pixels that is to be coded in frame mode, where N=4 and M=4. The numbers in scanning path (500) represent the frequency coefficient scanning order. For example, the frequency coefficient corresponding to the top left pixel is the first frequency coefficient to get scanned and is thus labeled with a 0. The frequency coefficient corresponding to the bottom right pixel is the last frequency coefficient to get scanned and is thus labeled with a 15. Table 2 lists the frequency coefficient scanning order for scanning path (500) and the corresponding values for n and m. Unless otherwise specifically denoted, as used hereafter and in the appended claims, n=0 to N-1 and is a variable that represents the pixel column number in the block as well as the corresponding frequency coefficient column number in the corresponding transform array. N is the total number of pixel columns in the block and the total number of frequency coefficient columns in the transform array. The left-most column number is 0 and the right-most column number is N-1. Likewise, m=O,1, . . . ,M-1, where m is a variable that represents the pixel row number in the block as well as the corresponding frequency coefficient row number in the corresponding transform array. M is the total number of pixel rows in the block and the total number of frequency coefficient rows in the transform array. The top row number is 0 and the bottom row number is M-1.

TABLE 2
Four by four transform array scanning
order for scanning path (500)

| Frequency Coefficient | | |
|---|---|---|
| Scanning Order | n | m |
| 0 | 0 | 0 |
| 1 | 1 | 0 |
| 2 | 0 | 1 |
| 3 | 0 | 2 |
| 4 | 1 | 1 |
| 5 | 2 | 0 |
| 6 | 3 | 0 |
| 7 | 2 | 1 |
| 8 | 1 | 2 |
| 9 | 0 | 3 |
| 10 | 1 | 3 |
| 11 | 2 | 2 |
| 12 | 3 | 1 |
| 13 | 3 | 2 |
| 14 | 2 | 3 |
| 15 | 3 | 3 |

Also shown in FIG. 5 is an alternate scanning path (501). The alternate scanning path (501) is used to scan frequency coefficients of a 4 by 4 transform array corresponding to a 4 by 4 block of pixels that is to be coded in field mode, where N=4 and M=4. The number in alternate scanning path (501) represent the frequency coefficient scanning order. For example, the frequency coefficient corresponding to the top left pixel is the first frequency coefficient to get scanned and is thus labeled with a 0. The frequency coefficient corresponding to the bottom right pixel is the last frequency coefficient to get scanned and is thus labeled with 15. Table 3 lists the frequency coefficient scanning order and the corresponding values for n and m.

TABLE 3
Four by four transform array scanning order
for alternate scanning path (501)

| Frequency Coefficient | | |
|---|---|---|
| Scanning Order | n | m |
| 0 | 0 | 0 |
| 1 | 0 | 1 |
| 2 | 1 | 0 |
| 3 | 0 | 2 |
| 4 | 0 | 3 |
| 5 | 1 | 1 |
| 6 | 1 | 2 |
| 7 | 1 | 3 |
| 8 | 2 | 0 |
| 9 | 2 | 1 |
| 10 | 2 | 2 |
| 11 | 2 | 3 |
| 12 | 3 | 0 |
| 13 | 3 | 1 |
| 14 | 3 | 2 |
| 15 | 3 | 3 |

In an exemplary embodiment of the present invention, the scanning path (500) and the alternate scanning path (501) may be applied to transform arrays that are larger than 4 by 4 so that they frequency coefficients of larger transform arrays may be coded using CAVLC or any other coding algorithm. These larger transform array sizes include, but are not limited to, transform arrays corresponding to pixel block sizes of 4 by 8 pixels, 8 by 4 pixels, 8 by 8 pixels, 8 by 16, 16 by 8 pixels, and 16 by 16 pixels. Preferable scanning paths for scanning the frequency coefficients of these block sizes will now be explained in connection with FIGS. 6-17.

FIGS. 6-11 illustratate that the scanning path (500) may be applied to transform arrays corresponding to pixel block sizes that are larger than 4 by 4 pixels, thus enabling these larger pixel blocks to be coded using CAVLC or any other coding algorithm. According to an embodiment of the present invention, the scanning path (500) is used when the larger blocks are to be coded in frame mode. Although the application of the scanning path (500) to larger blocks of pixels principally enables CAVLC on these larger blocks, any other coding scheme may be used according to an alternative embodiment, including, but not limited to, UVLC and CABAC.

FIG. 6 illustrates that the scanning path (500) of FIG. 5 may be applied to a 4 by 8 pixel block's corresponding transform array to scan all of its 32 frequency coefficients in frame mode, according to an embodiment of the present invention. Thus, the 4 by 8 pixel block may be coded using CAVLC or any other coding algorithm. As shown in FIG. 6, the 4 by 8 transform array is composed of two 4 by 4 blocks of frequency coefficients, a top 4 by 4 block (600) and a bottom 4 by4 block (601). The top 4 by 4 block (600) comprises the frequency coefficients in the top four rows of the 4 by 8 transform array and the bottom 4 by 4 block (601) comprises the frequency coefficients in the bottom four rows of the 4 by 8 transform array. In one embodiment of the present invention, the frequency coefficients of the top 4 by 4 block (600) are scanned first using the same scanning path (500; FIG. 5) that is used to scan the frequent coefficients of a 4 by 4 transform array. After the frequency coefficients of the top 4 by 4 block (600) are scanned, the frequency coefficients of the bottom 4 by 4 block (601) are scanned using the same scanning path (500; FIG. 5) that is used to scan the frequent coefficients of a 4 by 4 transform array. Thus, FIG. 6 shows that the frequency coefficient scanning order of the top 4 by 4 block (600) and of the bottom 4 by 4 block (601) are identical.

Table 4 lists the overall frequency coefficient scanning order for the 4 by 8 transform block of FIG. 6 and the corresponding values for n and m. In this case, N=4 and M=8. For example, the frequency coefficient corresponding to the top left pixel in the 4 by 8 block of pixels is the first frequency coefficient to get scanned and is thus labeled with a 0. The frequency coefficient corresponding to the bottom right pixel of the 4 by 8 block of pixels is the last frequency coefficient to get scanned and is thus labeled with a 31. It will be recognized that frequency coefficients corresponding to the top 4 by 4 block (600) are scanned before the frequency coefficients corresponding to the bottom 4 by 4 block (601).

TABLE 4
Four by eight transform array scanning order (frame coding)

| Frequency Coefficient | | |
|---|---|---|
| Scanning Order | n | m |
| 0 | 0 | 0 |
| 1 | 1 | 0 |
| 2 | 0 | 1 |
| 3 | 0 | 2 |
| 4 | 1 | 1 |
| 5 | 2 | 0 |
| 6 | 3 | 0 |
| 7 | 2 | 1 |
| 8 | 1 | 2 |
| 9 | 0 | 3 |
| 10 | 1 | 3 |
| 11 | 2 | 2 |
| 12 | 3 | 1 |
| 13 | 3 | 2 |
| 14 | 2 | 3 |
| 15 | 3 | 3 |
| 16 | 0 | 4 |
| 17 | 1 | 4 |
| 18 | 0 | 5 |
| 19 | 0 | 6 |
| 20 | 1 | 5 |
| 21 | 2 | 4 |
| 22 | 3 | 4 |
| 23 | 2 | 5 |
| 24 | 1 | 6 |
| 25 | 0 | 7 |
| 26 | 1 | 7 |
| 27 | 2 | 6 |
| 28 | 3 | 5 |
| 29 | 3 | 6 |
| 30 | 2 | 7 |
| 31 | 3 | 7 |

FIG. 7 illustrates that the scanning path (500) of FIG. 5 may be applied to an 8 by 4 pixel block's corresponding transform array to scan all of its 32 frequency coefficients in frame mode, according to an embodiment of the present invention. Thus, CAVLC or any other coding algorithm may be performed on the 8 by 4 pixel block. As shown in FIG. 7, the 8 by 4 transform array is composed of two 4 by 4 blocks of frequency coefficients, a left 4 by 4 block (700) and a right 4 by 4 block (701). The left 4 by 4 block (700) comprises the frequency coefficients in the left-most four columns of the 4 by 8 transform array and the right 4 by 4 block (701) comprises the frequency coefficients in the right-most four columns of the 4 by 8 transform array. In one embodiment the present invention, the frequency coefficients of the left 4 by 4 block (700) are scanned first using the same scanning path (500; FIG. 5) that is used to scan the frequent coefficients of a 4 by 4 transform array. After the frequency coefficients of the left 4 by 4 block (700) are scanned, the frequency coefficients of the right 4 by 4 block (701) are scanned using the same scanning path (500; FIG. 5) that is used to scan the frequent coefficients of a 4 by 4 transform block. Thus, FIG. 7 shows that the frequency coefficient scanning order of the left 4 by 4 block (700) and of the right 4 by 4 block (701) are identical.

Table 5 lists the overall frequency coefficient scanning order for the 8 by 4 block of FIG. 7 and the corresponding values for n and m. In this case, N=8 and M=4. For example, the frequency coefficient corresponding to the top left pixel in the 8 by 4 block of pixels of FIG. 7 is the first frequency coefficient to get scanned and is thus labeled with a 0. The frequency coefficient corresponding to the bottom right pixel of the 8 by 4 block of pixels is the last frequency coefficient to get scanned and is thus labeled with a 31. It will be recognized that frequency coefficients corresponding to the left 4 by 4 block (700) are scanned before the frequency coefficients corresponding to the right 4 by 4 block (701).

TABLE 5
Eight by four transform array scanning order (frame coding)

| Frequency Coefficient | | |
|---|---|---|
| Scanning Order | n | m |
| 0 | 0 | 0 |
| 1 | 1 | 0 |
| 2 | 0 | 1 |
| 3 | 0 | 2 |
| 4 | 1 | 1 |
| 5 | 2 | 0 |
| 6 | 3 | 0 |
| 7 | 2 | 1 |
| 8 | 1 | 2 |
| 9 | 0 | 3 |
| 10 | 1 | 3 |
| 11 | 2 | 2 |
| 12 | 3 | 1 |
| 13 | 3 | 2 |
| 14 | 2 | 3 |
| 15 | 3 | 3 |
| 16 | 4 | 0 |
| 17 | 5 | 0 |
| 18 | 4 | 1 |
| 19 | 4 | 2 |
| 20 | 5 | 1 |
| 21 | 6 | 0 |
| 22 | 7 | 0 |
| 23 | 6 | 1 |
| 24 | 5 | 2 |
| 25 | 4 | 3 |
| 26 | 5 | 3 |
| 27 | 6 | 2 |
| 28 | 7 | 1 |
| 29 | 7 | 2 |
| 30 | 6 | 3 |
| 31 | 7 | 3 |

FIG. 8 illustrates that the scanning path (500) of FIG. 5 may be applied to an 8 by 8 pixel block's corresponding transform array to scan all of its 64 frequency coefficients in frame mode, according to an embodiment of the present invention. Thus, CAVLC or any other coding algorithm may be performed on the 8 by 8 pixel block. As shown in FIG. 8, the 8 by 8 transform array is composed of four 4 by 4 blocks of frequency coefficients: a top-left 4 by 4 block (800), a top-right 4 by 4 block (801), a bottom-left 4 by 4 block (802), and a bottom-right 4 by 4 block (803). The top-left 4 by 4 block (800) comprises the frequency coefficients that are in both the top four rows and in the left-most four columns of the 8 by 8 transform array. The top-right 4 by 4 block (801) comprises the frequency coefficients that are in both the top four rows and in the right-most four columns of the 8 by 8 transform array. The bottom-left 4 by 4 block (802) comprises the frequency coefficients that are in both the bottom four rows and in the left-most four columns of the 8 by 8 transform array. The bottom-right 4 by 4 block (803) comprises the frequency coefficients that are in both the bottom four rows and in the right-most four columns of the 8 by 8 transform array. In an exemplary embodiment of the present invention, the frequency coefficients of the top-left left 4 by 4 block (800) are scanned first using the same scanning path (500; FIG. 5) that is used to scan the frequency coefficients of a 4 by 4 transform array. Next, the frequency coefficients of the top-right 4 by 4 block (801) are scanned using the same scanning path (500; FIG. 5) that is used to scan the frequent coefficients of a 4 by 4 transform array. Next, the frequency coefficients of the bottom-left 4 by 4 block (802) are scanned using the same scanning path (500; FIG. 5) that is used to scan the frequent coefficients of a 4 by 4 transform array. Finally, the frequency coefficients of the bottom-right 4 by 4 block (803) are scanned using the same scanning path (500; FIG. 5) that is used to scan the frequent coefficients of a 4 by 4 transform array. Thus, FIG. 8 shows that the frequency coefficient scanning order of the top-left 4 by 4 block (800), the top-right 4 by 4 block (801), the bottom-left 4 by 4 block (802), and the bottom-right 4 by 4 block (803) are identical.

Table 6 lists the overall frequency coefficient scanning order for the 8 by 8 block of FIG. 8 and the corresponding values for n and m. In this case, N=8 and M=8. For example, the frequency coefficient corresponding to the top left pixel in the 8 by 8 block of pixels of FIG. 8 is the first frequency coefficient to get scanned and is thus labeled with a 0. The frequency coefficient corresponding to the bottom right pixel of the 8 by 8 block of pixels is the last frequency coefficient to get scanned and is thus labeled with a 63.

TABLE 6
Eight by eight transform array scanning order (frame coding)

| Frequency Coefficient | | |
|---|---|---|
| Scanning Order | n | M |
| 0 | 0 | 0 |
| 1 | 1 | 0 |
| 2 | 0 | 1 |
| 3 | 0 | 2 |
| 4 | 1 | 1 |
| 5 | 2 | 0 |
| 6 | 3 | 0 |
| 7 | 2 | 1 |
| 8 | 1 | 2 |
| 9 | 0 | 3 |
| 10 | 1 | 3 |
| 11 | 2 | 2 |
| 12 | 3 | 1 |
| 13 | 3 | 2 |
| 14 | 2 | 3 |
| 15 | 3 | 3 |
| 16 | 4 | 0 |
| 17 | 5 | 0 |
| 18 | 4 | 1 |
| 19 | 4 | 2 |
| 20 | 5 | 1 |
| 21 | 6 | 0 |
| 22 | 7 | 0 |
| 23 | 6 | 1 |
| 24 | 5 | 2 |
| 25 | 4 | 3 |
| 26 | 5 | 3 |
| 27 | 6 | 2 |
| 28 | 7 | 1 |
| 29 | 7 | 2 |
| 30 | 6 | 3 |
| 31 | 7 | 3 |
| 32 | 0 | 4 |
| 33 | 1 | 4 |
| 34 | 0 | 5 |
| 35 | 0 | 6 |
| 36 | 1 | 5 |
| 37 | 2 | 4 |
| 38 | 3 | 4 |
| 39 | 2 | 5 |
| 40 | 1 | 6 |
| 41 | 0 | 7 |
| 42 | 1 | 7 |
| 43 | 2 | 6 |
| 44 | 3 | 5 |
| 45 | 3 | 6 |
| 46 | 2 | 7 |
| 47 | 3 | 7 |
| 48 | 4 | 4 |
| 49 | 5 | 4 |
| 50 | 4 | 5 |
| 51 | 4 | 6 |
| 52 | 5 | 5 |
| 53 | 6 | 4 |
| 54 | 7 | 4 |
| 55 | 6 | 5 |
| 56 | 5 | 6 |
| 57 | 4 | 7 |
| 58 | 5 | 7 |
| 59 | 6 | 6 |
| 60 | 7 | 5 |
| 61 | 7 | 6 |
| 62 | 6 | 7 |
| 63 | 7 | 7 |

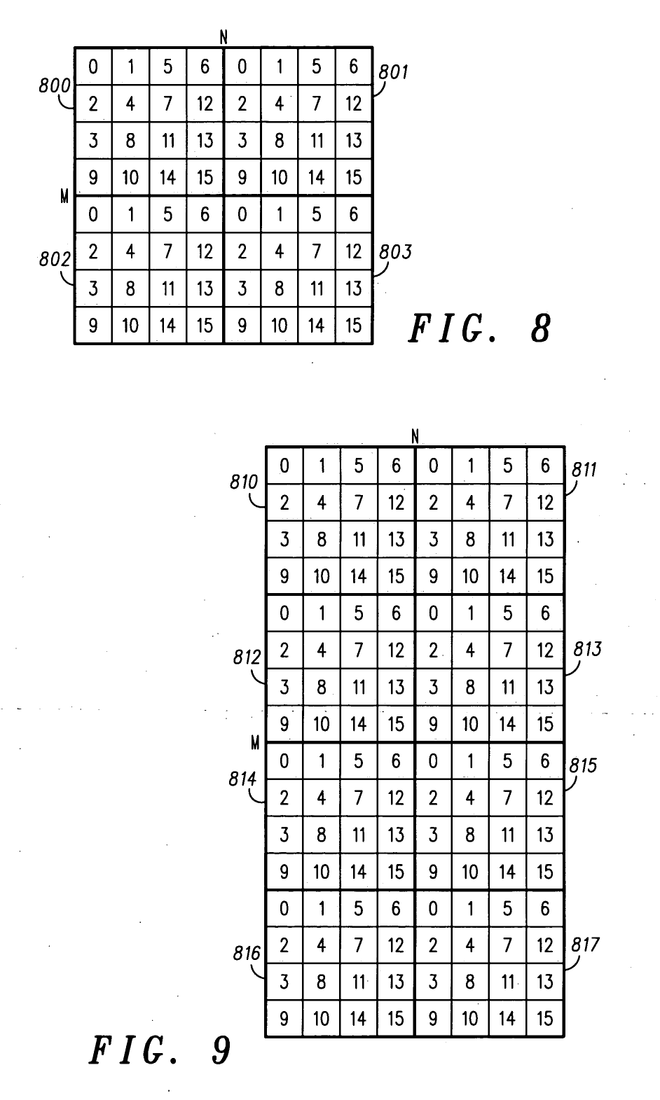

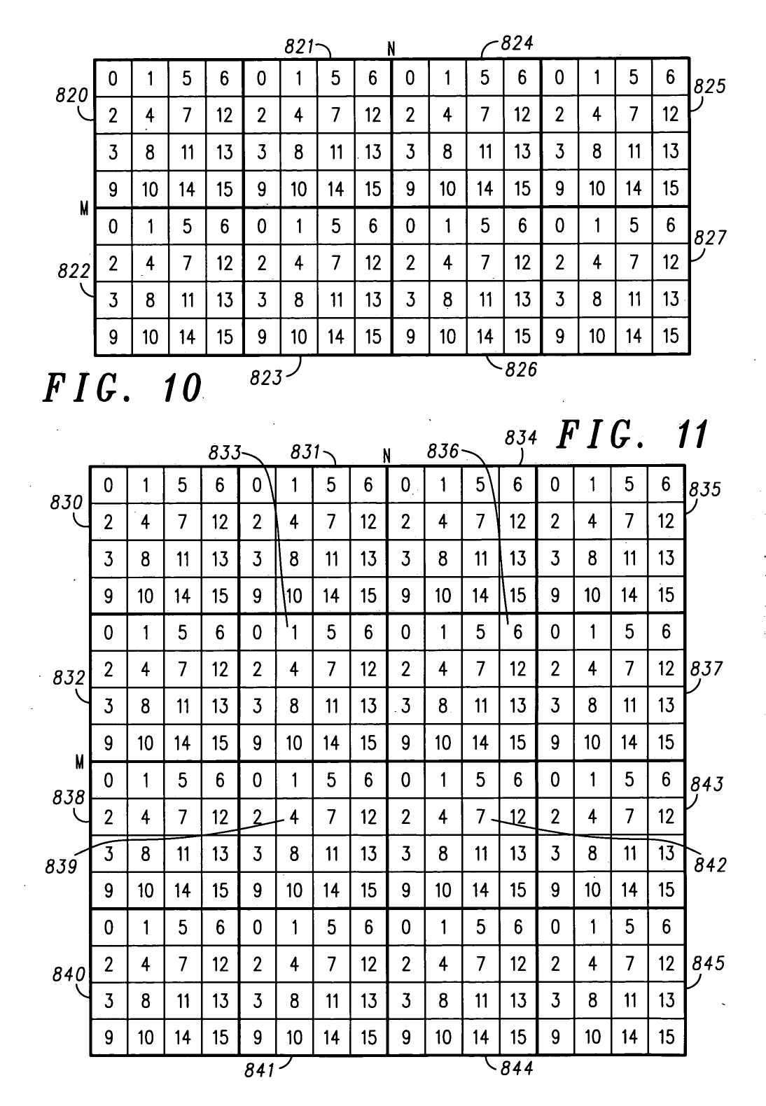

FIG. 9 illustrates that the scanning path (500) of FIG. 5 may be applied to and 8 by 16 pixel block's corresponding transform array to scan all of its 128 frequency coefficients in frame mode, according to an embodiment of the present invention. Thus, CAVLC or any other coding algorithm may be performed on the 8 by 16 pixel block. As shown in FIG. 9 the 8 by 16 transform array is composed of eight 4 by 4 blocks of frequency coefficient. The eight 4 by 4 blocks comprise a first 4 by 4 block (810), a second 4 by 4 block (811), a third 4 by 4 block (812), a fourth 4 by 4 block (813), a fifth 4 by 4 block (814), a sixth 4 by 4 block (815), a seventh 4 by 4 block (816), and an eighth 4 by 4 block (817). The first 4 by 4 block (810) comprises the frequency coefficients that are in both the top four rows and in the left-most four columns of the 8 by 16 transform array. The second 4 by 4 block (811) comprises the frequency coefficients that are in both the top four rows and in the right-most four columns of the 8 by 16 transform array. The third 4 by 4 block (812) comprises the frequency coefficients that are in both the fourth through seventh rows from the top of the 8 by 16 transform array and in the left-most four columns of the 8 by 16 transform array. The fourth 4 by 4 block (813) comprises the frequency coefficients that are in both the fourth through seventh rows from the top of the 8 by 16 transform array and in the right-most four column of the 8 by 16 transform array. The fifth 4 by 4 block (814) comprises the frequency coefficients that are in both the eighth through eleventh rows from the top of the 8 by 16 transform array and in the left-most four columns of the 8 by 16 transform array. The sixth 4 by 4 block (815) comprises the frequency coefficients that are in both the eighth through eleventh rows from the top of the 8 by 16 transform array and in the right-most four columns of the 8 by 16 transform array. The seventh 4 by 4 block (816) comprises the frequency coefficients that are in both the bottom four rows and in the left-most four columns of the 8 by 16 transform array. The eighth 4 by 4 block (817) comprises the frequency coefficients that are in both the bottom four rows and in the right-most four columns of the 8 by 16 transform array.

In one embodiment the present invention, the frequency coefficients of the eight 4 by 4 blocks of the transform array of FIG. 9 are scanned using the same scanning path (500; FIG. 5) that is used to scan the frequency coefficients of a 4 by 4 transform array. The eight 4 by 4 blocks are scanned in the following order, according to an embodiment of the present invention. The frequency coefficients of the first 4 by 4 block (810) are scanned first, followed by the frequency coefficients of the second 4 by 4 block (811), followed by the frequency coefficients of the third 4 by 4 block (812), followed by the frequency coefficients of the fourth 4 by 4 block (813), followed by the frequency coefficients of the fifth 4 by 4 block (814), followed by the frequency coefficients of the sixth 4 by 4 block (814), followed by the frequency coefficients of the seventh 4 by 4 block (816), followed by the frequency coefficients of the eighth 4 by 4 block (817). FIG. 9 shows that the frequency coefficient scanning order of each of the eight 4 by 4 blocks in the 8 by 16 transform array is identical.

A table listing of the overall frequency coefficient scanning order for the 8 by 16 transform array of FIG. 9 will not be given. However, the information provided in the preceding paragraph and in FIG. 9 would allow one skilled in the art to easily ascertain the overall frequency coefficient scanning order.

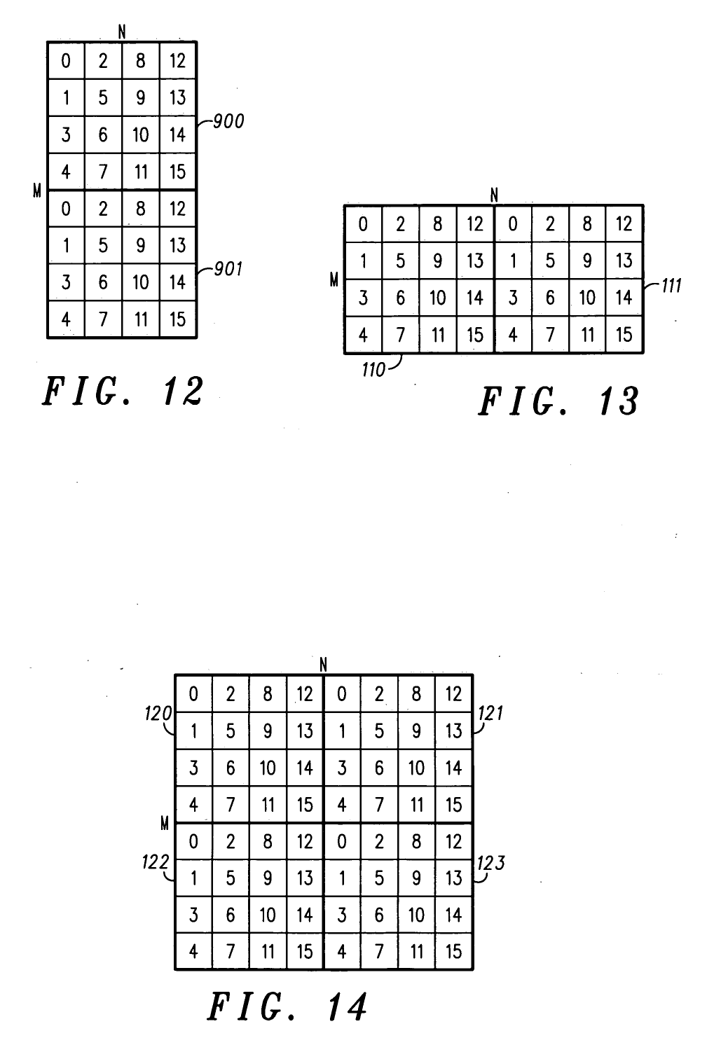

FIG. 10 illustrates that the scanning path (500) of FIG. 5 may be applied to a 16 by 8 pixel block's corresponding transform array to scan all of its 128 frequency coefficients in frame mode, according to an embodiment of the present invention. Thus, CAVLC or any other coding algorithm may be performed on the 16 by 8 pixel block. As shown in FIG. 10, the 16 by 8 transform array is composed of eight 4 by 4 blocks of frequency coefficients. The eight 4 by 4 blocks comprise a first 4 by 4 block (820), a second 4-by 4 block (821), a third 4 by 4 block (822), a fourth 4 by 4 block (823), a fifth 4 by 4 block (824), a sixth 4 by 4 block (825), a seventh 4 by 4 block (826), and an eighth 4 by 4 block (827). The first 4 by 4 block (820) comprises the frequency coefficients that are in both the top four rows and in the left-most four columns of the 8 by 16 transform array. The second 4 by 4 block (821) comprises the frequency coefficients that are in both the top four rows and in the fourth through seventh columns of the 16 by 8 transform array. The third 4 by 4 block (822) comprises the frequency coefficients that are in the bottom four rows and in the first four columns of the 16 by 8 transform array. The fourth 4 by 4 block (823) comprises the frequency coefficients that are in the bottom four rows and in the fourth through seventh columns of the 16 by 8 transform array. The fifth 4 by 4 block (824) comprises the frequency coefficients that are in both the top four rows and in the eighth through eleventh columns of the 16 by 8 transform array. The sixth 4 by 4 block (825) comprises the frequency coefficients that are in both the top four rows and in the right-most four columns of the 16 by 8 transform array. The seventh 4 by 4 block (826) comprises the frequency coefficients that are bottom four rows and in the eighth through eleventh columns of the 16 by 8 transform array. The eighth 4 by 4 block (827) comprises the frequency coefficients that are in both the bottom four rows and in the right-most four columns of the 16 by 8 transform array.

In one embodiment the present invention, the frequency coefficients of the eight 4 by 4. blocks of the transform array of FIG. 10 are scanned using the same scanning path (500; FIG. 5) that is used to scan the frequency coefficients of a 4 by 4 transform array. The eight 4 by 4 blocks are scanned in the following order, according to an embodiment of the present invention. The frequency coefficients of the first 4 by 4 block (820) are scanned first, followed by the frequency coefficients of the second 4 by 4 block (821), followed by the frequency coefficients of the third 4 by 4 block (822), followed by the frequency coefficients of the fourth 4 by 4 block (823), followed by the frequency coefficients of the fifth 4 by 4block (824), followed by the frequency coefficients of the sixth 4 by 4 block (824), followed by the frequency coefficients of the seventh 4 by 4 block (826), followed by the frequency coefficients of the eighth 4 by 4 block (827). FIG. 10 shows that the frequency coefficient scanning order of each of the eight 4 by 4 blocks in the 16 by 8 transform array is identical.

A table listing of the overall frequency coefficient scanning order for the 16 by 8 transform array of FIG. 10 will not be given. However, the information provided in the preceding paragraph and in FIG. 10 would allow one skilled in the art to easily ascertain the overall frequency coefficient scanning order.

FIG. 11 illustrates that the scanning path (500) of FIG. 5 may be applied to a 16 by 16 pixel block's corresponding transform array to scan all, of its 256 frequency coefficients in frame mode, according to an embodiment of the present invention. Thus, CAVLC or any other coding algorithm may be performed on the 16 by 16 pixel block. As shown in FIG. 1, the 16 by 16 transform array is composed of sixteen 4 by 4 blocks of frequency coefficients. The sixteen 4 by 4 blocks comprise a first 4 by 4 block (830), a second 4 by 4 block (831), a third 4 by 4 block (832), a fourth 4 by 4 block (833), a fifth 4 by 4 block (834), a sixth 4 by 4 block (835), a seventh 4 by 4 block (836), an eighth 4 by 4 block (837), a ninth 4 by 4 block (838), a tenth 4 by 4 block (839), an eleventh 4 by 4 block (840), a twelfth 4 by 4 block (841), a thirteenth 4 by 4 block (842), a fourteenth 4 by 4 block (843), a fifteenth 4 by 4 block (844), and a sixteenth 4 by 4 block (845). The first 4 by 4 block (830) comprises the frequency coefficients that are in both the top four rows and in the left-most four columns of the 8 by 16 transform array. The second 4 by 4 block (831) comprises the frequency coefficients that are in both the top four rows and in the fourth through seventh columns of the 16 by 16 transform array. The third 4 by 4 block (832) comprises the frequency coefficients that are in the fourth through seventh rows and in the first four columns of the 16 by 16 transform array. The fourth 4 by 4 block (833) comprises the frequency coefficients that are in the fourth through seventh rows and in the fourth through seventh columns of the 16 by 16 transform array. The fifth 4 by 4 block (834) comprises the frequency coefficients that are in both the top four rows and in the eighth through eleventh columns of the 16 by 16 transform array. The sixth 4 by 4 block (835) comprises the frequency coefficients that are in both the top four rows and in the right-most four columns of the 16 by 16 transform array. The seventh 4 by 4 block (836) comprises the frequency coefficients that are fourth through seventh rows and in the eighth through eleventh columns of the 16 by 16 transform array. The eighth 4 by 4 block (837) comprises the frequency coefficients that are in both the fourth through seventh rows and in the right-most four columns of the 16 by 16 transform array. The ninth 4 by 4 block (838) comprises the frequency coefficients that are in both the eighth through eleventh rows and in the left-most four columns of the 8 by 16 transform array. The tenth 4 by 4 block (839) comprises the frequency coefficients that are in both the eighth through eleventh rows and in the fourth through seventh columns of the 16 by 16 transform array. The eleventh 4 by 4 block (840) comprises the frequency coefficients that are in the bottom four rows and in the first four columns of the 16 by 16 transform array. The twelfth 4 by 4 block (841) comprises the frequency coefficients that are in the bottom four rows and in the fourth through seventh columns of the 16 by 16 transform array. The thirteenth 4 by 4 block (842) comprises the frequency coefficients that are in both the eighth through eleventh rows and in the eighth through eleventh columns of the 16 by 16 transform array. The fourteenth 4 by 4 block (843) comprises the frequency coefficients that are in both the eighth through eleventh rows and in the right-most four columns of the 16 by 16 transform array. The fifteenth 4 by 4 block (844) comprises the frequency coefficients that are in the bottom four rows and in the eighth through eleventh columns of the 16 by 16 transform array. The sixteenth 4 by 4 block (845) comprises the frequency coefficients that are in both the bottom four rows and in the right-most four columns of the 16 by 16 transform array.

In one embodiment the present invention, the frequency coefficients of the sixteen 4 by 4 blocks of the transform array of FIG. 11 are scanned using the same scanning path (500; FIG. 5) that is used to scan the frequency coefficients of a 4 by 4 transform array. The sixteen 4 by 4 blocks are scanned in the following order, according to an embodiment of the present invention. The frequency coefficients of the first 4 by 4 block (830) are scanned first, followed by the frequency coefficients of the second 4 by 4 block (831), followed by the frequency coefficients of the third 4 by 4 block (832), followed by the frequency coefficients of the fourth 4 by 4 block (833), followed by the frequency coefficients of the fifth 4 by 4 block (834), followed by the frequency coefficients of the sixth 4 by 4 block (834), followed by the frequency coefficients of the seventh 4 by 4 block (836), followed by the frequency coefficients of the eighth 4 by 4 block (837), followed by the frequency coefficients of the ninth 4 by 4 block (838), followed by the frequency coefficients of the tenth 4 by 4 block (839), an eleventh 4 by 4 block (840), followed by the frequency coefficients of the twelfth 4 by 4 block (841), followed by the frequency coefficients of the thirteenth 4 by 4 block (842), followed by the frequency coefficients of the fourteenth 4 by 4 block (843), followed by the frequency coefficients of the fifteenth 4 by 4 block (844), followed by the frequency coefficients of the sixteenth 4 by 4 block (845). FIG. 11 shows that the frequency coefficient scanning order of each of the sixteen 4 by 4 blocks in the 16 by 16 transform array is identical.

A table listing of the overall frequency coefficient scanning order for the 16 by 16 transform array of FIG. 11 will not be given. However, the information provided in the preceding paragraph and in FIG. 11 would allow one skilled in the art to easily ascertain the overall frequency coefficient scanning order.

FIGS. 12-17 illustrate that the alternate scanning path (501) may be applied to transform arrays corresponding to pixel block sizes that are larger than 4 by 4 pixels that are to be encoded in field mode, according to an exemplary embodiment. As previously described, the alternate scanning path (501) is used when a pixel block is to be coded in field mode. Although the application of the alternate scanning path (501) to larger blocks of pixels enables CAVLC on these larger blocks, any other coding scheme may be used according to an alternative embodiment, including, but not limited to, UVLC and CABAC.

FIG. 12 illustrates that the alternate scanning path (501) of FIG. 5 may be applied to a 4 by 8 pixel block's corresponding transform array to scan all of its 32 frequency coefficients in field mode, according to an embodiment of the present invention. Thus, CAVLC or any other coding algorithm may be performed on the 4 by 8 pixel block. As shown in FIG. 12, the 4 by 8 transform array is composed of two 4 by 4 blocks of frequency coefficients, a top 4 by 4 block (900) and a bottom 4 by 4 block (901). The top 4 by 4 block (900) comprises the frequency coefficients in the top four rows of the 4 by 8 transform array and the bottom 4 by 4 block (901) comprises the frequency coefficients in the bottom four rows of the 4 by 8 transform array. In an exemplary embodiment of the present invention, the frequency coefficients of the top 4 by 4 block (900) are scanned first using the same alternate scanning path (501; FIG. 5) that is used to scan the frequency coefficients of a 4 by 4 transform array. After the frequency coefficients of the top 4 by 4 block (900) are scanned, the frequency coefficients of the bottom 4 by 4 block (901) array are scanned using the same alternate scanning path (501; FIG. 5) that is used to scan the frequency coefficients of a 4 by 4 transform array. Thus, FIG. 12 shows that the frequency coefficient scanning order of the top 4 by 4 block (900) and of the bottom 4 by 4 block (901) are identical.

Table 7 lists the overall frequency coefficient scanning order for the 4 by 8 block of FIG. 12 and the corresponding values for n and m. In this case, N=4 and M=8. For example, the frequency coefficient corresponding to the top left pixel in the 4 by 8 block of pixels is the first frequency coefficient to get scanned and is thus labeled with a 0. The frequency coefficient corresponding to the bottom right pixel of the 4 by 8 block of pixels is the last frequency coefficient to get scanned and is thus labeled with a 31. It will be recognized that frequency coefficients corresponding to the top 4 by 4 block (900) are scanned before the frequency coefficients corresponding to the bottom 4 by 4 block (901).

TABLE 7
Four by eight transform array scanning order (field coding)

| Frequency Coefficient | | |
|---|---|---|
| Scanning Order | n | m |
| 0 | 0 | 0 |
| 1 | 0 | 1 |
| 2 | 1 | 0 |
| 3 | 0 | 2 |
| 4 | 0 | 3 |
| 5 | 1 | 1 |
| 6 | 1 | 2 |
| 7 | 1 | 3 |
| 8 | 2 | 0 |
| 9 | 2 | 1 |
| 10 | 2 | 2 |
| 11 | 2 | 3 |
| 12 | 3 | 0 |
| 13 | 3 | 1 |
| 14 | 3 | 2 |
| 15 | 3 | 3 |
| 16 | 0 | 4 |
| 17 | 0 | 5 |
| 18 | 1 | 4 |
| 19 | 0 | 6 |
| 20 | 0 | 7 |
| 21 | 1 | 5 |
| 22 | 1 | 6 |
| 23 | 1 | 7 |
| 24 | 2 | 4 |
| 25 | 2 | 5 |
| 26 | 2 | 6 |
| 27 | 2 | 7 |
| 28 | 3 | 4 |
| 29 | 3 | 5 |
| 30 | 3 | 6 |
| 31 | 3 | 7 |

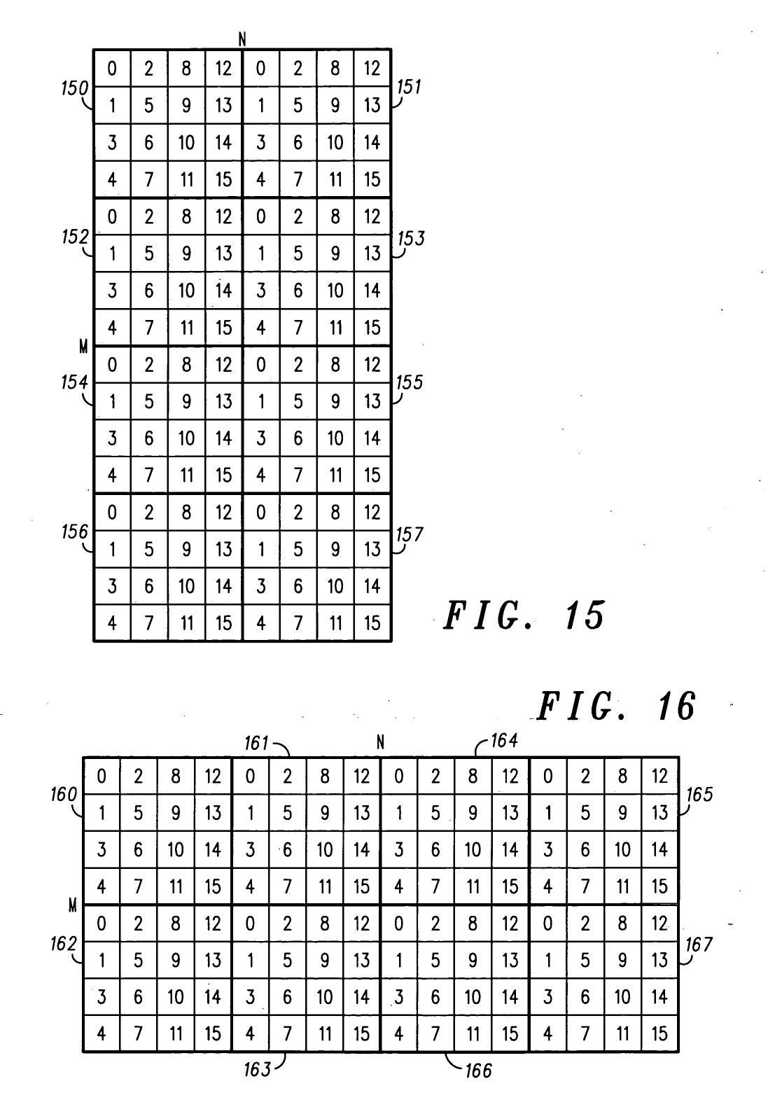

FIG. 13 illustrates that the alternate scanning path (501) of FIG. 5 may be applied to an 8 by 4 pixel block's corresponding transform array to scan all of its 32 frequency coefficients in field mode, according to an embodiment of the present invention. Thus, CAVLC or any other coding algorithm may be performed on the 8 by 4 pixel block. As shown in FIG. 13, the 8 by 4 transform array is composed of two 4 by 4 blocks of frequency coefficients, a left 4 by 4 block (110) and a right 4 by 4 block (111). The left 4 by 4 block (110) comprises the frequency coefficients in the left-most four columns of the 4 by 8 transform array and the right 4 by 4 block (111) comprises the frequency coefficients in the right-most four columns of the 4 by 8 transform array. In an exemplary embodiment of the present invention, the frequency coefficients of the left 4 by 4 block (110) are scanned first using the same alternate scanning path (501; FIG. 5) that is used to scan the frequency coefficients of a 4 by 4 transform array. After the frequency coefficients of the left 4 by-4 block (110) are scanned, the frequency coefficients of the right 4 by 4 block (111) are scanned using the same alternate scanning path (501; FIG. 5) that is used to scan the frequency coefficients of a 4 by 4 array. Thus, FIG. 13 shows that the frequency coefficient scanning order of the left 4 by 4 block (110) and of the right 4 by 4 block (111) are identical.

Table 8 lists the frequency coefficient scanning order for the 8 by 4 block of FIG. 13 and the corresponding values for n and m. In this case, N=8 and M=4. For example, the frequency coefficient corresponding to the top left pixel in the 8 by 4 block of pixels of FIG. 13 is the first frequency coefficient to get scanned and is thus labeled with a 0. The frequency coefficient corresponding to the bottom right pixel of the 8 by 4 block of pixels is the last frequency coefficient to get scanned and is thus labeled with a 31. It will be recognized that frequency coefficients corresponding to the left 4 by 4 block (110) are scanned before the frequency coefficients corresponding to the right 4 by 4 block (111).

TABLE 8
Eight by four transform array scanning order (field coding)

| Frequency Coefficient | | |
|---|---|---|
| Scanning Order | n | m |
| 0 | 0 | 0 |
| 1 | 0 | 1 |
| 2 | 1 | 0 |
| 3 | 0 | 2 |
| 4 | 0 | 3 |
| 5 | 1 | 1 |
| 6 | 1 | 2 |
| 7 | 1 | 3 |
| 8 | 2 | 0 |
| 9 | 2 | 1 |
| 10 | 2 | 2 |
| 11 | 2 | 3 |
| 12 | 3 | 0 |
| 13 | 3 | 1 |
| 14 | 3 | 2 |
| 15 | 3 | 3 |
| 16 | 4 | 0 |
| 17 | 4 | 1 |
| 18 | 5 | 0 |
| 19 | 4 | 2 |
| 20 | 4 | 3 |
| 21 | 5 | 1 |
| 22 | 5 | 2 |
| 23 | 5 | 3 |
| 24 | 6 | 0 |
| 25 | 6 | 1 |
| 26 | 6 | 2 |
| 27 | 6 | 3 |
| 28 | 7 | 0 |
| 29 | 7 | 1 |
| 30 | 7 | 2 |
| 31 | 7 | 3 |

FIG. 14 illustrates that the alternate scanning path (501) of FIG. 5 may be applied to an 8 by 8 pixel block's corresponding transform array to scan all of its 64 frequency coefficients in field mode, according to an embodiment of the present invention. Thus, CAVLC or any other coding algorithm may be performed on the 8 by 8 pixel block. As shown in FIG. 14, the 8 by 8 transform array is composed of four 4 by 4 blocks of frequency coefficients: a top-left 4 by 4 block (120), a top-right 4 by 4 block (121), a bottom-left 4 by 4 block (122), and a bottom-right 4 by 4 block (123). The top-left 4 by 4 block (120) comprises the frequency coefficients that are in both the top four rows and in the left-most four columns of the 8 by 8 transform array. The top-right 4 by 4 block (121) comprises the frequency coefficients that are in both the top four rows and in the right-most four columns of the 8 by 8 transform array. The bottom-left 4 block (122) comprises the frequency coefficients that are in both the bottom four rows and in the left-most four columns of the 8 by 8 transform array. The bottom-right 4 by 4 block (123) comprises the frequency coefficients that are in both the bottom four rows and in the right-most four columns of the 8 by 8 transform array. In one embodiment the present invention, the frequency coefficients of the top-left 4 by 4 block (120) are scanned first using the same alternate scanning path (501; FIG. 5) that is used to scan the frequency coefficient of a 4 by 4 transform array. Next, the frequency coefficients of the top-right 4 by 4 block (121) are scanned using the same alternate scanning path (501; FIG. 5) that is used to scan the frequency coefficients of a 4 by 4 transform array. Next, the frequency coefficients of the bottom-left 4 by 4 block (122) are scanned using the same alternate scanning path (501; FIG. 5) that is used to scan the frequency coefficients of a 4 by 4 transform array. Finally, the frequency coefficients of the bottom-right 4 by 4 block (123) are scanned using the same alternate scanning path (501; FIG. 5) that is used to scan the frequency coefficients of a 4 by 4 transform array. Thus, FIG. 14 shows that the frequency coefficient scanning order of the top-left 4 by 4 block (120), the top-right 4 by 4 block (121), the bottom-left 4 by 4 block (122), and the bottom-right 4 by 4 block (123) are identical.

Table 9 lists the frequency coefficient scanning order for the 8 by 8 block of FIG. 14 and the corresponding values for n and m. In this case, N=8 and M=8. For example, the frequency coefficient corresponding to the top left pixel in the 8 by 8 block of pixels of FIG. 14 is the first frequency coefficient to get scanned and is thus labeled with a 0. The frequency coefficient corresponding to the bottom right pixel of the 8 by 8 block of pixels is the last frequency coefficient to get scanned and is thus labeled with a 63.

TABLE 9
Eight by eight transform array scanning order (field coding)

| Frequency Coefficient | | |
|---|---|---|
| Scanning Order | n | m |
| 0 | 0 | 0 |
| 1 | 0 | 1 |
| 2 | 1 | 0 |
| 3 | 0 | 2 |
| 4 | 0 | 3 |
| 5 | 1 | 1 |
| 6 | 1 | 2 |
| 7 | 1 | 3 |
| 8 | 2 | 0 |
| 9 | 2 | 1 |
| 10 | 2 | 2 |
| 11 | 2 | 3 |
| 12 | 3 | 0 |
| 13 | 3 | 1 |
| 14 | 3 | 2 |
| 15 | 3 | 3 |
| 16 | 4 | 0 |
| 17 | 4 | 1 |
| 18 | 5 | 0 |
| 19 | 4 | 2 |
| 20 | 4 | 3 |
| 21 | 5 | 1 |
| 22 | 5 | 2 |
| 23 | 5 | 3 |
| 24 | 6 | 0 |
| 25 | 6 | 1 |
| 26 | 6 | 2 |
| 27 | 6 | 3 |
| 28 | 7 | 0 |
| 29 | 7 | 1 |
| 30 | 7 | 2 |
| 31 | 7 | 3 |
| 32 | 0 | 4 |
| 33 | 0 | 5 |
| 34 | 1 | 4 |
| 35 | 0 | 6 |
| 36 | 0 | 7 |
| 37 | 1 | 5 |
| 38 | 1 | 6 |
| 39 | 1 | 7 |
| 40 | 2 | 4 |
| 41 | 2 | 5 |
| 42 | 2 | 6 |
| 43 | 2 | 7 |
| 44 | 3 | 4 |
| 45 | 3 | 5 |
| 46 | 3 | 6 |
| 47 | 3 | 7 |
| 48 | 4 | 4 |
| 49 | 4 | 5 |
| 50 | 5 | 4 |
| 51 | 4 | 6 |
| 52 | 4 | 7 |
| 53 | 5 | 5 |
| 54 | 5 | 6 |
| 55 | 5 | 7 |
| 56 | 6 | 4 |
| 57 | 6 | 5 |
| 58 | 6 | 6 |
| 59 | 6 | 7 |
| 60 | 7 | 4 |
| 61 | 7 | 5 |
| 62 | 7 | 6 |
| 63 | 7 | 7 |

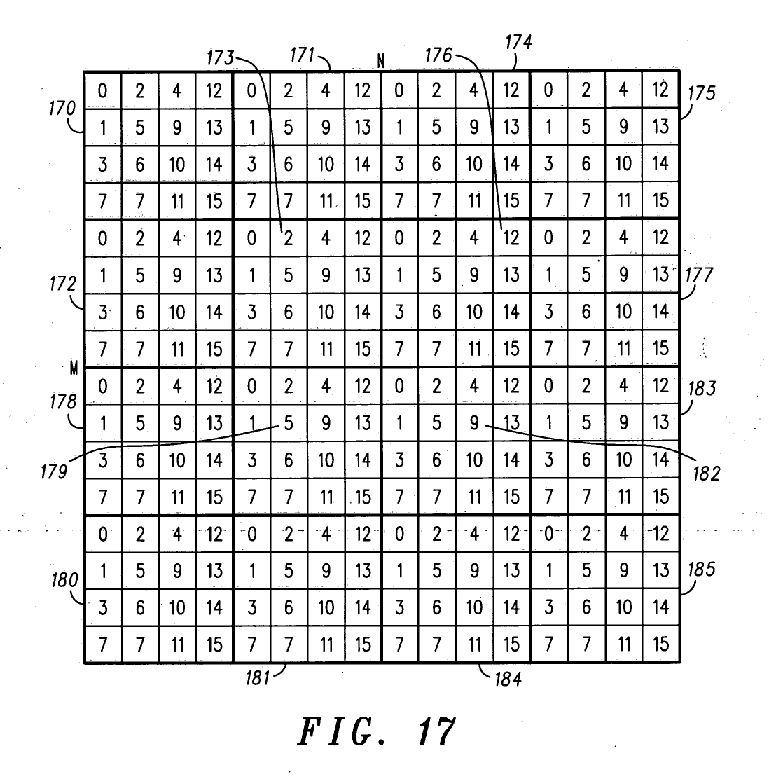

FIG. 15 illustrates that the scanning path (500) of FIG. 5 may be applied to and 8 by 16 pixel block's corresponding transform array to scan all of its 128 frequency coefficients in field mode, according to an embodiment of the present invention. Thus, CAVLC or any other coding algorithm may be performed on the 8 by 16 pixel block. As shown in FIG. 15, the 8 by 16 transform array is composed of eight 4 by 4 blocks of frequency coefficients. The eight 4 by 4 blocks comprise a first 4 by 4 block (150), a second 4 by 4 block (151), a third 4 by 4 (152), a fourth 4 by 4 block (153), a fifth 4 by 4 block (154), a sixth 4 by 4 block (155), a seventh 4 by 4 block (156), and an eighth 4 by 4 block (157). The first 4 by 4 block (150) comprises the frequency coefficients that are in both the top four rows and in the left-most four columns of the 8 by 16 transform array. The second 4 by 4 block (151) comprises the frequency coefficients that are in both the top four rows and in the right-most four columns of the 8 by 16 transform array. The third 4 by 4 block (152) comprises the frequency coefficients that are in both the fourth through seventh rows from the top of the 8 by 16 transform array and in the left-most four columns of the 8 by 16 transform array. The fourth 4 by 4 block (153) comprises the frequency coefficients that are in both the fourth through seventh rows from the top of the 8 by 16 transform-array and in the right-most four columns of the 8 by 16 transform array. The fifth 4 by 4 block (154) comprises the frequency coefficients that are in both the eighth through eleventh rows from the top of the 8 by 16 transform array and in the left-most four columns of the 8 by 16 transform array. The sixth 4 by 4 block (155) comprises the frequency coefficients that are in both the eighth through eleventh rows from the top of the 8 by 16 transform array and in the right-most four columns of the 8 by 16 transform array. The seventh 4 by 4 block (156) comprises the frequency coefficients that are in both the bottom four rows and in the left-most four columns of the 8 by 16 transform array. The eighth 4 by 4 block (157) comprises the frequency coefficients that are in both the bottom four rows and in the right-most four columns of the 8 by 16 transform array.

In one embodiment the present invention, the frequency coefficients of the eight 4 by 4 blocks of the transform array of FIG. 15 are scanned using the same scanning path (500; FIG. 5) that is used to scan the frequency coefficients of a 4 by 4 transform array. The eight 4 by 4 blocks are scanned in the following order, according to an embodiment of the present invention. The frequency coefficients of the first 4 by 4 block (150) are scanned first, followed by the frequency coefficients of the second 4 by 4 block (151), followed by the frequency coefficients of the third 4 by 4 block (152), followed by the frequency coefficients of the fourth 4 by 4 block (153), followed by the frequency coefficients of the fifth 4 by 4 block (154), followed by the frequency coefficients of the sixth 4 by 4 block (154), followed by the frequency coefficients of the seventh 4 by 4 block (156), followed by the frequency coefficients of the eighth 4 by 4 block (157). FIG. 15 shows that the frequency coefficient scanning order of each of the eight 4 by 4 blocks in the 8 by 16 transform array is identical.

A table listing of the overall frequency coefficient scanning order for the 8 by 16 transform array of FIG. 15 will not be given. However, the information provided in the preceding paragraph and in FIG. 15 would allow one skilled in the art to easily ascertain the overall frequency coefficient scanning order.

FIG. 16 illustrates that the scanning path (500) of FIG. 5 may be applied to a 16 by 8 pixel block's corresponding transform array to scan all of its 128 frequency coefficients in field mode, according to an embodiment of the present invention. Thus, CAVLC or any other coding algorithm may be performed on the 16 by 8 pixel block. As shown in FIG. 16, the 16 by 8 transform array is composed of eight 4 by 4 blocks of frequency coefficients. The eight 4 by 4 blocks comprise a first 4 by 4 block (160), a second 4 by 4 block (161), a third 4 by 4 block (162), a fourth 4 by 4 block (163), a fifth 4 by 4 block (164), a sixth 4 by 4 block (165), a seventh 4 by 4 block (166), and an eighth 4 by 4 block (167). The first 4 by 4 block (160) comprises the frequency coefficients that are in both the top four rows and in the left-most four columns of the 8 by 16 transform array. The second 4 by 4 block (161) comprises the frequency coefficients that are in both the top four rows and in the fourth through seventh columns of the 16 by 8 transform array. The third 4 by 4 block (162) comprises the frequency coefficients that are in the bottom four rows and in the first four columns of the 16 by 8 transform array. The fourth 4 by 4 block (163) comprises the frequency coefficients that are in the bottom four rows and in the fourth through seventh columns of the 16 by 8 transform array. The fifth 4 by 4 block (164) comprises the frequency coefficients that are in both the top four rows and in the eighth through eleventh columns of the 16 by 8 transform array. The sixth 4 by 4 block (165) comprises the frequency coefficients that are in both the top four rows and in the right-most four columns of the 16 by 8 transform array. The seventh 4 by 4 block (166) comprises the frequency coefficients that are bottom four rows and in the eighth through eleventh columns of the 16 by 8 transform array. The eighth 4 by 4 block (167) comprises the frequency coefficients that are in both the bottom four rows and in the right-most four columns of the 16 by 8 transform array.

In one embodiment the present invention, the frequency coefficients of the eight 4 by 4 blocks of the transform array of FIG. 16 are scanned using the same scanning path (500; FIG. 5) that is used to scan the frequency coefficients of a 4 by 4 transform array. The eight 4 by 4 blocks are scanned in the following order, according to an embodiment of the present invention. The frequency coefficients of the first 4 by 4 block (160) are scanned first, followed by the frequency coefficients of the second 4 by 4 block (161), followed by the frequency coefficients of the third 4 by 4 block (162), followed by the frequency coefficients of the fourth 4 by 4 block (163), followed by the frequency coefficients of the fifth 4 by 4 block (164), followed by the frequency coefficients of the sixth 4 by 4 block (164), followed by the frequency coefficients of the seventh 4 by 4 block (166), followed by the frequency coefficients of the eighth 4 by 4 block (167). FIG. 16 shows that the frequency coefficient scanning order of each of the eight 4 by 4 blocks in the 16 by 8 transform array is identical.

A table listing of the overall frequency coefficient scanning order for the 16 by 8 transform array of FIG. 16 will not be given. However, the information provided in the preceding paragraph and in FIG. 16 would allow one skilled in the art to easily ascertain the overall frequency coefficient scanning order.

FIG. 17 illustrates that the scanning path (500) of FIG. 5 may be applied to a 16 by 16 pixel block's corresponding transform array to scan all of its 256 frequency coefficients in field mode, according to an embodiment of the present invention. Thus, CAVLC or any other coding algorithm may be performed on the 16 by 16 pixel block. As shown in FIG. 17, the 16 by 16 transform array is composed of sixteen 4 by 4 blocks of frequency coefficients. The sixteen 4 by 4 blocks comprise a first 4 by 4 block (170), a second 4 by 4 block (171), a third 4 by 4 block (172), a fourth 4 by 4 block (173), a fifth 4 by 4 block (174), a sixth 4 by 4 block (175), a seventh 4 by 4 block (176), an eighth 4 by 4 block (177), a ninth 4 by 4 block (178), a tenth 4 by 4 block (179), an eleventh 4 by 4 block (180), a twelfth 4 by 4 block (181), a thirteenth 4 by 4 block (182), a fourteenth 4 by 4 block (183), a fifteenth 4 by 4 block (184), and a sixteenth 4 by 4 block (185). The first 4 by 4 block (170) comprises the frequency coefficients that are in both the top four rows and in the left-most four columns of the 8 by 16 transform array. The second 4 by 4 block (171) comprises the frequency coefficients that are in both the top four rows and in the fourth through seventh columns of the 16 by 16 transform array. The third 4 by 4 block (172) comprises the frequency coefficients that are in the fourth through seventh rows and in the first four columns of the 16 by 16 transform array. The fourth 4 by 4 block (173) comprises the frequency coefficients that are in the fourth through seventh rows and in the fourth through seventh columns of the 16 by 16 transform array. The fifth 4 by 4 block (174) comprises the frequency coefficients that are in both the top four rows and in the eighth through eleventh columns of the 16 by 16 transform array. The sixth 4 by 4 block (175) comprises the frequency coefficients that are in both the top four rows and in the right-most four columns of the 16 by 16 transform array. The seventh 4 by 4 block (176) comprises the frequency coefficients that are fourth through seventh rows and in the eighth through eleventh columns of the 16 by 16 transform array. The eighth 4 by 4 block (177) comprises the frequency coefficients that are in both the fourth through seventh rows and in the right-most four columns of the 16 by 16 transform array. The ninth 4 by 4 block (178) comprises the frequency coefficients that are in both the eighth through eleventh rows and in the left-most four columns of the 8 by 16 transform array. The tenth 4 by 4 block (179) comprises the frequency coefficients that are in both the eighth through eleventh rows and in the fourth through seventh columns of the 16 by 16 transform array. The eleventh 4 by 4 block (180) comprises the frequency coefficients that are in the bottom four rows and in the first four columns of the 16 by 16 transform array. The twelfth 4 by 4 block (181) comprises the frequency coefficients that are in the bottom four rows and in the fourth through seventh columns of the 16 by 16 transform array. The thirteenth 4 by 4 block (182) comprises the frequency coefficients that are in both the eighth through eleventh rows and in the eighth through eleventh columns of the 16 by 16 transform array. The fourteenth 4 by 4 block (183) comprises the frequency coefficients that are in both the eighth through eleventh rows and in the right-most four columns of the 16 by 16 transform array. The fifteenth 4 by 4 block (184) comprises the frequency coefficients that are bottom four rows and in the eighth through eleventh columns of the 16 by 16 transform array. The sixteenth 4 by 4 block (185) comprises the frequency coefficients that are in both the bottom four rows and in the right-most four columns of the 16 by 16 transform array.

In one embodiment the present invention, the frequency coefficients of the sixteen 4 by 4 blocks of the transform array of FIG. 17 are scanned using the same scanning path (500; FIG. 5) that is used to scan the frequency coefficients of a 4 by 4 transform array. The sixteen 4 by 4 blocks are scanned in the following order, according to an embodiment of the present invention. The frequency coefficients of the first 4 by 4 block (170) are scanned first, followed by the frequency coefficients of the second 4 by 4 block (171), followed by the frequency coefficients of the third 4 by 4 block (172), followed by the frequency coefficients of the fourth 4 by 4 block (173), followed by the frequency coefficients of the fifth 4 by 4 block (174), followed by the frequency coefficients of the sixth 4 by 4 block (174), followed by the frequency coefficients of the seventh 4 by 4 block (176), followed by the frequency coefficients of the eighth 4 by 4 block (177), followed by the frequency coefficients of the ninth 4 by 4 block (178), followed by the frequency coefficients of the tenth 4 by 4 block (179), an eleventh 4 by 4 block (180), followed by the frequency coefficients of the twelfth 4 by 4 block (181), followed by the frequency coefficients of the thirteenth 4 by 4 block (182), followed by the frequency coefficients of the fourteenth 4 by 4 block (183), followed by the frequency coefficients of the fifteenth 4 by 4 block (184), followed by the frequency coefficients of the sixteenth 4 by 4 block (185). FIG. 17 shows that the frequency coefficient scanning order of each of the sixteen 4 by 4 blocks in the 16 by 16 transform array is identical.

A table listing of the overall frequency coefficient scanning order for the 16 by 16 transform array of FIG. 17 will not be given. However, the information provided in the preceding paragraph and in FIG. 17 would allow one skilled in the art to easily ascertain the overall frequency coefficient scanning order.

As previously explained, after the frequency coefficients of a particular transform array are scanned into a one dimensional array and then encoded, the one dimensional array of frequency coefficients may be transmitted to a decoder. The decoder decodes the frequency coefficients. In one embodiment, the decoder also scans the frequency coefficients in the one dimensional array and maps the frequency coefficients into corresponding positions in a two dimensional array. In an alternative embodiment, a system of which the decoder is a part performs the mapping. An exemplary method of mapping frequency coefficients in a one dimensional array of frequency coefficients to corresponding positions in a two dimensional array of frequency coefficients will now be explained.

According to an exemplary embodiment, a decoder maps frequency coefficients to their original locations within a two dimensional array. In other words, if a frequency coefficient is originally in a location defined by n=0 and m=0 in a two dimensional array before it is scanned into a one dimensional array, then the decoder maps that frequency coefficient to a location in a two dimensional array defined by n=0 and m=0. In this way, the frequency coefficients are in identical locations within two dimensional arrays before and after they are encoded and decoded. In one embodiment, the decoder may use a method of scanning that comprises assigning values of one dimensional array frequency coefficients in a one dimensional array to corresponding two dimensional array frequency coefficients in a two dimensional array of frequency coefficients. Tables and figures illustrating locations to which frequency coefficients are mapped for different block sizes will not be given because they are identical to those already given in connection with the scanning order illustrations.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

1. A method of transform-based encoding of digital video content, said digital video content comprising a stream of pictures, slices, or macroblocks in the form of blocks of pixels, each of said blocks of pixels having a corresponding two dimensional array of two dimensional array frequency coefficients, wherein, for each of said blocks, said method comprises:
dividing said two dimensional array of said two dimensional array frequency coefficients into a number of four by four blocks of two dimensional array frequency coefficients, said number of four by four blocks each comprising 4 columns and 4 rows of said two dimensional array frequency coefficients;
scanning said two dimensional array frequency coefficients in each of said number of four by four blocks with a pre-determined scanning order, said scanning order sequentially starting at 0 and ending at 15; and
producing a one dimensional array of one dimensional array frequency coefficients.

2. The method of claim 1, further comprising:
representing said columns of said number of four by four blocks with a variable n=0, 1, 2, or 3, wherein n=0 is at least one of a first or leftmost column, n=1 is a second column, n=2 is a third column, and n=3 is at least one of a fourth or rightmost column; and
representing said rows of said number of four by four blocks with a variable m=0, 1, 2, or 3, wherein m=0 is at least one of a first or top row, m=1 is a second row, m=2 is a third row, and m=3 is at least one of a fourth or bottom row.

3. The method of claim 2, wherein said one dimensional array comprises a number of groups of sixteen one dimensional array frequency coefficients, said number of groups corresponding to said number of said four by four blocks of said two dimensional array frequency coefficients, wherein said sixteen one dimensional array frequency coefficients in each of said groups are represented with a variable p=0, 1, 2, 3, 4, 5, 6, 7, 8, 9, 10, 11, 12, 13, 14, 15, in a numerical sequential order, wherein a first one dimensional array frequency coefficient in said each of said groups is represented by p=0 and a sixteenth one dimensional array frequency coefficient in said each of said groups is represented by p=15.

4. The method of claim 3, wherein if said block of pixels is to be encoded in frame mode, said step of scanning said two dimensional array frequency coefficients in each of said number of four by four blocks comprises:
assigning a scanning order=0 to a two dimensional array frequency coefficient located at n=0 and m=0;
assigning a scanning order=1 to a two dimensional array frequency coefficient located at n=1 and m=0;
assigning a scanning order=2 to a two dimensional array frequency coefficient located at n=0 and m=1;
assigning a scanning order=3 to a two dimensional array frequency coefficient located at n=0 and m=2;
assigning a scanning order=4 to a two dimensional array frequency coefficient located at n=1 and m=1;
assigning a scanning order=5 to a two dimensional array frequency coefficient located at n=2 and m=0;
assigning a scanning order=6 to a two dimensional array frequency coefficient located at n=3 and m=0;
assigning a scanning order=7 to a two dimensional array frequency coefficient located at n=2 and m=1;
assigning a scanning order=8 to a two dimensional array frequency coefficient located at n=1 and m=2;
assigning a scanning order=9 to a two dimensional array frequency coefficient located at n=0 and m=3;
assigning a scanning order=10 to a two dimensional array frequency coefficient located at n=1 and m=3;
assigning a scanning order=11 to a two dimensional array frequency coefficient located at n=2 and m=2;
assigning a scanning order=12 to a two dimensional array frequency coefficient located at n=3 and m=1;
assigning a scanning order=13 to a two dimensional array frequency coefficient located at n=3 and m=2;
assigning a scanning order=14 to a two dimensional array frequency coefficient. located at n=2 and m=3; and
assigning a scanning order=15 to a two dimensional array frequency coefficient located at n=3 and m=3.

5. The method of claim 4, wherein said step of scanning said two dimensional array frequency coefficients in each of said number of four by four blocks further comprises:
assigning a one dimensional array frequency coefficient located at p=0 in a corresponding group of sixteen one dimensional array frequency coefficients a value of said two dimensional array frequency coefficient located at n=0 and m=0.
assigning a one dimensional array frequency coefficient located at p=1 in said corresponding group of sixteen one dimensional array frequency coefficients a value of said two dimensional array frequency coefficient located at n=1 and m=0;
assigning a one dimensional array frequency coefficient located at p=2 in said corresponding group of sixteen one dimensional array frequency coefficients a value of said two dimensional array frequency coefficient located at n=0 and m=1;
assigning a one dimensional array frequency coefficient located at p=3 in said corresponding group of sixteen one dimensional array frequency coefficients a value of said two dimensional array frequency coefficient located at n=0 and m=2;
assigning a one dimensional array frequency coefficient located at p=4 in said corresponding group of sixteen one dimensional array frequency coefficients a value of said two dimensional array frequency coefficient located at n=1 and m=1;
assigning a one dimensional array frequency coefficient located at p=5 in said corresponding group of sixteen one dimensional array frequency coefficients a value of said two dimensional array frequency coefficient located at n=2 and m=0;
assigning a one dimensional array frequency coefficient located at p=6 in said corresponding group of sixteen one dimensional array frequency coefficients a value of said two dimensional array frequency coefficient located at n=3 and m=0;
assigning a one dimensional array frequency coefficient located at p=7 in said corresponding group of sixteen one dimensional array frequency coefficients a value of said two dimensional array frequency coefficient located at n=2 and m=1;
assigning a one dimensional array frequency coefficient located at p=8 in said corresponding group of sixteen one dimensional array frequency coefficients a value of said two dimensional array frequency coefficient located at n=1 and m=2;
assigning a one dimensional array frequency coefficient located at p=9 in said corresponding group of sixteen one dimensional array frequency coefficients a value of said two dimensional array frequency coefficient located at n=0 and m=3;
assigning a one dimensional array frequency coefficient located at p=10 in said corresponding group of sixteen one dimensional array frequency coefficients a value of said two dimensional array frequency coefficient located at n=1 and m=3;
assigning a one dimensional array frequency coefficient located at p=11 in said corresponding group of sixteen one dimensional array frequency coefficients a value of said two dimensional array frequency coefficient located at n=2 and m=2;
assigning a one dimensional array frequency coefficient located at p=12 in said corresponding group of sixteen one dimensional array frequency coefficients a value of said two dimensional array frequency coefficient located at n=3 and m=1;
assigning a one dimensional array frequency-coefficient located at p=13 in said corresponding group of sixteen one dimensional array frequency coefficients a value of said two dimensional array frequency coefficient located at n=3 and m=2;
assigning a one dimensional array frequency coefficient located at p=14 in said corresponding group of sixteen one dimensional array frequency coefficients a value of said two dimensional array frequency coefficient located at n=2 and m=3; and
assigning a one dimensional array frequency coefficient located at p=15 in said corresponding group of sixteen one dimensional array frequency coefficients a value of said two dimensional array frequency coefficient located at n=3 and m=3.

6. The method of claim 5, further comprising:
scanning each of said number of groups of sixteen one dimensional array frequency coefficients in said numerical sequential order, said scanning starting at p=0 and ending at p=15; and
producing said two dimensional array of said two dimensional array frequency coefficients.

7. The method of claim 6, wherein, for each of said number of groups of sixteen one dimensional array frequency coefficients, said step of scanning said each of said number of groups of sixteen one dimensional array frequency coefficients further comprises:
assigning a two dimensional array frequency coefficient located at n=0 and m=0 in a corresponding four by four block of said two dimensional array frequency coefficients a value of said one dimensional array frequency coefficient located at p=0;
assigning a two dimensional array frequency coefficient located at n=1 and m=0 in said corresponding four by four block of said two dimensional array frequency coefficients a value of said one dimensional array frequency coefficient located at p=1;
assigning a two dimensional array frequency coefficient located at n=0 and m=1 in said corresponding four by four block of said two dimensional array frequency coefficients a value of said one dimensional array frequency coefficient located at p=2;
assigning a two dimensional array frequency coefficient located at n=0 and m=2 in said corresponding four by four block of said two dimensional array frequency coefficients a value of said one dimensional array frequency coefficient located at p=3;
assigning a two dimensional array frequency coefficient located at n=1 and m=1 in said corresponding four by four block of said two dimensional array frequency coefficients a value of said one dimensional array frequency coefficient located at p=4;
assigning a two dimensional array frequency coefficient located at n=2 and m=0 in said corresponding four by four block of said two dimensional array frequency coefficients a value of said one dimensional array frequency coefficient located at p=5;
assigning a two dimensional array frequency coefficient located at n=3 and m=0 in said corresponding four by four block of said two dimensional array frequency coefficients a value of said one dimensional array frequency coefficient located at p=6;
assigning a two dimensional array frequency coefficient located at n=2 and m=1 in said corresponding four by four block of said two dimensional array frequency coefficients a value of said one dimensional array frequency coefficient located at p=7;
assigning a two dimensional array frequency coefficient located at n=1 and m=2 in said corresponding four by four block of said two dimensional array frequency coefficients a value of said one dimensional array frequency coefficient located at p=8;
assigning a two dimensional array frequency coefficient located at n=0 and m=3 in said corresponding four by four block of said two dimensional array frequency coefficients a value of said one dimensional array frequency coefficient located at p=9;
assigning a two dimensional array frequency coefficient located at n=1 and m=3 in said corresponding four by four block of said two dimensional array frequency coefficients a value of said one dimensional array frequency coefficient located at p=10;
assigning a two dimensional array frequency coefficient located at n=2 and m=2 in said corresponding four by four block of said two dimensional array frequency coefficients a value of said one dimensional array frequency coefficient located at p=11;
assigning a two dimensional array frequency coefficient located at n=3 and m=1 in said corresponding four by four block of said two dimensional array frequency coefficients a value of said one dimensional array frequency coefficient located at p=12;
assigning a two dimensional array frequency coefficient located at n=3 and m=2 in said corresponding four by four block of said two dimensional array frequency coefficients a value of said one dimensional array frequency coefficient located at p=13;
assigning a two dimensional array frequency coefficient located at n=2 and m=3 in said corresponding four by four block of said two dimensional array frequency coefficients a value of said one dimensional array frequency coefficient located at p=14; and
assigning a two dimensional array frequency coefficient located at n=3 and m=3 in said corresponding four by four block of said two dimensional array frequency coefficients a value of said one dimensional array frequency coefficient located at p=15.

8. The method of claim 5, wherein if said two dimensional array of said two dimensional array frequency coefficients comprises four columns and four rows of said two dimensional array frequency coefficients:
said step of dividing said two dimensional array into a number of four by four blocks of two dimensional array frequency coefficients comprises dividing said two dimensional array into a single four by four block comprising all of said two dimensional array frequency coefficients in said two dimensional array.

9. The method of claim 8, wherein:
said one dimensional array of said one dimensional array frequency coefficients comprises 16 one dimensional array frequency coefficients at positions 0 through 15 in said one dimensional array, wherein a first one dimensional array frequency coefficient of said one dimensional array is at position 0 and a sixteenth one dimensional array frequency coefficient of said one dimensional array is at position 15; and
said number of groups of sixteen one dimensional array frequency coefficients comprises a first group comprising one dimensional array frequency coefficients at positions 0 through 15 in said one dimensional array, said first group being said corresponding group of sixteen one dimensional array frequency coefficients for said single four by four block.

10. The method of claim 9, wherein:
said two dimensional array frequency coefficients of said single four by four block are scanned using said step of scanning said two dimensional array frequency coefficients.

11. The method of claim 7, wherein if said one dimensional array of one dimensional array frequency coefficients comprises 16 one dimensional array frequency coefficients at positions 0 through 15 in said one dimensional array, said two dimensional array of said two dimensional array frequency coefficients comprises four columns and four rows of said two dimensional array frequency coefficients and said number of groups of sixteen one dimensional array frequency coefficients comprises:
a first group comprising one dimensional array frequency coefficients at positions 0 through 15 in said one dimensional array.

12. The method of claim 11, wherein:
said first group's said corresponding four by four block of said two dimensional array frequency coefficients is a single four by four block comprising said all of said two dimensional array frequency coefficients in said two dimensional array.

13. The method of claim 5, wherein if said two dimensional array of said two dimensional array frequency coefficients comprises four columns and eight rows of said two dimensional array frequency coefficients:
said step of dividing said two dimensional array into a number of four by four blocks of two dimensional array frequency coefficients comprises dividing said two dimensional array into a top four by four block comprising the top four rows of said two dimensional array frequency coefficients in said two dimensional array and a bottom four by four block comprising the bottom four rows of said two dimensional array frequency coefficients in said two dimensional array.

14. The method of claim 13, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said top four by four block and said second group being said corresponding group of sixteen one dimensional array frequency coefficients for said bottom four by four block.

15. The method of claim 14, wherein:
said two dimensional array frequency coefficients of said top four by four block are scanned first using said step of scanning said two dimensional array frequency coefficients; and
said two dimensional array frequency coefficients of said bottom four by four block are scanned second using said step of scanning said two dimensional array frequency coefficients.

16. The method of claim 7, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises four columns and eight rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

17. The method of claim 16, wherein:
said first group's said corresponding four by four block of said two dimensional array frequency coefficients is a top four by four block comprising the top four rows of said two dimensional array frequency coefficients in said two dimensional array; and
said second group's said corresponding four by four block of said two dimensional array frequency coefficients is a bottom four by four block comprising the bottom four rows of said two dimensional array frequency coefficients in said two dimensional array.

18. The method of claim 5, wherein if said two dimensional array of said two dimensional array frequency coefficients comprises eight columns and four rows of said two dimensional array frequency coefficients:
said step of dividing said two dimensional array into a number of four by four blocks of two dimensional array frequency coefficients comprises dividing said two dimensional array into a left four by four block comprising the left-most four columns of said two dimensional array frequency coefficients in said two dimensional array and a right four by four block comprising the right-most four columns of said two dimensional array frequency coefficients in said two dimensional array.

19. The method of claim 18, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said left four by four block and said second group being said corresponding group of sixteen one dimensional array frequency coefficients for said right four by four block.

20. The method of claim 19, wherein:
said two dimensional array frequency coefficients of said left four by four block are scanned first using said step of scanning said two dimensional array frequency coefficients; and
said two dimensional array frequency coefficients of said right four by four block are scanned second using said step of scanning said two dimensional array frequency coefficients.

21. The method of claim 7, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises eight columns and four rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

22. The method of claim 21, wherein:
said first group's said corresponding four by four block of said two dimensional array frequency coefficients is a left four by four block comprising the left-most four columns of said two dimensional~array frequency coefficients in said two dimensional array; and
said second group's said corresponding four by four block of said two dimensional array frequency coefficients is a right four by four block comprising the right-most four columns of said two dimensional array frequency coefficients in said two dimensional array.

23. The method of claim 5, wherein if said two dimensional array of said two dimensional array frequency coefficients comprises eight columns and eight rows of said two dimensional array frequency coefficients, said step of dividing said two dimensional array into a number of four by four blocks of two dimensional array frequency coefficients comprises dividing said two dimensional array into:
a top-left four by four block comprising said two dimensional array frequency coefficients in both the top four rows and in the left-most four columns of said two dimensional array;
a top-right four by four block comprising said two dimensional array frequency coefficients in both the top four rows and in the right-most four columns of said two dimensional array;
a bottom-left four by four block comprising said two dimensional array frequency coefficients in both the bottom four rows and in the left-most four columns of said two dimensional array; and
a bottom-right four by four block comprising said two dimensional array frequency coefficients in both the bottom four rows and in the right-most four columns of said two dimensional array.

24. The method of claim 23, wherein:
said one dimensional array of said one dimensional array frequency coefficients comprises 64 frequency coefficients at positions 0 through 63 in said one dimensional array, wherein a first one dimensional array frequency coefficient of said one dimensional array is at position 0 and a sixty-fourth one dimensional array frequency coefficient of said one dimensional array is at position 63; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, and a fourth group comprising one dimensional array frequency coefficients at positions 48 through 63 in said one dimensional array, said first group being said corresponding group of sixteen one dimensional array frequency coefficients for said top-left four by four block, said second group being said corresponding group of sixteen one dimensional array frequency coefficients for said top-right four by four block, said third group being said corresponding group of sixteen one dimensional array frequency coefficients for said bottom-left four by four block, said fourth group being said corresponding group of sixteen one dimensional array frequency coefficients for said bottom-right four by four block.

25. The method of claim 24, wherein:
said two dimensional array frequency coefficients of said top-left four by four block are scanned first using said step of scanning said two dimensional array frequency coefficients;
said two dimensional array frequency coefficients of said top-right four by four block are scanned second using said step of scanning said two dimensional array frequency coefficients;
s said two dimensional array frequency coefficients of aid bottom-left four by four block are scanned third using said step of scanning said two dimensional array frequency coefficients; and
said two dimensional array frequency coefficients of said bottom-right four by four block are scanned fourth using said step of scanning said two dimensional array frequency coefficients.

26. The method of claim 7, wherein if said one dimensional array of said one dimensional array frequency-coefficients comprises 64 one dimensional array frequency coefficients at positions 0 through 63 in said one dimensional array, said two dimensional array of said two dimensional array frequency coefficients comprises eight columns and eight rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47. in said one dimensional array; and
a fourth group comprising one dimensional array frequency coefficients at positions 48 through 63 in said one dimensional array.

27. The method of claim 26, wherein:
said first group's said corresponding four by four block of said two dimensional array frequency coefficients is a top-left four by four block comprising said two dimensional array frequency coefficients in both the top four rows and in the left-most four columns of said two dimensional array;
said second group's said corresponding four by four block of said two dimensional array frequency coefficients is a top-right four by four block comprising said two dimensional array frequency coefficients in both the top four rows and in the right-most four columns of said two dimensional array;
said third group's said corresponding four by four block of said two dimensional array frequency coefficients is a bottom-left four by four block comprising said two dimensional array frequency coefficients in both the bottom four rows and in the left-most four columns of said two dimensional array; and
said fourth group's said corresponding four by four block of said two dimensional array frequency coefficients is said bottom-right four by four block comprising said two dimensional array frequency coefficients in both the bottom four rows and in the right-most four columns of said two dimensional array.

28. The method of claim 5, wherein if said two dimensional array of said two dimensional array frequency coefficients comprises eight columns and sixteen rows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the right-most four columns of said two dimensional array;
a third four by four block comprising said two dimensional array frequency coefficients in both the fourth through seventh rows from the top of said two dimensional array and in the left-most four columns of said two dimensional array;
a fourth four by four block comprising said two dimensional array frequency coefficients in both the fourth through seventh rows from the top of said two dimensional array and in the right-most four columns of said two dimensional array;
a fifth four by four block comprising said two dimensional array frequency coefficients in both the eighth through eleventh rows from the top of said two dimensional array and in the left-most four columns of said two dimensional array;
a sixth four by four block comprising said two dimensional array frequency coefficients in both the eighth through eleventh rows from the top of said two dimensional array and in the right-most four columns of said two dimensional array;
a seventh four by four block comprising said two dimensional array frequency coefficients in both the bottom four rows and in the left-most four columns of said two dimensional array; and
an eighth four by four block comprising said two dimensional array frequency coefficients in both the bottom four rows and in the right-most four columns of said two dimensional array.

29. The method of claim 28, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

30. The method of claim 29, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh using said step of scanning said two dimensional array frequency coefficients; and
said two dimensional array frequency coefficients of said eighth four by four block are scanned eighth using said step of scanning said two dimensional array frequency coefficients.

31. The method of claim 7, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

32. The method of claim 31, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the right-most four columns of said two dimensional array;
said third group's said corresponding four by four block of said two dimensional array frequency coefficients is a third four by four block comprising said two dimensional array frequency coefficients in both the fourth through seventh from the top of said two dimensional array and in the left-most four columns of said two dimensional array;
said fourth group's said corresponding four by four block of said two dimensional array frequency coefficients is a fourth four by four block comprising said two dimensional array frequency coefficients in both the fourth through seventh rows from the top of said two dimensional array and in the right-most four columns of said two dimensional array;
said fifth group's said corresponding four by four block of said two dimensional array frequency coefficients is a fifth four by four block comprising said two dimensional array frequency coefficients in both the eighth through eleventh rows from the top of said two dimensional array and in the left-most four columns of said two dimensional array;
said sixth group's said corresponding four by four block of said two dimensional array frequency coefficients is a sixth four by four block comprising said two dimensional array frequency coefficients in both the eighth through eleventh rows from the top of said two dimensional array and in the right-most four columns of said two dimensional array;
said seventh group's said corresponding four by four block of said two dimensional array frequency coefficients is a seventh four by four block comprising said two dimensional array frequency coefficients in both the bottom four rows and in the left-most four columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

33. The method of claim 5, wherein if said two dimensional array of said two dimensional array frequency coefficients comprises sixteen columns and eight rows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the fourth through seventh columns of said two dimensional array;
a third four by four block comprising said two dimensional array frequency coefficients in both the bottom four rows and in the first four columns of said two dimensional array;
a fourth four by four block comprising said two dimensional array frequency coefficients in both the bottom four rows and in the fourth through seventh columns of said two dimensional array;
a fifth four by four block comprising said two dimensional array frequency coefficients in both the top four rows and in the eighth through eleventh columns of said two dimensional array;
a sixth four by four block comprising said two dimensional array frequency coefficients in both the top four rows and in the right-most four columns of said two dimensional array;
a seventh four by four block comprising said two dimensional array frequency coefficients in both the bottom four rows and in the eighth through eleventh columns of said two dimensional array; and
an eighth four by four block comprising said two dimensional array frequency coefficients in both the bottom four rows and in the right-most four columns of said two dimensional array.

34. The method of claim 33, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

35. The method of claim 34, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh using said step of scanning said two dimensional array frequency coefficients; and
said two dimensional array frequency coefficients of said eighth four by four block are scanned eighth using said step of scanning said two dimensional array frequency coefficients.

36. The method of claim 7, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

37. The method of claim 36, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensionally array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array I frequency coefficients in both the bottom four rows and in the first four columns of said two dimensional array;
said fourth group's said corresponding four by four block of said two dimensional array frequency coefficients is a fourth four by four block comprising said two dimensional array frequency coefficients in both the bottom four rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the bottom four rows and in the eighth through eleventh columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

38. The method of claim 5, wherein if said two dimensional array of said two dimensional array frequency coefficients comprises sixteen columns and sixteen rows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the fourth through seventh columns of said two dimensional array;
a third four by four block comprising said two dimensional array frequency coefficients in both the fourth through seventh rows four rows and in the first four columns of said two dimensional array;
a fourth four by four block comprising said two dimensional array frequency coefficients in both the fourth through seventh rows and in the fourth through seventh columns of said two dimensional array;
a fifth four by four block comprising said two dimensional array frequency coefficients in both the top four rows and in the eighth through eleventh columns of said two dimensional array;
a sixth four by four block comprising said two dimensional array frequency coefficients in both the top four rows and in the right-most four columns of said two dimensional array;
a seventh four by four block comprising said two dimensional array frequency coefficients in both the fourth through seventh rows and in the eighth through eleventh columns of said two dimensional array;
an eighth four by four block comprising said two dimensional array frequency coefficients in both the fourth through seventh rows and in the right-most four columns of said two dimensional array;
a ninth four by four block comprising said two dimensional array frequency coefficients in the eighth through eleventh rows and in the left-most four columns of said two dimensional array;
a tenth four by four block comprising said two dimensional array frequency coefficients in both the eighth through eleventh rows and in the fourth through seventh columns of said two dimensional array;
an eleventh four by four block comprising said two dimensional array frequency coefficients in the bottom four rows and in the first four columns of said two dimensional array;
a twelfth fourth four by four block comprising said two dimensional array frequency coefficients in both the bottom four rows and in the fourth through seventh columns of said two dimensional array;
a thirteenth four by four block comprising said two dimensional array frequency coefficients in both the eighth through eleventh rows and in the eighth through eleventh columns of said two dimensional array;
a fourteenth four by four block comprising said two dimensional array frequency coefficients in both the eighth through eleventh rows and in the right-most four columns of said two dimensional array;
a fifteenth four by four block comprising said two dimensional array frequency coefficients in both the bottom four rows and in the eighth through eleventh columns of said two dimensional array; and
a sixteenth four by four block comprising said two dimensional array frequency coefficients in both the bottom four rows and in the right-most four columns of said two dimensional array.

39. The method of claim 38, wherein:
said one dimensional array of said one dimensional array frequency coefficients comprises 256 one dimensional array frequency coefficients at positions 0 through 255 in said one dimensional array, wherein a first one dimensional array frequency coefficient of said one dimensional array is at position 0 and a two hundred and fifth-sixth one dimensional array frequency coefficient of said one dimensional array is at position 255; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, a ninth group comprising one dimensional array frequency coefficients at positions 128 through 143 in said one dimensional array, a tenth group comprising one dimensional array frequency coefficients at positions 144 through 159 in said one dimensional array, an eleventh group comprising one dimensional array frequency coefficients at positions 160 through 175 in said one dimensional array, a twelfth group comprising one dimensional array frequency coefficients at positions 176 through 191 in said one dimensional array, a thirteenth group comprising one dimensional array frequency coefficients at positions 192 through 207 in said one dimensional array, a fourteenth group comprising one dimensional array frequency coefficients at positions 208 through 223 in said one dimensional array, a fifteenth group comprising one dimensional array frequency coefficients at positions 224 through 239 in said one dimensional array, and a sixteenth group comprising one dimensional array frequency coefficients at positions 240 through 255 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block, said ninth group being said corresponding group of sixteen one dimensional array frequency coefficients for said ninth four by four block, said tenth group being said corresponding group of sixteen one dimensional array frequency coefficients for said tenth four by four block, said eleventh group being said corresponding group of sixteen one dimensional array frequency coefficients for said eleventh four by four block, said twelfth group being said corresponding group of sixteen one dimensional array frequency coefficients for said twelfth four by four block, said thirteenth group being said corresponding group of sixteen one dimensional array frequency coefficients for said thirteenth four by four block, said fourteenth group being said corresponding group of sixteen one dimensional array frequency coefficients for said fourteenth four by four block, said fifteenth-group being said corresponding group of sixteen one dimensional array frequency coefficients for said fifteenth four by four block, said sixteenth group being said corresponding group of sixteen one dimensional array frequency coefficients for said sixteenth four by four block.

40. The method of claim 39, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh using said step of scanning said two dimensional array frequency coefficients;
said two dimensional array frequency coefficients of said eighth four by four block are scanned eighth using said step of scanning said two dimensional array frequency coefficients;
said two dimensional array frequency coefficients of said ninth four by four block are scanned ninth using said step of scanning said two dimensional array frequency coefficients;
said two dimensional array frequency coefficients of said tenth four by four block are scanned tenth using said step of scanning said two dimensional array frequency coefficients;
said two dimensional array frequency coefficients of said eleventh four by four block are scanned eleventh using said step of scanning said two dimensional array frequency coefficients;
said two dimensional array frequency coefficients of said twelfth four by four block are scanned twelfth using said step of scanning said two dimensional array frequency coefficients;
said two dimensional array frequency coefficients of said thirteenth four by four block are scanned thirteenth using said step of scanning said two dimensional array frequency coefficients;
said two dimensional array frequency coefficients of said fourteenth four by four block are scanned fourteenth using said step of scanning said two dimensional array frequency coefficients;
said two dimensional array frequency coefficients of said fifteenth four by four block are scanned fifteenth using said step of scanning said two dimensional array frequency coefficients; and
said two dimensional array frequency coefficients of said sixteenth four by four block are scanned sixteenth using said step of scanning said two dimensional array frequency coefficients.

41. The method of claim 7, wherein if said one dimensional array of said one dimensional array frequency coefficients comprises 256 one dimensional array frequency coefficients at positions 0 through 255 in said one dimensional array, said two dimensional array of said two dimensional array frequency coefficients comprises sixteen columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array;
an eighth group comprising one dimensional array frequency coefficients at positions 112 through 127 in said one dimensional array;
a ninth group comprising one dimensional array frequency coefficients at positions 128 through 143 in said one dimensional array;
a tenth group comprising one dimensional array frequency coefficients at positions 144 through 159 in said one dimensional array;
an eleventh group comprising one dimensional array frequency coefficients at positions 160 through 175 in said one dimensional array;
a twelfth group comprising one dimensional array frequency coefficients at positions 176 through 191 in said one dimensional array;
a thirteenth group comprising one dimensional array frequency coefficients at positions 192 through 207 in said one dimensional array;
a fourteenth group comprising one dimensional array frequency coefficients at positions 208 through 223 in said one dimensional array;
a fifteenth group comprising one dimensional array frequency coefficients at positions 224 through 239 in said one dimensional array; and
a sixteenth group comprising one dimensional array frequency coefficients at positions 240 through 255 in said one dimensional array.

42. The method of claim 41, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the fourth through seventh rows four rows and in the first four columns of said two dimensional array;
said fourth group's said corresponding four by four block of said two dimensional array frequency coefficients is a fourth four by four block comprising said two dimensional array frequency coefficients in both the fourth through seventh rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the fourth through seventh rows and in the eighth through eleventh columns of said two dimensional array;
said eighth group's said corresponding four by four block of said two dimensional array frequency coefficients is an eighth four by four block comprising said two dimensional array frequency coefficients in both the fourth through seventh rows and in the right-most four columns of said two dimensional array;
said ninth group's said corresponding four by four block of said two dimensional array frequency coefficients is a ninth four by four block comprising said two dimensional array frequency coefficients in the eighth through eleventh rows and in the left-most four columns of said two dimensional array;
said tenth group's said corresponding four by four block of said two dimensional array frequency coefficients is a tenth four by four block comprising said two dimensional array frequency coefficients in both the eighth through eleventh rows and in the fourth through seventh columns of said two dimensional array;
said eleventh group's said corresponding four by four block of said two dimensional array frequency coefficients is an eleventh four by four block comprising said two dimensional array frequency coefficients in the bottom four rows and in the first four columns of said two dimensional array;
said twelfth group's said corresponding four by four block of said two dimensional array frequency coefficients is a twelfth fourth four by four block comprising said two dimensional array frequency coefficients in both the bottom four rows and in the fourth through seventh columns of said two dimensional array;
said thirteenth group's said corresponding four by four block of said two dimensional array frequency coefficients is a thirteenth four by four block comprising said two dimensional array frequency coefficients in both the eighth through eleventh rows and in the eighth through eleventh columns of said two dimensional array;
said fourteenth group's said corresponding four by four block of said two dimensional array frequency coefficients is a fourteenth four by four block comprising said two dimensional array frequency coefficients in both the eighth through eleventh rows and in the right-most four columns of said two dimensional array;
said fifteenth group's said corresponding four by four block of said two dimensional array frequency coefficients is a fifteenth four by four block comprising said two dimensional array frequency coefficients in both the bottom four rows and in the eighth through eleventh columns of said two dimensional array;
said sixteenth group's said corresponding four by four block of said two dimensional array frequency coefficients is a sixteenth four by four block comprising said two dimensional array frequency coefficients in both the bottom four rows and in the right-most four columns of said two dimensional array.

43. The method of claim 3, wherein if said block of pixels is to be encoded in field mode, said step of scanning said two dimensional array frequency coefficients in each of said number of four by four blocks comprises:
assigning a scanning order=0 to a two dimensional array frequency coefficient located at n=0 and m=0;
assigning a scanning order=1 to a two dimensional array frequency coefficient located at n=0 and m=1;
assigning a scanning order=2 to a two dimensional array frequency coefficient located at n=1 and m=0;
assigning a scanning order=3 to a two dimensional array frequency coefficient located at n=0 and m=2;
assigning a scanning order=4 to a two dimensional array frequency coefficient located at n=0 and m=3;
assigning a scanning order=5 to a two dimensional array frequency coefficient located at n=1 and m=1;
assigning a scanning order=6 to a two dimensional array frequency coefficient located at n=1 and m=2;
assigning a scanning order=7 to a two dimensional array frequency coefficient located at n=1 and m=3;
assigning a scanning order=8 to a two dimensional array frequency coefficient located at n=2 and m=0;
assigning a scanning order=9 to a two dimensional array frequency coefficient located at n=2 and m=1;
assigning a scanning order=10 to a two dimensional array frequency coefficient located at n=2 and m=2;
assigning a scanning order=11 to a two dimensional array frequency coefficient located at n=2 and m=3;
assigning a scanning order=12 to a two dimensional array frequency coefficient located at n=3 and m=0;
assigning a scanning order=13 to a two dimensional array frequency coefficient located at n=3 and m=1;
assigning a scanning order=14 to a two dimensional array frequency coefficient located at n=3 and m=2; and
assigning a scanning order=15 to a two dimensional array frequency coefficient located at n=3 and m=3.

44. The method of claim 43, wherein said step of scanning said two dimensional array frequency coefficients in each of said number of four by four blocks further comprises:
assigning a one dimensional array frequency coefficient located at p=0 in a corresponding group of sixteen one dimensional array frequency coefficients a value of said two dimensional array frequency coefficient located at n=0 and m=0.
assigning a one dimensional array frequency coefficient located at p=1 in said corresponding group of sixteen one dimensional array frequency coefficients a value of said two dimensional array frequency coefficient located at n=0 and m=1;
assigning a one dimensional array frequency coefficient located at p=2 in said corresponding group of sixteen one dimensional array frequency coefficients a value of said two dimensional array frequency coefficient located at n=1 and m=0;
assigning a one dimensional array frequency coefficient located at p=3 in said corresponding group of sixteen one dimensional array frequency coefficients a value of said two dimensional array frequency coefficient located at n=0 and m=2;
assigning a one dimensional array frequency coefficient located at p=4 in said corresponding group of sixteen one dimensional array frequency coefficients a value of said two dimensional array frequency coefficient located at n=0 and m=3;
assigning a one dimensional array frequency coefficient located at p=5 in said corresponding group of sixteen one dimensional array frequency coefficients a value of said two dimensional array frequency coefficient located at n=1 and m=1;
assigning a one dimensional array frequency coefficient located at p=6 in said corresponding group of sixteen one dimensional array frequency coefficients a value of said two dimensional array frequency coefficient located at n=1 and m=2;
assigning a one dimensional array frequency coefficient located at p=7 in said corresponding group of sixteen one dimensional array frequency coefficients a value of said two dimensional array frequency coefficient located at n=1 and m=3;
assigning a one dimensional array frequency coefficient located at p=8 in said corresponding group of sixteen one dimensional array frequency coefficients a value of said two dimensional array frequency coefficient located at n=2 and m=0;
assigning a one dimensional array frequency coefficient located at p=9 in said corresponding group of sixteen one dimensional array frequency coefficients a value of said two dimensional array frequency coefficient located at n=2 and m=1;
assigning a one dimensional array frequency coefficient located at p=10 in said corresponding group of sixteen one dimensional array frequency coefficients a value of said two dimensional array frequency coefficient located at n=2 and m=2;
assigning a one dimensional array frequency coefficient located at p=11 in said corresponding group of sixteen one dimensional array frequency coefficients a value of said two dimensional array frequency coefficient located at n=2 and m=3;
assigning a one dimensional array frequency coefficient located at p=12 in said corresponding group of sixteen one dimensional array frequency coefficients a value of said two dimensional array frequency coefficient located at n=3 and m=0;
assigning a one dimensional array frequency coefficient located at p=13 in said corresponding group of sixteen one dimensional array frequency coefficients a value of said two dimensional array frequency coefficient located at n=3 and m=1;
assigning a one dimensional array frequency coefficient located at p=14 in said corresponding group of sixteen one dimensional array frequency coefficients a value of said two dimensional array frequency coefficient located at n=3 and m=2; and
assigning a one dimensional array frequency coefficient located at p=15 in said corresponding group of sixteen one dimensional array frequency coefficients a value of said two dimensional array frequency coefficient located at n=3 and m=3.

45. The method of claim 44, further comprising:
scanning each of said number of groups of sixteen one dimensional array frequency coefficients in said numerical sequential order, said scanning starting at p=0 and ending at p=15; and
producing said two dimensional array of said two dimensional array frequency coefficients.

46. The method of claim 45, wherein, for each of said number of groups of sixteen one dimensional array frequency coefficients, said step of scanning said each of said number of groups of sixteen one dimensional array frequency coefficients further comprises:
assigning a two dimensional array frequency coefficient located at n=0 and m=0 in a corresponding four by four block of said two dimensional array frequency coefficients a value of said one dimensional array frequency coefficient located at p=0;
assigning a two dimensional array frequency coefficient located at n=0 and m=1 in said corresponding four by four block of said two dimensional array frequency coefficients a value of said one dimensional array frequency coefficient located at p=1;
assigning a two dimensional array frequency coefficient located at n=1 and m=0 in said corresponding four by four block of said two dimensional array frequency coefficients a value of said one dimensional array frequency coefficient located at p=2;
assigning a two dimensional array frequency coefficient located at n=0 and m=2 in said corresponding four by four block of said two dimensional array frequency coefficients a value of said one dimensional array frequency coefficient located at p=3;
assigning a two dimensional array frequency coefficient located at n=0 and m=3 in said corresponding four by four block of said two dimensional array frequency coefficients a value of said one dimensional array frequency coefficient located at p=4;
assigning a two dimensional array frequency coefficient located at n=1 and m=1 in said corresponding four by four block of said two dimensional array frequency coefficients a value of said one dimensional array frequency coefficient located at p=5;
assigning a two dimensional array frequency coefficient located at n=1 and m=2 in said corresponding four by four block of said two dimensional array frequency coefficients a value of said one dimensional array frequency coefficient located at p=6;
assigning a two dimensional array frequency coefficient located at n=1 and m=3 in said corresponding four by four block of said two dimensional array frequency coefficients a value of said one dimensional array frequency coefficient located at p=7;
assigning a two dimensional array frequency coefficient located at n=2 and m=0 in said corresponding four by four block of said two dimensional array frequency coefficients a value of said one dimensional array frequency coefficient located at p=8;
assigning a two dimensional array frequency coefficient located at n=2 and m=1 in said corresponding four by four block of said two dimensional array frequency coefficients a value of said one dimensional array frequency coefficient located at p=9;
assigning a two dimensional array frequency coefficient located at n=2 and m=2 in said corresponding four by four block of said two dimensional array frequency coefficients a value of said one dimensional array frequency coefficient located at p=10;
assigning a two dimensional array frequency coefficient located at n=2 and m=3 in said corresponding four by four block of said two dimensional array frequency coefficients a value of said one dimensional array frequency coefficient located at p=11;
assigning a two dimensional array frequency coefficient located at n=3 and m=0 in said corresponding four by four block of said two dimensional array frequency coefficients a value of said one dimensional array frequency coefficient located at p=12;
assigning a two dimensional array frequency coefficient located at n=3 and m=1 in said corresponding four by four block of said two dimensional array frequency coefficients a value of said one dimensional array frequency coefficient located at p=13;
assigning a two dimensional array frequency coefficient located at n=3 and m=2 in said corresponding four by four block of said two dimensional array frequency coefficients a value of said one dimensional array frequency coefficient located at p=14; and
assigning a two dimensional array frequency coefficient located at n=3 and m=3 in said corresponding four by four block of said two dimensional array frequency coefficients a value of said one dimensional array frequency coefficient located at p=15.

47. The method of claim 44, wherein if said two dimensional array of said two dimensional array frequency coefficients comprises four columns and four rows of said two dimensional array frequency coefficients:
said step of dividing said two dimensional array into a number of four by four blocks of two dimensional array frequency coefficients comprises dividing said two dimensional array into a single four by four block comprising all of said two dimensional array frequency coefficients in said two dimensional array.

48. The method of claim 47, wherein:
said one dimensional array of said one dimensional array frequency coefficients comprises 16 one dimensional array frequency coefficients at positions 0 through 15 in said one dimensional array, wherein a first one dimensional array frequency coefficient of said one dimensional array is at position 0 and a sixteenth one dimensional array frequency coefficient of said one dimensional array is at position 15; and
said number of groups of sixteen one dimensional array frequency coefficients comprises a first group comprising one dimensional array frequency coefficients at positions 0 through 15 in said one dimensional array, said first group being said corresponding group of sixteen one dimensional array frequency coefficients for said single four by four block.

49. The method of claim 48, wherein:
said two dimensional array frequency coefficients of said single four by four block are scanned using said step of scanning said two dimensional array frequency coefficients.

50. The method of claim 46, wherein if said one dimensional array of one dimensional array frequency coefficients comprises 16 one dimensional array frequency coefficients at positions 0 through 15 in said one dimensional array, said two dimensional array of said two dimensional array frequency coefficients comprises four columns and four rows of said two dimensional array frequency coefficients and said number of groups of sixteen one dimensional array frequency coefficients comprises:
a first group comprising one dimensional array frequency coefficients at positions 0 through 15 in said one dimensional array.

51. The method of claim 50, wherein:
said first group's said corresponding four by four block of said two dimensional array frequency coefficients is a single four by four block comprising said all of said two dimensional array frequency coefficients in said two dimensional array.

52. The method of claim 44, wherein if said two dimensional array of said two dimensional array frequency coefficients comprises four columns and eight rows of said two dimensional array frequency coefficients:
said step of dividing said two dimensional array into a number of four by four blocks of two dimensional array frequency coefficients comprises dividing said two dimensional array into a top four by four block comprising the top four rows of said two dimensional array frequency coefficients in said two dimensional array and a bottom four by four block comprising the bottom four rows of said two dimensional array frequency coefficients in said two dimensional array.

53. The method of claim 52, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said top four by four block and said second group being said corresponding group of sixteen one dimensional array frequency coefficients for said bottom four by four block.

54. The method of claim 53, wherein:
said two dimensional array frequency coefficients of said top four by four block are scanned first using said step of scanning said two dimensional array frequency coefficients; and
said two dimensional array frequency coefficients of said bottom four by four block are scanned second using said step of scanning said two dimensional array frequency coefficients.

55. The method of claim 46, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises four columns arid eight rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

56. The method of claim 55, wherein:
said first group's said corresponding four by four block of said two dimensional array frequency coefficients is a top four by four block comprising the top four rows of said two dimensional array frequency coefficients in said two dimensional array; and
said second group's said corresponding four by four block of said two dimensional array frequency coefficients is a bottom four by four block comprising the bottom four rows of said two dimensional array frequency coefficients in said two dimensional array.

57. The method of claim 44, wherein if said two dimensional array of said two dimensional array frequency coefficients comprises eight columns and four rows of said two dimensional array frequency coefficients:
said step of dividing said two dimensional array into a number of four by four blocks of two dimensional array frequency coefficients comprises dividing said two dimensional array into a left four by four block comprising the left-most four columns of said two dimensional array frequency coefficients in said two dimensional array and a right four by four block comprising the right-most four columns of said two dimensional array frequency coefficients in said two dimensional array.

58. The method of claim 57, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said left four by four block and said second group being said corresponding group of sixteen one dimensional array frequency coefficients for said right four by four block.

59. The method of claim 58, wherein:
said two dimensional array frequency coefficients of said left four by four block are scanned first using said step of scanning said two dimensional array frequency coefficients; and
said two dimensional array frequency coefficients of said right four by four block are scanned second using said step of scanning said two dimensional array frequency coefficients.

60. The method of claim 46, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises eight columns and four rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

61. The method of claim 60, wherein:
said first group's said corresponding four by four block of said two dimensional array frequency coefficients is a left four by four block comprising the left-most four columns of said two dimensional array frequency coefficients in said two dimensional array; and
said second group's said corresponding four by four block of said two dimensional array frequency coefficients is a right four by four block comprising the right-most four columns of said two dimensional array frequency coefficients in said two dimensional array.

62. The method of claim 44, wherein if said two dimensional array of said two dimensional array frequency coefficients comprises eight columns and eight rows of said two dimensional array frequency coefficients, said step of dividing said two dimensional array into a number of four by four blocks of two dimensional array frequency coefficients comprises dividing said two dimensional array into:
a top-left four by four block comprising said two dimensional array frequency coefficients in both the top four rows and in the left-most four columns of said two dimensional array;
a top-right four by four block comprising said two dimensional array frequency coefficients in both the top four rows and in the right-most four columns of said two dimensional array;
a bottom-left four by four block comprising said two dimensional array frequency coefficients in both the bottom four rows and in the left-most four columns of said two dimensional array; and
a bottom-right four by four block comprising said two dimensional array frequency coefficients in both the bottom four rows and in the right-most four columns of said two dimensional array.

63. The method of claim 62, wherein:
said one dimensional array of said one dimensional array frequency coefficients comprises 64 frequency coefficients at positions 0 through 63 in said one dimensional array, wherein a first one dimensional array frequency coefficient of said one dimensional array is at position 0 and a sixty-fourth one dimensional array frequency coefficient of said one dimensional array is at position 63; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, and a fourth group comprising one dimensional array frequency coefficients at positions 48 through 63 in said one dimensional array, said first group being said corresponding group of sixteen one dimensional array frequency coefficients for said top-left four by four block, said second group being said corresponding group of sixteen one dimensional array frequency coefficients for said top-right four by four block, said third group being said corresponding group of sixteen one dimensional array frequency coefficients for said bottom-left four by four block, said fourth group being said corresponding group of sixteen one dimensional array frequency coefficients for said bottom-right four by four block.

64. The method of claim 63, wherein:
said two dimensional array frequency coefficients of said top-left four by four block are scanned first using said step of scanning said two dimensional array frequency coefficients;
said two dimensional array frequency coefficients of said top-right four by four block are scanned second using said step of scanning said two dimensional array frequency coefficients;
said two dimensional array frequency coefficients of said bottom-left four by four block are scanned third using said step of scanning said two dimensional array frequency coefficients; and
said two dimensional array frequency coefficients of said bottom-right four by four block are scanned fourth using said step of scanning said two dimensional array frequency coefficients.

65. The method of claim 46, wherein if said one dimensional array of said one dimensional array frequency coefficients comprises 64 one dimensional array frequency coefficients at positions 0 through 63 in said one dimensional array, said two dimensional array of said two dimensional array frequency coefficients comprises eight columns and eight rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array; and
a fourth group comprising one dimensional array frequency coefficients at positions 48 through 63 in said one dimensional array.

66. The method of claim 65, wherein:
said first group's said corresponding four by four block of said two dimensional array frequency coefficients is a top-left four by four block comprising said two dimensional array frequency coefficients in both the top four rows and in the left-most four columns of said two dimensional array;
said second group's said corresponding four by four block of said two dimensional array frequency coefficients is a top-right four by four block comprising said two dimensional array frequency coefficients in both the top four rows and in the right-most four columns of said two dimensional array;
said third group's said corresponding four by four block of said two dimensional array frequency coefficients is a bottom-left four by four block comprising said two dimensional array frequency coefficients in both the bottom four rows and in the left-most four columns of said two dimensional array; and
said fourth group's said corresponding four by four block of said two dimensional array frequency coefficients is said bottom-right four by four block comprising said two dimensional array frequency coefficients in both the bottom four rows and in the right-most four columns of said two dimensional array.

67. The method of claim 44, wherein if said two dimensional array of said two dimensional array frequency coefficients comprises eight columns and sixteen tows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the right-most four columns of said two dimensional array;
a third four by four block comprising said two dimensional array frequency coefficients in both the fourth through seventh rows from the top of said two dimensional array and in the left-most four columns of said two dimensional array;
a fourth four by four block comprising said two dimensional array frequency coefficients in both the fourth through seventh rows from the top of said two dimensional array and in the right-most four columns of said two dimensional array;
a fifth four by four block comprising said two dimensional array frequency coefficients in both the eighth through eleventh rows from the top of said two dimensional array and in the left-most four columns of said two dimensional array;
a sixth four by four block comprising said two dimensional array frequency coefficients in both the eighth through eleventh rows from the top of said two dimensional array and in the right-most four columns of said two dimensional array;
a seventh four by four block comprising said two dimensional array frequency coefficients in both the bottom four rows and in the left-most four columns of said two dimensional array; and
an eighth four by four block comprising said two dimensional array frequency coefficients in both the bottom four rows and in the right-most four columns of said two dimensional array.

68. The method of claim 67, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficient comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

69. The method of claim 68, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh using said step of scanning said two dimensional array frequency coefficients; and
said two dimensional array frequency coefficients of said eighth four by four block are scanned eighth using said step of scanning said two dimensional array frequency coefficients.

70. The method of claim 46, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

71. The method of claim 70, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the right-most four columns of said two dimensional array;
said third group's said corresponding four by four block of said two dimensional array frequency coefficients is a third four by four block comprising said two dimensional array frequency coefficients in both the fourth through seventh from the top of said two dimensional array and in the left-most four columns of said two dimensional array;
said fourth group's said corresponding four by four block of said two dimensional array frequency coefficients is a fourth four by four block comprising said two dimensional array frequency coefficients in both the fourth through seventh rows from the top of said two dimensional array and in the right-most four columns of said two dimensional array;
said fifth group's said corresponding four by four block of said two dimensional array frequency coefficients is a fifth four by four block comprising said two dimensional array frequency coefficients in both the eighth through eleventh rows from the top of said two dimensional array and in the left-most four columns of said two dimensional array;
said sixth group's said corresponding four by four block of said two dimensional array frequency coefficients is a sixth four by four block comprising said two dimensional array frequency coefficients in both the eighth through eleventh rows from the top of said two dimensional array and in the right-most four columns of said two dimensional array;
said seventh group's said corresponding four by four block of said two dimensional array frequency coefficients is a seventh four by four block comprising said two dimensional array frequency coefficients in both the bottom four rows and in the left-most four columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

72. The method of claim 44, wherein if said two dimensional array of said two dimensional array frequency coefficients comprises sixteen columns and eight rows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the fourth through seventh columns of said two dimensional array;
a third four by four block comprising said two dimensional array frequency coefficients in both the bottom four rows and in the first four columns of said two dimensional array;
a fourth four by four block comprising said two dimensional array frequency coefficients in both the bottom four rows and in the fourth through seventh columns of said two dimensional array;
a fifth four by four block comprising said two dimensional array frequency coefficients in both the top four rows and in the eighth through eleventh columns of said two dimensional array;
a sixth four by four block comprising said two dimensional array frequency coefficients in both the top four rows and in the right-most four columns of said two dimensional array;
a seventh four by four block comprising said two dimensional array frequency coefficients in both the bottom four rows and in the eighth through eleventh columns of said two dimensional array; and
an eighth four by four block comprising said two dimensional array frequency coefficients in both the bottom four rows and in the right-most four columns of said two dimensional array.

73. The method of claim 72, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

74. The method of claim 73, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh-using said step of scanning said two dimensional array frequency coefficients; and
said two dimensional array frequency coefficients of said eighth four by four block are scanned eighth using said step of scanning said two dimensional array frequency coefficients.

75. The method of claim 46, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

76. The method of claim 75, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the bottom four rows and in the first four columns of said two dimensional array;
said fourth group's said corresponding four by four block of said two dimensional array frequency coefficients is a fourth four by four block comprising said two dimensional array frequency coefficients in both the bottom four rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the bottom four rows and in the eighth through eleventh columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

77. The method of claim 44, wherein if said two dimensional array of said two dimensional array frequency coefficients comprises sixteen columns and sixteen rows of said two dimensional array frequency coefficients, said step of dividing said two dimensional array into a number of four by four blocks of two dimensional array frequency coefficients comprises dividing said two dimensional array into:
a first four by four block comprising said two dimensional array frequency coefficients in both the top four rows and in the left-most four columns of said two dimensional array;
a second four by four block comprising said two dimensional array frequency coefficients in both the top four rows and in the fourth through seventh columns of said two dimensional array;
a third four by four block comprising said two dimensional array frequency coefficients in both the fourth through seventh rows four rows and in the first four columns of said two dimensional array;
a fourth four by four block comprising said two dimensional array frequency coefficients in both the fourth through seventh rows and in the fourth through seventh columns of said two dimensional array;
a fifth four by four block comprising said two dimensional array frequency coefficients in both the top four rows and in the eighth through eleventh columns of said two dimensional array;
a sixth four by four block comprising said two dimensional array frequency coefficients in both the top four rows and in the right-most four columns of said two dimensional array;
a seventh four by four block comprising said two dimensional array frequency coefficients in both the fourth through seventh rows and in the eighth through eleventh columns of said two dimensional array;
an eighth four by four block comprising said two dimensional array frequency coefficients in both the fourth through seventh rows and in the right-most four columns of said two dimensional array;
a ninth four by four block comprising said two dimensional array frequency coefficients in the eighth through eleventh rows and in the left-most four columns of said two dimensional array;
a tenth four by four block comprising said two dimensional array frequency coefficients in both the eighth through eleventh rows and in the fourth through seventh columns of said two dimensional array;
an eleventh four by four block comprising said two dimensional array frequency coefficients in the bottom four rows and in the first four columns of said two dimensional array;
a twelfth fourth four by four block comprising said two dimensional array frequency coefficients in both the bottom four rows and in the fourth through seventh columns of said two dimensional array;
a thirteenth four by four block comprising said two dimensional array frequency coefficients in both the eighth through eleventh rows and in the eighth through eleventh columns of said two dimensional array;
a fourteenth four by four block comprising said two dimensional array frequency coefficients in both the eighth through eleventh rows and in the right-most four columns of said two dimensional array;
a fifteenth four by four block comprising said two dimensional array frequency coefficients in both the bottom four rows and in the eighth through eleventh columns of said two dimensional array; and
a sixteenth four by four block comprising said two dimensional array frequency coefficients in both the bottom four rows and in the right-most four columns of said two dimensional array.

78. The method of claim 77, wherein:
said one dimensional array of said one dimensional array frequency coefficients comprises 256 one dimensional array frequency coefficients at positions 0 through 255 in said one dimensional array, wherein a first one dimensional array frequency coefficient of said one dimensional array is at position 0 and a two hundred and fifth-sixth one dimensional array frequency coefficient of said one dimensional array is at position 255; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, a ninth group comprising one dimensional array frequency coefficients at positions 128 through 143 in said one dimensional array, a tenth group comprising one dimensional array frequency coefficients at positions 144 through 159 in said one dimensional array, an eleventh group comprising one dimensional array frequency coefficients at positions 160 through 175 in said one dimensional array, a twelfth group comprising one dimensional array frequency coefficients at positions 176 through 191 in said one dimensional array, a thirteenth group comprising one dimensional array frequency coefficients at positions 192 through 207 in said one dimensional array, a fourteenth group comprising one dimensional array frequency coefficients at positions 208 through 223 in said one dimensional array, a fifteenth group comprising one dimensional array frequency coefficients at positions 224 through 239 in said one dimensional array, and a sixteenth group comprising one dimensional array frequency coefficients at positions 240 through 255 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block, said ninth group being said corresponding group of sixteen one dimensional array frequency coefficients for said ninth four by four block, said tenth group being said corresponding group of sixteen one dimensional array frequency coefficients for said tenth four by four block, said eleventh group being said corresponding group of sixteen one dimensional array frequency coefficients for said eleventh four by four block, said twelfth group being said corresponding group of sixteen one dimensional array frequency coefficients for said twelfth four by four block, said thirteenth group being said corresponding group of sixteen one dimensional array frequency coefficients for said thirteenth four by four block, said fourteenth group being said corresponding group of sixteen one dimensional array frequency coefficients for said fourteenth four by four block, said fifteenth group being said corresponding group of sixteen one dimensional array frequency coefficients for said fifteenth four by four block, said sixteenth group being said corresponding group of sixteen one dimensional array frequency coefficients for said sixteenth four by four block.

79. The method of claim 78, wherein:
said two dimensional array frequency coefficients of said first four by four block are scanned first using said step of scanning said two dimensional array frequency coefficients;
said two dimensional array frequency coefficients of said second four by four block are scanned second using said step of scanning said two dimensional array frequency coefficients;
said two dimensional array frequency coefficients of said third four by four block are scanned third using said step of scanning said two dimensional array frequency coefficients;
said two dimensional array frequency coefficients of said fourth four by four block are scanned fourth using said step of scanning said two dimensional array frequency coefficients;
said two dimensional array frequency coefficients of said fifth four by four block are scanned fifth using said step of scanning said two dimensional array frequency coefficients;
said two dimensional array frequency coefficients of said sixth four by four block are scanned sixth using said step of scanning said two dimensional array frequency coefficients;
said two dimensional array frequency coefficients of said seventh four by four block are scanned seventh using said step of scanning said two dimensional array frequency coefficients;
said two dimensional array frequency coefficients of said eighth four by four block are scanned eighth using said step of scanning said two dimensional array frequency coefficients;
said two dimensional array frequency coefficients of said ninth four by four block are scanned ninth using said step of scanning said two dimensional array frequency coefficients;
said two dimensional array frequency coefficients of said tenth four by four block are scanned tenth using said step of scanning said two dimensional array frequency coefficients;
said two dimensional array frequency coefficients of said eleventh four by four block are scanned eleventh using said step of scanning said two dimensional array frequency coefficients;
said two dimensional array frequency coefficients of said twelfth four by four block are scanned twelfth using said step of scanning said two dimensional array frequency coefficients;
said two dimensional array frequency coefficients of said thirteenth four by four block are scanned thirteenth using said step of scanning said two dimensional array frequency coefficients;
said two dimensional array frequency coefficients of said fourteenth four by four block are scanned fourteenth using said step of scanning said two dimensional array frequency coefficients;
said two dimensional array frequency coefficients of said fifteenth four by four block are scanned fifteenth using said step of scanning said two dimensional array frequency coefficients; and
said two dimensional array frequency coefficients of said sixteenth four by four block are scanned sixteenth using said step of scanning said two dimensional array frequency coefficients.

80. The method of claim 46, wherein if said one dimensional array of said one dimensional array frequency coefficients comprises 256 one dimensional array frequency coefficients at positions 0 through 255 in said one dimensional array, said two dimensional array of said two dimensional array frequency coefficients comprises sixteen columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array;
an eighth group comprising one dimensional array frequency coefficients at positions 112 through 127 in said one dimensional array;
a ninth group comprising one dimensional array frequency coefficients at positions 128 through 143 in said one dimensional array;
a tenth group comprising one dimensional array frequency coefficients at positions 144 through 159 in said one dimensional array;
an eleventh group comprising one dimensional array frequency coefficients at positions 160 through 175 in said one dimensional array;
a twelfth group comprising one dimensional array frequency coefficients at positions 176 through 191 in said one dimensional array;
a thirteenth group comprising one dimensional array frequency coefficients at positions 192 through 207 in said one dimensional array;
a fourteenth group comprising one dimensional array frequency coefficients at positions 208 through 223 in said one dimensional array;
a fifteenth group comprising one dimensional array frequency coefficients at positions 224 through 239 in said one dimensional array; and
a sixteenth group comprising one dimensional array frequency coefficients at positions 240 through 255 in said one dimensional array.

81. The method of claim 80, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the fourth through seventh rows four rows and in the first four columns of said two dimensional array;
said fourth group's said corresponding four by four block of said two dimensional array frequency coefficients is a fourth four by four block comprising said two dimensional array frequency coefficients in both the fourth through seventh rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the fourth through seventh rows and in the eighth through eleventh columns of said two dimensional array;
said eighth group's said corresponding four by four block of said two dimensional array frequency coefficients is an eighth four by four block comprising said two dimensional array frequency coefficients in both the fourth through seventh rows and in the right-most four columns of said two dimensional array;
said ninth group's said corresponding four by four block of said two dimensional array frequency coefficients is a ninth four by four block comprising said two dimensional array frequency coefficients in the eighth through eleventh rows and in the left-most four columns of said two dimensional array;
said tenth group's said corresponding four by four block of said two dimensional array frequency coefficients is a tenth four by four block comprising said two dimensional array frequency coefficients in both the eighth through eleventh rows and in the fourth through seventh columns of said two dimensional array;
said eleventh group's said corresponding four by four block of said two dimensional array frequency coefficients is an eleventh four by four block comprising said two dimensional array frequency coefficients in the bottom four rows and in the first four columns of said two dimensional array;
said twelfth group's said corresponding four by four block of said two dimensional array frequency coefficients is a twelfth fourth four by four block comprising said two dimensional array frequency coefficients in both the bottom four rows and in the fourth through seventh columns of said two dimensional array;
said thirteenth group's said corresponding four by four block of said two dimensional array frequency coefficients is a thirteenth four by four block comprising said two dimensional array frequency coefficients in both the eighth through eleventh rows and in the eighth through eleventh columns of said two dimensional array;
said fourteenth group's said corresponding four by four block of said two dimensional array frequency coefficients is a fourteenth four by four block comprising said two dimensional array frequency coefficients in both the eighth through eleventh rows and in the right-most four columns of said two dimensional array;
said fifteenth group's said corresponding four by four block of said two dimensional array frequency coefficients is a fifteenth four by four block comprising said two dimensional array frequency coefficients in both the bottom four rows and in the eighth through eleventh columns of said two dimensional array;
said sixteenth group's said corresponding four by four block of said two dimensional array frequency coefficients is a sixteenth four by four block comprising said two dimensional array frequency coefficients in both the bottom four rows and in the right-most four columns of said two dimensional array.

82. The method of claim 2, wherein if said original two dimensional array of said frequency coefficients comprises eight columns of frequency coefficients and eight rows of said two dimensional array frequency coefficients, said method further comprises:
scanning first a top-left four by four block of frequency coefficients with said scanning order, said top-left four by four block comprising frequency coefficients located in an area covered by four top-most rows and four left-most columns in said original two dimensional array;
scanning second a top-right four by four block of frequency coefficients with said scanning order, said top-right four by four block comprising frequency coefficients located in an area covered both by four top-most rows and four right-most columns in said original two dimensional array;
scanning third a bottom-left four by four block of frequency coefficients with said scanning order, said bottom-left four by four block comprising frequency coefficients located in an area covered both by four bottom-most rows and four left-most columns in said original two dimensional array; and
scanning fourth a bottom-right four by four block of frequency coefficients with said scanning order, said bottom-right four by four block comprising frequency coefficients located in an area covered both by four bottom-most rows and four right-most columns in said original two dimensional array.

83. The method of claim 1, wherein said pixels are encoded using context-based adaptive variable length coding (CAVLC), context-based adaptive binary arithmetic coding (CABAC), or universal variable length codeword (UVLC).

84. A device comprising an encoder for transform-based encoding of digital video content, said digital video content comprising a stream of pictures, slices, or macroblocks in the form of blocks of pixels, each of said blocks of pixels having a corresponding two dimensional array of two dimensional array frequency coefficients, wherein, for each of said blocks, said encoder:
divides said two dimensional array of said two dimensional array frequency coefficients into a number of four by four blocks of two dimensional array frequency coefficients, said number of four by four blocks each comprising 4 columns and 4 rows of said two dimensional array frequency coefficients;
scans said two dimensional array frequency coefficients in each of said number of four by four blocks with a pre-determined scanning order, said scanning order sequentially starting at 0 and ending at 15; and
produces a one dimensional array of one dimensional array frequency coefficients.

85. The device of claim 84, wherein said encoder:
represents said columns of said number of four by four blocks with a variable n=0, 1, 2, or 3, wherein n=0 is at least one of a first or leftmost column, n=1 is a second column, n=2 is a third column, and n=3 is at least one of a fourth or rightmost column; and
represents said rows of said number of four by four blocks with a variable m=0, 1, 2, or 3, wherein m=0 is at least one of a first or top row, m=1 is a second row, m=2 is a third row, and m=3 is at least one of a fourth or bottom row.

86. The device of claim 85, wherein said one dimensional array comprises a number of groups of sixteen one dimensional array frequency coefficients, said number of groups corresponding to said number of said four by four blocks of said two dimensional array frequency coefficients, wherein said sixteen one dimensional array frequency coefficients in each of said groups are represented with a variable p=0, 1, 2, 3, 4, 5, 6, 7, 8, 9, 10, 11, 12, 13, 14, 15, in a numerical sequential order, wherein a first one dimensional array frequency coefficient in said group is represented by p=0 and a sixteenth one dimensional array frequency coefficient in said group is represented by p=15.

87. The device of claim 86, wherein, in scanning said two dimensional array frequency coefficients in each of said number of four by four blocks, if said block of pixels is to be encoded in frame mode, said encoder:
assigns a scanning order=0 to a two dimensional array frequency coefficient located at n=0 and m=0;
assigns a scanning order=1 to a two dimensional array frequency coefficient located at n=1 and m=0;
assigns a scanning order=2 to a two dimensional array frequency coefficient located at n=0 and m=1;
assigns a scanning order=3 to a two dimensional array frequency coefficient located at n=0 and m=2;
assigns a scanning order=4 to a two dimensional array frequency coefficient located at n=1 and m=1;
assigns a scanning order=5 to a two dimensional array frequency coefficient located at n=2 and m=0;
assigns a scanning order=6 to a two dimensional array frequency coefficient located at n=3 and m=0;
assigns a scanning order=7 to a two dimensional array frequency coefficient located at n=2 and m=1;
assigns a scanning order=8 to a two dimensional array frequency coefficient located at n=1 and m=2;
assigns a scanning order=9 to a two dimensional array frequency coefficient located at n=0 and m=3;
assigns a scanning order=10 to a two dimensional array frequency coefficient located at n=1 and m=3;
assigns a scanning order=11 to a two dimensional array frequency coefficient located at n=2 and m=2;
assigns a scanning order=12 to a two dimensional array frequency coefficient located at n=3 and m=1;
assigns a scanning order=13 to a two dimensional array frequency coefficient located at n=3 and m=2;
assigns a scanning order=14 to a two dimensional array frequency coefficient located at n=2 and m=3; and
assigns a scanning order=15 to a two dimensional array frequency coefficient located at n=3 and m=3.

88. The device of claim 87, wherein in scanning said two dimensional array frequency coefficients in each of said number of four by four blocks, said encoder further:
assigns a one dimensional array frequency coefficient located at p=0 in a corresponding group of sixteen one dimensional array frequency coefficients a value of said two dimensional array frequency coefficient located at n=0 and m=0.
assigns a one dimensional array frequency coefficient located at p=1 in said corresponding group of sixteen one dimensional array frequency coefficients a value of said two dimensional array frequency coefficient located at n=1 and m=0;
assigns a one dimensional array frequency coefficient located at p=2 in said corresponding group of sixteen one dimensional array frequency coefficients a value of said two dimensional array frequency coefficient located at n=0 and m=1;
assigns a one dimensional array frequency coefficient located at p=3 in said corresponding group of sixteen one dimensional array frequency coefficients a value of said two dimensional array frequency coefficient located at n=0 and m=2;
assigns a one dimensional array frequency coefficient located at p=4 in said corresponding group of sixteen one dimensional array frequency coefficients a value of said two dimensional array frequency coefficient located at n=1 and m=1;
assigns a one dimensional array frequency coefficient located at p=5 in said corresponding group of sixteen one dimensional array frequency coefficients a value of said two dimensional array frequency coefficient located at n=2 and m=0;
assigns a one dimensional array frequency coefficient located at p=6 in said corresponding group of sixteen one dimensional array frequency coefficients a value of said two dimensional array frequency coefficient located at n=3 and m=0;
assigns a one dimensional array frequency coefficient located at p=7 in said corresponding group of sixteen one dimensional array frequency coefficients a value of said two dimensional array frequency coefficient located at n=2 and m=1;
assigns a one dimensional array frequency coefficient located at p=8 in said corresponding group of sixteen one dimensional array frequency coefficients a value of said two dimensional array frequency coefficient located at n=1 and m=2;
assigns a one dimensional array frequency coefficient located at p=9 in said corresponding group of sixteen one dimensional array frequency coefficients a value of said two dimensional array frequency coefficient located at n=0 and m=3;
assigns a one dimensional array frequency coefficient located at p=10 in said corresponding group of sixteen one dimensional array frequency coefficients a value of said two dimensional array frequency coefficient located at n=1 and m=3;
assigns a one dimensional array frequency coefficient located at p=11 in said corresponding group of sixteen one dimensional array frequency coefficients a value of said two dimensional array frequency coefficient located at n=2 and m=2;
assigns a one dimensional array frequency coefficient located at p=12 in said corresponding group of sixteen one dimensional array frequency coefficients a value of said two dimensional array frequency coefficient located at n=3 and m=1;
assigns a one dimensional array frequency coefficient located at p=13 in said corresponding group of sixteen one dimensional array frequency coefficients a value of said two dimensional array frequency coefficient located at n=3 and m=2;
assigns a one dimensional array frequency coefficient located at p=14 in said corresponding group of sixteen one dimensional array frequency coefficients a value of said two dimensional array frequency coefficient located at n=2 and m=3; and
assigns a one dimensional array frequency coefficient located at p=15 in said corresponding group of sixteen one dimensional array frequency coefficients a value of said two dimensional array frequency coefficient located at n=3 and m=3.

89. The device of claim 88, wherein, in dividing said two dimensional array of said two dimensional array frequency coefficients into a number of four by four blocks, if said two dimensional array of said two dimensional array frequency coefficients comprises four columns and four rows of said two dimensional array frequency coefficients, said encoder:
divides said two dimensional array into a single four by four block comprising all of said two dimensional array frequency coefficients in said two dimensional array.

90. The device of claim 89, wherein:
said one dimensional array of said one dimensional array frequency coefficients comprises 16 one dimensional array frequency coefficients at positions 0 through 15 in said one dimensional array, wherein a first one dimensional array frequency coefficient of said one dimensional array is at position 0 and a sixteenth one dimensional array frequency coefficient of said one dimensional array is at position 15; and
said number of groups of sixteen one dimensional array frequency coefficients comprises a first, group comprising one dimensional array frequency coefficients at positions 0 through 15 in said one dimensional array, said first group being said corresponding group of sixteen one dimensional array frequency coefficients for said single four by four block.

91. The device of claim 90, wherein said encoder:
scans said two dimensional array frequency coefficients of said single four by four block.

92. The device of claim 88, wherein, in dividing said two dimensional array of said two dimensional array frequency coefficients into a number of four by four blocks, if said two dimensional array of said two dimensional array frequency coefficients comprises four columns and eight rows of said two dimensional array frequency coefficients, said encoder:
divides said two dimensional array into a top four by four block comprising the top four rows of said two dimensional array frequency coefficients in said two dimensional array and a bottom four by four block comprising the bottom four rows of said two dimensional array frequency coefficients in said two dimensional array.

93. The device of claim 92, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said top four by four block and said second group being said corresponding group of sixteen one dimensional array frequency coefficients for said bottom four by four block.

94. The device of claim 93, wherein said encoder:
scans said two dimensional array frequency coefficients of said top four by four block first; and
scans said two dimensional array frequency coefficients of said bottom four by four block second.

95. The device of claim 88, wherein, in dividing said two dimensional array of said two dimensional array frequency coefficients into a number of four by four blocks, if said two dimensional array of said two dimensional array frequency coefficients comprises eight columns and four rows of said two dimensional array frequency coefficients, said encoder:
divides said two dimensional array into a left four by four block comprising the left-most four columns of said two dimensional array frequency coefficients in said two dimensional array and a right four by four block comprising the right-most four columns of said two dimensional array frequency coefficients in said two dimensional array.

96. The device of claim 95, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said left four by four block and said second group being said corresponding group of sixteen-one dimensional array frequency coefficients for said right four by four block.

97. The device of claim 96, wherein said encoder:
scans said two dimensional array frequency coefficients of said left four by four block first; and
scans said two dimensional array frequency coefficients of said right four by four block second.

98. The device of claim 88, wherein, in dividing said two dimensional array of said two dimensional array frequency coefficients into a number of four by four blocks, if said two dimensional array of said two dimensional array frequency coefficients comprises eight columns and eight rows of said two dimensional array frequency coefficients, said encoder divides:
said two dimensional array into a top-left four by four block comprising said two dimensional array frequency coefficients in both the top four rows and in the left-most four columns of said two dimensional array;
said two dimensional array into a top-right four by four block comprising said two dimensional array frequency coefficients in both the top four rows and in the right-most four columns of said two dimensional array;
said two dimensional array into a bottom-left four by four block comprising said two dimensional array frequency coefficients in both the bottom four rows and in the left-most four columns of said two dimensional array; and
said two dimensional array into a bottom-right four by four block comprising said two dimensional array frequency coefficients in both the bottom four rows and in the right-most four columns of said two dimensional array.

99. The device of claim 98, wherein:
said one dimensional array of said one dimensional array frequency coefficients comprises 64 frequency coefficients at positions 0 through 63 in said one dimensional array, wherein a first one dimensional array frequency coefficient of said one dimensional array is at position 0 and a sixty-fourth one dimensional array frequency coefficient of said one dimensional array is at position 63; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, and a fourth group comprising one dimensional array frequency coefficients at positions 48 through 63 in said one dimensional array, said first group being said corresponding group of sixteen one dimensional array frequency coefficients for said top-left four by four block, said second group being said corresponding group of sixteen one dimensional array frequency coefficients for said top-right four by four block, said third group being said corresponding group of sixteen one dimensional array frequency coefficients for said bottom-left four by four block, said fourth group being said corresponding group of sixteen one dimensional array frequency coefficients for said bottom-right four by four block.

100. The device of claim 99, wherein said encoder:
scans said two dimensional array frequency coefficients of said top-left four by four block first;
scans said two dimensional array frequency coefficients of said top-right four by four block second;
scans said two dimensional array frequency coefficients of aid bottom-left four by four block third; and
scans said two dimensional array frequency coefficients of said bottom-right four by four block fourth.

101. The device of claim 88, wherein, in dividing said two dimensional array of said two dimensional array frequency coefficients into a number of four by four blocks, if said two dimensional array of said two dimensional array frequency coefficients comprises eight columns and sixteen rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the right-most four columns of said two dimensional array;
said two dimensional array into a third four by four block comprising said two dimensional array frequency coefficients in both the fourth through seventh rows from the top of said two dimensional array and in the left-most four columns of said two dimensional array;
said two dimensional array into a fourth four by four block comprising said two dimensional array frequency coefficients in both the fourth through seventh rows from the top of said two dimensional array and in the right-most four columns of said two dimensional array;
said two dimensional array into a fifth four by four block comprising said two dimensional array frequency coefficients in both the eighth through eleventh rows from the top of said two dimensional array and in the left-most four columns of said two dimensional array;
said two dimensional array into a sixth four by four block comprising said two dimensional array frequency coefficients in both the eighth through eleventh rows from the top of said two dimensional array and in the right-most four columns of said two dimensional array;
said two dimensional array into a seventh four by four block comprising said two dimensional array frequency coefficients in both the bottom four rows and in the left-most four columns of said two dimensional array; and
said two dimensional array into an eighth four by four block comprising said two dimensional array frequency coefficients in both the bottom four rows and in the right-most four columns of said two dimensional array.

102. The device of claim 101, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

103. The device of claim 102, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said two dimensional array frequency coefficients of said sixth four by four block sixth;
scans said two dimensional array frequency coefficients of said seventh four by four block seventh; and scans said two dimensional array frequency coefficients of said eighth four by four block eighth.

104. The device of claim 88, wherein, in dividing said two dimensional array of said two dimensional array frequency coefficients into a number of four by four blocks, if said two dimensional array of said two dimensional array frequency coefficients comprises sixteen columns and eight rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the fourth through seventh columns of said two dimensional array;
said two dimensional array into a third four by four block comprising said two dimensional array frequency coefficients in both the bottom four rows and in the first four columns of said two dimensional array;
said two dimensional array into a fourth four by four block comprising said two dimensional array frequency coefficients in both the bottom four rows and in the fourth through seventh columns of said two dimensional array;
said two dimensional array into a fifth four by four block comprising said two dimensional array frequency coefficients in both the top four rows and in the eighth through eleventh columns of said two dimensional array;
said two dimensional array into a sixth four by four block comprising said two dimensional array frequency coefficients in both the top four rows and in the right-most four columns of said two dimensional array;
said two dimensional array into a seventh four by four block comprising said two A dimensional array frequency coefficients in both the bottom four rows and in the eighth through eleventh columns of said two dimensional array; and
said two dimensional array into an eighth four by four block comprising said two dimensional array frequency coefficients in both the bottom four rows and in the right-most four columns of said two dimensional array.

105. The device of claim 104, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

106. The device of claim 105, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said two dimensional array frequency coefficients of said sixth four by four block sixth;
scans said two dimensional array frequency coefficients of said seventh four by four block seventh; and
scans said two dimensional array frequency coefficients of said eighth four by four block eighth.

107. The device of claim 88, wherein, in dividing said two dimensional array of said two dimensional array frequency coefficients into a number of four by four blocks, if said two dimensional array of said two dimensional array frequency coefficients comprises sixteen columns and sixteen rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the fourth through seventh columns of said two dimensional array;
said two dimensional array into a third four by four block comprising said two dimensional array frequency coefficients in both the fourth through seventh rows four rows and in the first four columns of said two dimensional array;
said two dimensional array into a fourth four by four block comprising said two dimensional array frequency coefficients in both the fourth through seventh rows and in the fourth through seventh columns of said two dimensional array;
said two dimensional array into a fifth four by four block comprising said two dimensional array frequency coefficients in both the top four rows and in the eighth through eleventh columns of said two dimensional array;
said two dimensional array into a sixth four by four block comprising said two dimensional array frequency coefficients in both the top four rows and in the right-most four columns of said two dimensional array;
said two dimensional array into a seventh four by four block comprising said two dimensional array frequency coefficients in both the fourth through seventh rows and in the eighth through eleventh columns of said two dimensional array;
said two dimensional array into an eighth four by four block comprising said two dimensional array frequency coefficients in both the fourth through seventh rows and in the right-most four columns of said two dimensional array;
said two dimensional array into a ninth four by four block comprising said two dimensional array frequency coefficients in the eighth through eleventh rows and in the left-most four columns of said two dimensional array;
said two dimensional array into a tenth four by four block comprising said two dimensional array frequency coefficients in both the eighth through eleventh rows and in the fourth through seventh columns of said two dimensional array;
said two dimensional array into an eleventh four by four block comprising said two dimensional array frequency coefficients in the bottom four rows and in the first four columns of said two dimensional array;
said two dimensional array into a twelfth fourth four by four block comprising said two dimensional array frequency coefficients in both the bottom four rows and in the fourth through seventh columns of said two dimensional array;
said two dimensional array into a thirteenth four by four block comprising said two dimensional array frequency coefficients in both the eighth through eleventh rows and in the eighth through eleventh columns of said two dimensional array;
said two dimensional array into a fourteenth four by four block comprising said two dimensional array frequency coefficients in both the eighth through eleventh rows and in the right-most four columns of said two dimensional array;
said two dimensional array into a fifteenth four by four block comprising said two dimensional array frequency coefficients in both the bottom four rows and in the eighth through eleventh columns of said two dimensional array; and
said two dimensional array into a sixteenth four by four block comprising said two dimensional array frequency coefficients in both the bottom four rows and in the right-most four columns of said two dimensional array.

108. The device of claim 107, wherein:
said one dimensional array of said one dimensional array frequency coefficients comprises 256 one dimensional array frequency coefficients at positions 0 through 255 in said one dimensional array, wherein a first one dimensional array frequency coefficient of said one dimensional array is at position 0 and a two hundred and fifth-sixth one dimensional array frequency coefficient of said one dimensional array is at position 255; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, a ninth group comprising one dimensional array frequency coefficients at positions 128 through 143 in said one dimensional array, a tenth group comprising one dimensional array frequency coefficients at positions 144 through 159 in said one dimensional array, an eleventh group comprising one dimensional array frequency coefficients at positions 160 through 175 in said one dimensional array, a twelfth group comprising one dimensional array frequency coefficients at positions 176 through 191 in said one dimensional array, a thirteenth group comprising one dimensional array frequency coefficients at positions 192 through 207 in said one dimensional array, a fourteenth group comprising one dimensional array frequency coefficients at positions 208 through 223 in said one dimensional array, a fifteenth group comprising one dimensional array frequency coefficients at positions 224 through 239 in said one dimensional array, and a sixteenth group comprising one dimensional array frequency coefficients at positions 240 through 255 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block, said ninth group being said corresponding group of sixteen one dimensional array frequency coefficients for said ninth four by four block, said tenth group being said corresponding group of sixteen one dimensional array frequency coefficients for said tenth four by four block, said eleventh group being said corresponding group of sixteen one dimensional array frequency coefficients for said eleventh four by four block, said twelfth group being said corresponding group of sixteen one dimensional array frequency coefficients for said twelfth four by four block, said thirteenth group being said corresponding group of sixteen one dimensional array frequency coefficients for said thirteenth four by four block, said fourteenth group being said corresponding group of sixteen one dimensional array frequency coefficients for said fourteenth four by four block, said fifteenth group being said corresponding group of sixteen one dimensional array frequency coefficients for said fifteenth four by four block, said sixteenth group being said corresponding group of sixteen one dimensional array frequency coefficients for said sixteenth four by four block.

109. The device of claim 108, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said two dimensional array frequency coefficients of said sixth four by four block sixth;
scans said two dimensional array frequency coefficients of said seventh four by four block seventh;
scans said two dimensional array frequency coefficients of said eighth four by four block eighth;
scans said two dimensional array frequency coefficients of said ninth four by four block ninth;
scans said two dimensional array frequency coefficients of said tenth four by four block tenth;
scans said two dimensional array frequency coefficients of said eleventh four by four block eleventh;
scans said two dimensional array frequency coefficients of said twelfth four by four block twelfth;
scans said two dimensional array frequency coefficients of said thirteenth four by four block thirteenth;
scans said two dimensional array frequency coefficients of said fourteenth four by four block fourteenth;
scans said two dimensional array frequency coefficients of said fifteenth four by four block fifteenth; and
scans said two dimensional array frequency coefficients of said sixteenth four by four block sixteenth.

110. The device of claim 86, wherein, in scanning said two dimensional array frequency coefficients in each of said number of four by four blocks, if said block of pixels is to be encoded in field mode, said encoder:
assigns a scanning order=0 to a two dimensional array frequency coefficient located at n=0 and m=0;
assigns a scanning order=1 to a two dimensional array frequency coefficient located at n=0 and m=1;
assigns a scanning order=2 to a two dimensional array frequency coefficient located at n=1 and m=0;
assigns a scanning order=3 to a two dimensional array frequency coefficient located at n=0 and m=2;
assigns a scanning order=4 to a two dimensional array frequency coefficient located at n=0 and m=3;
assigns a scanning order=5 to a two dimensional array frequency coefficient located at n=1 and m=1;
assigns a scanning order=6 to a two dimensional array frequency coefficient located at n=1 and m=2;
assigns a scanning order=7 to a two dimensional array frequency coefficient located at n=1 and m=3;
assigns a scanning order=8 to a two dimensional array frequency coefficient located at n=2 and m=0;
assigns a scanning order=9 to a two dimensional array frequency coefficient located at n=2 and m=1;
assigns a scanning order=10 to a two dimensional array frequency coefficient located at n=2 and m=2;
assigns a scanning order=11 to a two dimensional array frequency coefficient located at n=2 and m=3;
assigns a scanning order=12 to a two dimensional array frequency coefficient located at n=3 and m=0;
assigns a scanning order=13 to a two dimensional array frequency coefficient located at n=3 and m=1;
assigns a scanning order=14 to a two dimensional array frequency coefficient located at n=3 and m=2; and
assigns a scanning order=15 to a two dimensional array frequency coefficient located at n=3 and m=3.

111. The device of claim 110, wherein in scanning said two dimensional array frequency coefficients in each of said number of four by four blocks, said encoder further:
assigns a one dimensional array frequency coefficient located at p=0 in a corresponding group of sixteen one dimensional array frequency coefficients a value of said two dimensional array frequency coefficient located at n=0 and m=0.
assigns a one dimensional array frequency coefficient located at p=1 in said corresponding group of sixteen one dimensional array frequency coefficients a value of said two dimensional array frequency coefficient located at n=0 and m=1;
assigns a one dimensional array frequency coefficient located at p=2 in said corresponding group of sixteen one dimensional array frequency coefficients a value of said two dimensional array frequency coefficient located at n=1 and m=0;
assigns a one dimensional array frequency coefficient located at p=3 in said corresponding group of sixteen one dimensional array frequency coefficients a value of said two dimensional array frequency coefficient located at n=0 and m=2;
assigns a one dimensional array frequency coefficient located at p=4 in said corresponding group of sixteen one dimensional array frequency coefficients a value of said two dimensional array frequency coefficient located at n=0 and m=3;
assigns a one dimensional array frequency coefficient located at p=5 in said corresponding group of sixteen one dimensional array frequency coefficients a value of said two dimensional array frequency coefficient located at n=1 and m=1;
assigns a one dimensional array frequency coefficient located at p=6 in said corresponding group of sixteen one dimensional array frequency coefficients a value of said two dimensional array frequency coefficient located at n=1 and m=2;
assigns a one dimensional array frequency coefficient located at p=7 in said corresponding group of sixteen one dimensional array frequency coefficients a value of said two dimensional array frequency coefficient located at n=1 and m=3;
assigns a one dimensional array frequency coefficient located at p=8 in said corresponding group of sixteen one dimensional array frequency coefficients a value of said two dimensional array frequency coefficient located at n=2 and m=0;
assigns a one dimensional array frequency coefficient located at p=9 in said corresponding group of sixteen one dimensional array frequency coefficients a value of said two dimensional array frequency coefficient located at n=2 and m=1;
assigns a one dimensional array frequency coefficient located at p=10 in said corresponding group of sixteen one dimensional array frequency coefficients a value of said two dimensional array frequency coefficient located at n=2 and m=2;
assigns a one dimensional array frequency coefficient located at p=11 in said corresponding group of sixteen one dimensional array frequency coefficients a value of said two dimensional array frequency coefficient located at n=2 and m=3;
assigns a one dimensional array frequency coefficient located at p=12 in said corresponding group of sixteen one dimensional array frequency coefficients a value of said two dimensional array frequency coefficient located at n=3 and m=0;
assigns a one dimensional array frequency coefficient located at p=13 in said corresponding group of sixteen one dimensional array frequency coefficients a value of said two dimensional array frequency coefficient located at n=3 and m=1;
assigns a one dimensional array frequency coefficient located at p=14 in said corresponding group of sixteen one dimensional array frequency coefficients a value of said two dimensional array frequency coefficient located at n=3 and m=2; and
assigns a one dimensional array frequency coefficient located at p=15 in said corresponding group of sixteen one dimensional array frequency coefficients a value of said two dimensional array frequency coefficient located at n=3 and m=3.

112. The device of claim 111, wherein, in dividing said two dimensional array of said two dimensional array frequency coefficients into a number of four by four blocks, if said two dimensional array of said two dimensional array frequency coefficients comprises four columns and four rows of said two dimensional array frequency coefficients, said encoder:
divides said two dimensional array into a single four by four block comprising all of said two dimensional array frequency coefficients in said two dimensional array.

113. The device of claim 112, wherein:
said one dimensional array of said one dimensional array frequency coefficients comprises 16 one dimensional array frequency coefficients at positions 0 through 15 in said one dimensional array, wherein a first one dimensional array frequency coefficient of said one dimensional array is at position 0 and a sixteenth one dimensional array frequency coefficient of said one dimensional array is at position 15; and
said number of groups of sixteen one dimensional array frequency coefficients comprises a first group comprising one dimensional array frequency coefficients at positions 0 through 15 in said one dimensional array, said first group being said corresponding group of sixteen one dimensional array frequency coefficients for said single four by four block.

114. The device of claim 113, wherein said encoder:
scans said two dimensional array frequency coefficients of said single four by four block.

115. The device of claim 111, wherein, in dividing said two dimensional array of said two dimensional array frequency coefficients into a number of four by four blocks, if said two dimensional array of said two dimensional array frequency coefficients comprises four columns and eight rows of said two dimensional array frequency coefficients, said encoder:
divides said two dimensional array into a top four by four block comprising the top four rows of said two dimensional array frequency coefficients in said two dimensional array and a bottom four by four block comprising the bottom four rows of said two dimensional array frequency coefficients in said two dimensional array.

116. The device of claim 115, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions o through 15 in said one dimensional array and a second group comprising one dimensional array frequency coefficients at positions 16 through 31 in said one dimensional array, said first group being said corresponding group of-sixteen one dimensional array frequency coefficients for said top four by four block and said second group being said corresponding group of sixteen one dimensional array frequency coefficients for said bottom four by four block.

117. The device of claim 116, wherein said encoder:
scans said two dimensional array frequency coefficients of said top four by four block first; and
scans said two dimensional array frequency coefficients of said bottom four by four block second.

118. The device of claim 111, wherein, in dividing said two dimensional array of said two dimensional array frequency coefficients into a number of four by four blocks, if said two dimensional array of said two dimensional array frequency coefficients comprises eight columns and four rows of said two dimensional array frequency coefficients, said encoder:
divides said two dimensional array into a left four by four block comprising the left-most four columns of said two dimensional array frequency coefficients in said two dimensional array and a right four by four block comprising the right-most four columns of said two dimensional array frequency coefficients in said two dimensional array.

119. The device of claim 118, wherein:
said one dimensional array of said one dimensional array frequency coefficients comprises 32 one dimensional array frequency coefficients at positions 0 through 31 in said one dimensional array, wherein a first one dimensional array frequency coefficient of said one dimensional array is at position 0 and a thirty-second one dimensional array frequency coefficient of said one dimensional array is at position 31; and
said number of groups of sixteen one dimensional array frequency coefficients comprises a first group comprising one dimensional array frequency coefficients at positions 0 through 15 in said one dimensional array and a second group comprising one dimensional array frequency coefficients at positions 16 through 31 in said one dimensional array, said first group being said corresponding group of sixteen one dimensional array frequency coefficients for said left four by four block and said second group being said corresponding group of sixteen one dimensional array frequency coefficients for said right four by four block.

120. The device of claim 119, wherein said encoder:
scans said two dimensional array frequency coefficients of said left four by four block first; and
scans said two dimensional array frequency coefficients of said right four by four block second.

121. The device of claim 111, wherein, in dividing said two dimensional array of said two dimensional array frequency coefficients into a number of four by four blocks, if said two dimensional array of said two dimensional array frequency coefficients comprises eight columns and eight rows of said two dimensional array frequency coefficients, said encoder divides:
said two dimensional array into a top-left four by four block comprising said two dimensional array frequency coefficients in both the top four rows and in the left-most four columns of said two dimensional array;
said two dimensional array into a top-right four by four block comprising said two dimensional array frequency coefficients in both the top four rows and in the right-most four columns of said two dimensional array;
said two dimensional array into a bottom-left four by four block comprising said two dimensional array frequency coefficients in both the bottom four rows and in the left-most four columns of said two dimensional array; and
said two dimensional array into a bottom-right four by four block comprising said two dimensional array frequency coefficients in both the bottom four rows and in the right-most four columns of said two dimensional array.

122. The device of claim 121, wherein:
said one dimensional array of said one dimensional array frequency coefficients comprises 64 frequency coefficients at positions 0 through 63 in said one dimensional array, wherein a first one dimensional array frequency coefficient of said one dimensional array is at position 0 and a sixty-fourth one dimensional array frequency coefficient of said one dimensional array is at position 63; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, and a fourth group comprising one dimensional array frequency coefficients at positions 48 through 63 in said one dimensional array, said first group being said corresponding group of sixteen one dimensional array frequency coefficients for said top-left four by four block, said second group being said corresponding group of sixteen one dimensional array frequency coefficients for said top-right four by four block, said third group being said corresponding group of sixteen one dimensional array frequency coefficients for said bottom-left four by four block, said fourth group being said corresponding group of sixteen one dimensional array frequency coefficients for said bottom-right four by four block.

123. The device of claim 122, wherein said encoder:
scans said two dimensional array frequency coefficients of said top-left four by four block first;
scans said two dimensional array frequency coefficients of said top-right four by four block second;
scans said two dimensional array frequency coefficients of aid bottom-left four by four block third; and
scans said two dimensional array frequency coefficients of said bottom-right four by four block fourth.

124. The device of claim 111, wherein, in dividing said two dimensional array of said two dimensional array frequency coefficients into a number of four by four blocks, if said two dimensional array of said two dimensional array frequency coefficients comprises eight columns and sixteen rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the right-most four columns of said two dimensional array;
said two dimensional array into a third four by four block comprising said two dimensional array frequency coefficients in both the fourth through seventh rows from the top of said two dimensional array and in the left-most four columns of said two dimensional array;
said two dimensional array into a fourth four by four block comprising said two dimensional array frequency coefficients in both the fourth through seventh rows from the top of said two dimensional array and in the right-most four columns of said two dimensional array;
said two dimensional array into a fifth four by four block comprising said two dimensional array frequency coefficients in both the eighth through eleventh rows from the top of said two dimensional array and in the left-most four columns of said two dimensional array;
said two dimensional array into a sixth four by four block comprising said two dimensional array frequency coefficients in both the eighth through eleventh rows from the top of said two dimensional array and in the right-most four columns of said two dimensional array;
said two dimensional array into a seventh four by four block comprising said two dimensional array frequency coefficients in both the bottom four rows and in the left-most four columns of said two dimensional array; and
said two dimensional array into an eighth four by four block comprising said two dimensional array frequency coefficients in both the bottom four rows and in the right-most four columns of said two dimensional array.

125. The device of claim 124, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

126. The device of claim 125, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said two dimensional array frequency coefficients of said sixth four by four block sixth;
scans said two dimensional array frequency coefficients of said seventh four by four block seventh; and
scans said two dimensional array frequency coefficients of said eighth four by four block eighth.

127. The device of claim 111, wherein, in dividing said two dimensional array of said two dimensional array frequency coefficients into a number of four by four blocks, if said two dimensional array of said two dimensional array frequency coefficients comprises sixteen columns and eight rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the fourth through seventh columns of said two dimensional array;
said two dimensional array into a third four by four block comprising said two dimensional array frequency coefficients in both the bottom four rows and in the first four columns of said two dimensional array;
said two dimensional array into a fourth four by four block comprising said two dimensional array frequency coefficients in both the bottom four rows and in the fourth through seventh columns of said two dimensional array;
said two dimensional array into a fifth four by four block comprising said two dimensional array frequency coefficients in both the top four rows and in the eighth through eleventh columns of said two dimensional array;
said two dimensional array into a sixth four by four block comprising said two dimensional array frequency coefficients in both the top four rows and in the right-most four columns of said two dimensional array;
said two dimensional array into a seventh four by four block comprising said two dimensional array frequency coefficients in both the bottom four rows and in the eighth through eleventh columns of said two dimensional array; and
said two dimensional array into an eighth four by four block comprising said two dimensional array frequency coefficients in both the bottom four rows and in the right-most four columns of said two dimensional array.

128. The device of claim 127, wherein:
said one dimensional array of said one dimensional array frequency coefficients comprises 128 one dimensional array frequency coefficients at positions 0 through 127 in said one dimensional array, wherein a first one dimensional array frequency coefficient of said one dimensional array is at position 0 and a one hundred and twenty-eighth one dimensional array frequency coefficient of said one dimensional array is at position 127; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block.

129. The device of claim 128, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said&two dimensional array frequency coefficients of said sixth four by four block sixth;
scans said two dimensional array frequency coefficients of said seventh four by four block seventh; and
scans said two dimensional array frequency coefficients of said eighth four by four block eighth.

130. The device of claim 111, wherein, in dividing said two dimensional array of said two dimensional array frequency coefficients into a number of four by four blocks, if said two dimensional array of said two dimensional array frequency coefficients comprises sixteen columns and sixteen rows of said two dimensional array frequency coefficients, said encoder divides:
said two dimensional array into a first four by four block comprising said two dimensional array frequency coefficients in both the top four rows and in the left-most four columns of said two dimensional array;
said two dimensional array into a second four by four block comprising said two dimensional array frequency coefficients in both the top four rows and in the fourth through seventh columns of said two dimensional array;
said two dimensional array into a third four by four block comprising said two dimensional array frequency coefficients in both the fourth through seventh rows four rows and in the first four columns of said two dimensional array;
said two dimensional array into a fourth four by four block comprising said two dimensional array frequency coefficients in both the fourth through seventh rows and in the fourth through seventh columns of said two dimensional array;
said two dimensional array into a fifth four by four block comprising said two dimensional array frequency coefficients in both the top four rows and in the eighth through eleventh columns of said two dimensional array;
said two dimensional array into a sixth four by four block comprising said two dimensional array frequency coefficients in both the top four rows and in the right-most four columns of said two dimensional array;
said two dimensional array into a seventh four by four block comprising said two dimensional array frequency coefficients in both the fourth through seventh rows and in the eighth through eleventh columns of said two dimensional array;
said two dimensional array into an eighth four by four block comprising said two dimensional array frequency coefficients in both the fourth through seventh rows and in the right-most four columns of said two dimensional array;
said two dimensional array into a ninth four by four block comprising said two dimensional array frequency coefficients in the eighth through eleventh rows and in the left-most four columns of said two dimensional array;
said two dimensional array into a tenth four by four block comprising said two dimensional array frequency coefficients in both the eighth through eleventh rows and in the fourth through seventh columns of said two dimensional array;
said two dimensional array into an eleventh four by four block comprising said two dimensional array frequency coefficients in the bottom four rows and in the first four columns of said two dimensional array;
said two dimensional array into a twelfth fourth four by four block comprising said two dimensional array frequency coefficients in both the bottom four rows and in the fourth through seventh columns of said two dimensional array;
said two dimensional array into a thirteenth four by four block comprising said two dimensional array frequency coefficients in both the eighth through eleventh rows and in the eighth through eleventh columns of said two dimensional array;
said two dimensional array into a fourteenth four by four block comprising said two dimensional array frequency coefficients in both the eighth through eleventh rows and in the right-most four columns of said two dimensional array;
said two dimensional array into a fifteenth four by four block comprising said two dimensional array frequency coefficients in both the bottom four rows and in the eighth through eleventh columns of said two dimensional array; and
said two dimensional array into a sixteenth four by four block comprising said two dimensional array frequency coefficients in both the bottom four rows and in the right-most four columns of said two dimensional array.

131. The device of claim 130, wherein:
said one dimensional array of said one dimensional array frequency coefficients comprises 256 one dimensional array frequency coefficients at positions 0 through 255 in said one dimensional array, wherein a first one dimensional array frequency coefficient of said one dimensional array is at position 0 and a two hundred and fifth-sixth one dimensional array frequency coefficient of said one dimensional array is at position 255; and
said number of groups of sixteen one dimensional array frequency coefficients comprises a first group comprising one dimensional array frequency coefficients at positions 0 through 15 in said one dimensional array, a second group comprising one dimensional array frequency coefficients at positions 16 through 31 in said one dimensional array, a third group comprising one dimensional array frequency coefficients at positions 32 through 47 in said one dimensional array, a fourth group comprising one dimensional array frequency coefficients at positions 48 through 63 in said one dimensional array, a fifth group comprising one dimensional array frequency coefficients at positions 64 through 79 in said one dimensional array, a sixth group comprising one dimensional array frequency coefficients at positions 80 through 95 in said one dimensional array, a seventh group comprising one dimensional array frequency coefficients at positions 96 through 111 in said one dimensional array, and an eighth group comprising one dimensional array frequency coefficients at positions 112 through 127 in said one dimensional array, a ninth group comprising one dimensional array frequency coefficients at positions 128 through 143 in said one dimensional array, a tenth group comprising one dimensional array frequency coefficients at positions 144 through 159 in said one dimensional array, an eleventh group comprising one dimensional array frequency coefficients at positions 160 through 175 in said one dimensional array, a twelfth group comprising one dimensional array frequency coefficients at positions 176 through 191 in said one dimensional array, a thirteenth group comprising one dimensional array frequency coefficients at positions 192 through 207 in said one dimensional array, a fourteenth group comprising one dimensional array frequency coefficients at positions 208 through 223 in said one dimensional array, a fifteenth group comprising one dimensional array frequency coefficients at positions 224 through 239 in said one dimensional array, and a sixteenth group comprising one dimensional array frequency coefficients at positions 240 through 255 in said one dimensional array, said first group being said corresponding group of sixteen one dimensional array frequency coefficients for said first four by four block, said second group being said corresponding group of sixteen one dimensional array frequency coefficients for said second four by four block, said third group being said corresponding group of sixteen one dimensional array frequency coefficients for said third four by four block, said fourth group being said corresponding group of sixteen one dimensional array frequency coefficients for said fourth four by four block, said fifth group being said corresponding group of sixteen one dimensional array frequency coefficients for said fifth four by four block, said sixth group being said corresponding group of sixteen one dimensional array frequency coefficients for said sixth four by four block, said seventh group being said corresponding group of sixteen one dimensional array frequency coefficients for said seventh four by four block, said eighth group being said corresponding group of sixteen one dimensional array frequency coefficients for said eighth four by four block, said ninth group being said corresponding group of sixteen one dimensional array frequency coefficients for said ninth four by four block, said tenth group being said corresponding group of sixteen one dimensional array frequency coefficients for said tenth four by four block, said eleventh group being said corresponding group of sixteen one dimensional array frequency coefficients for said eleventh four by four block, said twelfth group being said corresponding group of sixteen one dimensional array frequency coefficients for said twelfth four by four block, said thirteenth group being said corresponding group of sixteen one dimensional array frequency coefficients for said thirteenth four by four block, said fourteenth group being said corresponding group of sixteen one dimensional array frequency coefficients for said fourteenth four by four block, said fifteenth group being said corresponding group of sixteen one dimensional array frequency coefficients for said fifteenth four by four block, said sixteenth group being said corresponding group of sixteen one dimensional array frequency coefficients for said sixteenth four by four block.

132. The device of claim 131, wherein said encoder:
scans said two dimensional array frequency coefficients of said first four by four block first;
scans said two dimensional array frequency coefficients of said second four by four block second;
scans said two dimensional array frequency coefficients of said third four by four block third;
scans said two dimensional array frequency coefficients of said fourth four by four block fourth;
scans said two dimensional array frequency coefficients of said fifth four by four block fifth;
scans said two dimensional array frequency coefficients of said sixth four by four block sixth;
scans said two dimensional array frequency coefficients of said seventh four by four block seventh;
scans said two dimensional array frequency coefficients of said eighth four by four block eighth; scans said two dimensional array frequency coefficients of said ninth four by four block ninth;
scans said two dimensional array frequency coefficients of said tenth four by four block tenth;
scans said two dimensional array frequency coefficients of said eleventh four by four block eleventh;
scans said two dimensional array frequency coefficients of said twelfth four by four block twelfth;
scans said two dimensional array frequency coefficients of said thirteenth four by four block thirteenth;
scans said two dimensional array frequency coefficients of said fourteenth four by four block fourteenth;
scans said two dimensional array frequency coefficients of said fifteenth four by four block fifteenth; and
scans said two dimensional array frequency coefficients of said sixteenth four by four block sixteenth.

133. A device comprising a decoder for transform-based decoding of digital video content, said digital video content comprising a stream of pictures, slices, or macroblocks in the form of blocks of pixels, said blocks of pixels forming a one dimensional array of one dimensional array frequency coefficients, wherein said decoder:
divides said one dimensional array frequency coefficients into a number of groups of sixteen one dimensional array frequency coefficients, wherein said sixteen one dimensional array frequency coefficients in each of said number of groups are represented with a variable p=0, 1, 2, 3, 4, 5, 6, 7, 8, 9, 10, 11, 12, 13, 14, 15, in a numerical sequential order, wherein a first one dimensional array frequency coefficient in said each of said group is represented by p=0 and a sixteenth one dimensional array frequency coefficient in said each of said group is represented by p=15;
scans each of said number of groups of sixteen one dimensional array frequency coefficients in said numerical sequential order, said scanning starting at p=0 and ending at p=15; and
produces a two dimensional array of two dimensional array frequency coefficients.

134. The device of claim 133, wherein said two dimensional array comprises a number of four by four blocks of two dimensional array frequency coefficients, said number of four by four blocks corresponding to said number of said number of groups of one dimensional array frequency coefficients, said number of four by four blocks each comprising 4 columns and 4 rows of said two dimensional array frequency coefficients.

135. The device of claim 134, wherein said decoder:
represents said columns of said number of four by four blocks with a variable n=0, 1, 2, or 3, wherein n=0 is at least one of a first or leftmost column, n=1 is a second column, n=2 is a third column, and n=3 is at least one of a fourth or rightmost column; and
represents said rows of said number of four by four blocks with a variable m=0, 1, 2, or 3, wherein m=0 is at least one of a first or top row, m=1 is a second row, m=2 is a third row, and m=3 is at least one of a fourth or bottom row.

136. The device of claim 135, wherein, in scanning said one dimensional array frequency coefficients in each of said number of groups of sixteen one dimensional array frequency coefficients, if said block of pixels is decoded in frame mode, said decoder:
assigns a two dimensional array frequency coefficient located at n=0 and m=0 in a corresponding four by four block of said two dimensional array frequency coefficients a value of said one dimensional array frequency coefficient located at p=0;
assigns a two dimensional array frequency coefficient located at n=1 and m=0 in said corresponding four by four block of said two dimensional array frequency coefficients a value of said one dimensional array frequency coefficient located at p=1;
assigns a two dimensional array frequency coefficient located at n=0 and m=1 in said corresponding four by four block of said two dimensional array frequency coefficients a value of said one dimensional array frequency coefficient located at p=2;
assigns a two dimensional array frequency coefficient located at n=0 and m=2 in said corresponding four by four block of said two dimensional array frequency coefficients a value of said one dimensional array frequency coefficient located at p=3;
assigns a two dimensional array frequency coefficient located at n=1 and m=1 in said corresponding four by four block of said two dimensional array frequency coefficients a value of said one dimensional array frequency coefficient located at p=4;
assigns a two dimensional array frequency coefficient located at n=2 and m=0 in said corresponding four by four block of said two dimensional array frequency coefficients a value of said one dimensional array frequency coefficient located at p=5;
assigns a two dimensional array frequency coefficient located at n=3 and m=0 in said corresponding four by four block of said two dimensional array frequency coefficients a value of said one dimensional array frequency coefficient located at p=6;
assigns a two dimensional array frequency coefficient located at n=2 and m=1 in said corresponding four by four block of said two dimensional array frequency coefficients a value of said one dimensional array frequency coefficient located at p=7;
assigns a two dimensional array frequency coefficient located at n=1 and m=2 in said corresponding four by four block of said two dimensional array frequency coefficients a value of said one dimensional array frequency coefficient located at p=8;
assigns a two dimensional array frequency coefficient located at n=0 and m=3 in said corresponding four by four block of said two dimensional array frequency coefficients a value of said one dimensional array frequency coefficient located at p=9;
assigns a two dimensional array frequency coefficient located at n=1 and m=3 in said corresponding four by four block of said two dimensional array frequency coefficients a value of said one dimensional array frequency coefficient located at p=10;
assigns a two dimensional array frequency coefficient located at n=2 and m=2 in said corresponding four by four block of said two dimensional array frequency coefficients a value of said one dimensional array frequency coefficient located at p=11;
assigns a two dimensional array frequency coefficient located at n=3 and m=1 in said corresponding four by four block of said two dimensional array frequency coefficients a value of said one dimensional array frequency coefficient located at p=12;
assigns a two dimensional array frequency coefficient located at n=3 and m=2 in said corresponding four by four block of said two dimensional array frequency coefficients a value of said one dimensional array frequency coefficient located at p=13;
assigns a two dimensional array frequency coefficient located at n=2 and m=3 in said corresponding four by four block of said two dimensional array frequency coefficients a value of said one dimensional array frequency coefficient located at p=14; and
assigns a two dimensional array frequency coefficient located at n=3 and m=3 in said corresponding four by four block of said two dimensional array frequency coefficients a value of said one dimensional array frequency coefficient located at p=15.

137. The device of claim 136, wherein if said one dimensional array of one dimensional array frequency coefficients comprises 16 one dimensional array frequency coefficients at positions 0 through 15 in said one dimensional array, said two dimensional array of said two dimensional array frequency coefficients comprises four columns and four rows of said two dimensional array frequency coefficients and said number of groups of sixteen one dimensional array frequency coefficients comprises:
a first group comprising one dimensional array frequency coefficients at positions 0 through 15 in said one dimensional array.

138. The device of claim 137, wherein:
said first group's said corresponding four by four block of said two dimensional array frequency coefficients is a single four by four block comprising said all of said two dimensional array frequency coefficients in said two dimensional array.

139. The device of claim 136, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises four columns and eight rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

140. The device of claim 139, wherein:
said first group's said corresponding four by four block of said two dimensional array frequency coefficients is a top four by four block comprising the top four rows of said two dimensional array frequency coefficients in said two dimensional array; and
said second group's said corresponding four by four block of said two dimensional array frequency coefficients is a bottom four by four block comprising the bottom four rows of said two dimensional array frequency coefficients in said two dimensional array.

141. The device of claim 136, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises eight columns and four rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

142. The device of claim 141, wherein:
said first group's said corresponding four by four block of said two dimensional array frequency coefficients is a left four by four block comprising the left-most four columns of said two dimensional array frequency coefficients in said two dimensional array; and
said second group's said corresponding four by four block of said two dimensional array frequency coefficients is a right four by four block comprising the right-most four columns of said two dimensional array frequency coefficients in said two dimensional array.

143. The device of claim 136, wherein if said one dimensional array of said one dimensional array frequency coefficients comprises 64 one dimensional array frequency coefficients at positions 0 through 63 in said one dimensional array, said two dimensional array of said two dimensional array frequency coefficients comprises eight columns and eight rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array; and
a fourth group comprising one dimensional array frequency coefficients at positions 48 through 63 in said one dimensional array.

144. The device of claim 143, wherein:
said first group's said corresponding four by four block of said two dimensional array frequency coefficients is a top-left four by four block comprising said two dimensional array frequency coefficients in both the top four rows and in the left-most four columns of said two dimensional array;
said second group's said corresponding four by four block of said two dimensional array frequency coefficients is a top-right four by four block comprising said two dimensional array frequency coefficients in both the top four rows and in the right-most four columns of said two dimensional array;
said third group's said corresponding four by four block of said two dimensional array frequency coefficients is a bottom-left four by four block comprising said two dimensional array frequency coefficients in both the bottom four rows and in the left-most four columns of said two dimensional array; and
said fourth group's said corresponding four by four block of said two dimensional array frequency coefficients is said bottom-right four by four block comprising said two dimensional array frequency coefficients in both the bottom four rows and in the right-most four columns of said two dimensional array.

145. The device of claim 136, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

146. The device of claim 145, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the right-most four columns of said two dimensional array;
said third group's said corresponding four by four block of said two dimensional array frequency coefficients is a third four by four block comprising said two dimensional array frequency coefficients in both the fourth through seventh from the top of said two dimensional array and in the left-most four columns of said two dimensional array;
said fourth group's said corresponding four by four block of said two dimensional array frequency coefficients is a fourth four by four block comprising said two dimensional array frequency coefficients in both the fourth through seventh rows from the top of said two dimensional array and in the right-most four columns of said two dimensional array;
said fifth group's said corresponding four by four block of said two dimensional array frequency coefficients is a fifth four by four block comprising said two dimensional array frequency coefficients in both the eighth through eleventh rows from the top of said two dimensional array and in the left-most four columns of said two dimensional array;
said sixth group's said corresponding four by four block of said two dimensional array frequency coefficients is a sixth four by four block comprising said two dimensional array frequency coefficients in both the eighth through eleventh rows from the top of said two dimensional array and in the right-most four columns of said two dimensional array;
said seventh group's said corresponding four by four block of said two dimensional array frequency coefficients is a seventh four by four block comprising said two dimensional array frequency coefficients in both the bottom four rows and in the left-most four columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

147. The device of claim 136, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

148. The device of claim 147, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the bottom four rows and in the first four columns of said two dimensional array;
said fourth group's said corresponding four by four block of said two dimensional array frequency coefficients is a fourth four by four block comprising said two dimensional array frequency coefficients in both the bottom four rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the bottom four rows and in the eighth through eleventh columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

149. The device of claim 136, wherein if said one dimensional array of said one dimensional array frequency coefficients comprises 256 one dimensional array frequency coefficients at positions 0 through 255 in said one dimensional array, said two dimensional array of said two dimensional array frequency coefficients comprises sixteen columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array;
an eighth group comprising one dimensional array frequency coefficients at positions 112 through 127 in said one dimensional array;
a ninth group comprising one dimensional array frequency coefficients at positions 128 through 143 in said one dimensional array;
a tenth group comprising one dimensional array frequency coefficients at positions 144 through 159 in said one dimensional array;
an eleventh group comprising one dimensional array frequency coefficients at positions 160 through 175 in said one dimensional array;
a twelfth group comprising one dimensional array frequency coefficients at positions 176 through 191 in said one dimensional array;
a thirteenth group comprising one dimensional array frequency coefficients at positions 192 through 207 in said one dimensional array;
a fourteenth group comprising one dimensional array frequency coefficients at positions 208 through 223 in said one dimensional array;
a fifteenth group comprising one dimensional array frequency coefficients at positions 224 through 239 in said one dimensional array; and
a sixteenth group comprising one dimensional array frequency coefficients at positions 240 through 255 in said one dimensional array.

150. The device of claim 149, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the fourth through seventh rows four rows and in the first four columns of said two dimensional array;
said fourth group's said corresponding four by four block of said two dimensional array frequency coefficients is a fourth four by four block comprising said two dimensional array frequency coefficients in both the fourth through seventh rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the fourth through seventh rows and in the eighth through eleventh columns of said two dimensional array;
said eighth group's said corresponding four by four block of said two dimensional array frequency coefficients is an eighth four by four block comprising said two dimensional array frequency coefficients in both the fourth through seventh rows and in the right-most four columns of said two dimensional array;
said ninth group's said corresponding four by four block of said two dimensional array frequency coefficients is a ninth four by four block comprising said two dimensional array frequency coefficients in the eighth through eleventh rows and in the left-most four columns of said two dimensional array;
said tenth group's said corresponding four by four block of said two dimensional array frequency coefficients is a tenth four by four block comprising said two dimensional array frequency coefficients in both the eighth through eleventh rows and in the fourth through seventh columns of said two dimensional array;
said eleventh group's said corresponding four by four block of said two dimensional array frequency coefficients is an eleventh four by four block comprising said two dimensional array frequency coefficients in the bottom four rows and in the first four columns of said two dimensional array;
said twelfth group's said corresponding four by four block of said two dimensional array frequency coefficients is a twelfth fourth four by four block comprising said two dimensional array frequency coefficients in both the bottom four rows and in the fourth through seventh columns of said two dimensional array;
said thirteenth group's said corresponding four by four block of said two dimensional array frequency coefficients is a thirteenth four by four block comprising said two dimensional array frequency coefficients in both the eighth through eleventh rows and in the eighth through eleventh columns of said two dimensional array;
said fourteenth group's said corresponding four by four block of said two dimensional array frequency coefficients is a fourteenth four by four block comprising said two dimensional array frequency coefficients in both the eighth through eleventh rows and in the right-most four columns of said two dimensional array;
said fifteenth group's said corresponding four by four block of said two dimensional array frequency coefficients is a fifteenth four by four block comprising said two dimensional array frequency coefficients in both the bottom four rows and in the eighth through eleventh columns of said two dimensional array;
said sixteenth group's said corresponding four by four block of said two dimensional array frequency coefficients is a sixteenth four by four block comprising said two dimensional array frequency coefficients in both the bottom four rows and in the right-most four columns of said two dimensional array.

151. The device of claim 135, wherein, in scanning said one dimensional array frequency coefficients in each of said number of groups of sixteen one dimensional array frequency coefficients, if said block of pixels is decoded in field mode, said decoder:
assigns a two dimensional array frequency coefficient located at n=0 and m=0 in a corresponding four by four block of said two dimensional array frequency coefficients a value of said one dimensional array frequency coefficient located at p=0;
assigns a two dimensional array frequency coefficient located at n=0 and m=1 in said corresponding four by four block of said two dimensional array frequency coefficients a value of said one dimensional array frequency coefficient located at p=1;
assigns a two dimensional array frequency coefficient located at n=1 and m=0 in said corresponding four by four block of said two dimensional array frequency coefficients a value of said one dimensional array frequency coefficient located at p=2;
assigns a two dimensional array frequency coefficient located at n=0 and m=2 in said corresponding four by four block of said two dimensional array frequency coefficients a value of said one dimensional array frequency coefficient located at p=3;
assigns a two dimensional array frequency coefficient located at n=0 and m=3 in said corresponding four by four block of said two dimensional array frequency coefficients a value of said one dimensional array frequency coefficient located at p=4;
assigns a two dimensional array frequency coefficient located at n=1 and m=1 in said corresponding four by four block of said two dimensional array frequency coefficients a value of said one dimensional array frequency coefficient located at p=5;
assigns a two dimensional array frequency coefficient located at n=1 and m=2 in said corresponding four by four block of said two dimensional array frequency coefficients a value of said one dimensional array frequency coefficient located at p=6;
assigns a two dimensional array frequency coefficient located at n=1 and m=3 in said corresponding four by four block of said two dimensional array frequency coefficients a value of said one dimensional array frequency coefficient located at p=7;
assigns a two dimensional array frequency coefficient located at n=2 and m=0 in said corresponding four by four block of said two dimensional array frequency coefficients a value of said one dimensional array frequency coefficient located at p=8;
assigns a two dimensional array frequency coefficient located at n=2 and m=1 in said corresponding four by four block of said two dimensional array frequency coefficients a value of said one dimensional array frequency coefficient located at p=9;
assigns a two dimensional array frequency coefficient located at n=2 and m=2 in said corresponding four by four block of said two dimensional array frequency coefficients a value of said one dimensional array frequency coefficient located at p=10;
assigns a two dimensional array frequency coefficient located at n=2 and m=3 in said corresponding four by four block of said two dimensional array frequency coefficients a value of said one dimensional array frequency coefficient located at p=11;
assigns a two dimensional array frequency coefficient located at n=3 and m=0 in said corresponding four by four block of said two dimensional array frequency coefficients a value of said one dimensional array frequency coefficient located at p=12;
assigns a two dimensional array frequency coefficient located at n=3 and m=1 in said corresponding four by four block of said two dimensional array frequency coefficients a value of said one dimensional array frequency coefficient located at p=13;
assigns a two dimensional array frequency coefficient located at n=3 and m=2 in said corresponding four by four block of said two dimensional array frequency coefficients a value of said one dimensional array frequency coefficient located at p=14; and
assigns a two dimensional array frequency coefficient located at n=3 and m=3 in said corresponding four by four block of said two dimensional array frequency coefficients a value of said one dimensional array frequency coefficient located at p=15.

152. The device of claim 151, wherein if said one dimensional array of one dimensional array frequency coefficients comprises 16 one dimensional array frequency coefficients at positions 0 through 15 in said one dimensional array, said two dimensional array of said two dimensional array frequency coefficients comprises four columns and four rows of said two dimensional array frequency coefficients and said number of groups of sixteen one dimensional array frequency coefficients comprises:
a first group comprising one dimensional array frequency coefficients at positions 0 through 15 in said one dimensional array.

153. The device of claim 152, wherein:
said first group's said corresponding four by four block of said two dimensional array frequency coefficients is a single four by four block comprising said all of said two dimensional array frequency coefficients in said two dimensional array.

154. The device of claim 151, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises four columns and eight rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

155. The device of claim 154, wherein:
said first group's said corresponding four by four block of said two dimensional array frequency coefficients is a top four by four block comprising the top four rows of said two dimensional array frequency coefficients in said two dimensional array; and
said second group's said corresponding four by four block of said two dimensional array frequency coefficients is a bottom four by four block comprising the bottom four rows of said two dimensional array frequency coefficients in said two dimensional array.

156. The device of claim 151, wherein if said one dimensional array of said one dimensional array frequency coefficients comprises 32 one dimensional array frequency coefficients at positions 0 through 31 in said one dimensional array, said two dimensional array of said two dimensional array frequency coefficients comprises eight columns and four rows of said two dimensional array frequency coefficients and said number of groups of sixteen one dimensional array frequency coefficients comprises:
a first group comprising one dimensional array frequency coefficients at positions 0 through 15 in said one dimensional array; and
a second group comprising one dimensional array frequency coefficients at positions 16 through 31 in said one dimensional array.

157. The device of claim 156, wherein:
said first group's said corresponding four by four block of said two dimensional array frequency coefficients is a left four by four block comprising the left-most four columns of said two dimensional array frequency coefficients in said two dimensional array; and
said second group's said corresponding four by four block of said two dimensional array frequency coefficients is a right four by four block comprising the right-most four columns of said two dimensional array frequency coefficients in said two dimensional array.

158. The device of claim 151, wherein if said one dimensional array of said one dimensional array frequency coefficients comprises 64 one dimensional array frequency coefficients at positions 0 through 63 in said one dimensional array, said two dimensional array of said two dimensional array frequency coefficients comprises eight columns and eight rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array; and
a fourth group comprising one dimensional array frequency coefficients at positions 48 through 63 in said one dimensional array.

159. The device of claim 158, wherein:
said first group's said corresponding four by four block of said two dimensional array frequency coefficients is a top-left four by four block comprising said two dimensional array frequency coefficients in both the top four rows and in the left-most four columns of said two dimensional array;
said second group's said corresponding four by four block of said two dimensional array frequency coefficients is a top-right four by four block comprising said two dimensional array frequency coefficients in both the top four rows and in the right-most four columns of said two dimensional array;
said third group's said corresponding four by four block of said two dimensional array frequency coefficients is a bottom-left four by four block comprising said two dimensional array frequency coefficients in both the bottom four rows and in the left-most four columns of said two dimensional array; and said fourth group's said corresponding four by four block of said two dimensional array frequency coefficients is said bottom-right four by four block comprising said two dimensional array frequency coefficients in both the bottom four rows and in the right-most four columns of said two dimensional array.

160. The device of claim 151, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31, in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

161. The device of claim 160, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the right-most four columns of said two dimensional array;
said third group's said corresponding four by four block of said two dimensional array frequency coefficients is a third four by four block comprising said two dimensional array frequency coefficients in both the fourth through seventh from the top of said two dimensional array and in the left-most four columns of said two dimensional array;
said fourth group's said corresponding four by four block of said two dimensional array frequency coefficients is a fourth four by four block comprising said two dimensional array frequency coefficients in both the fourth through seventh rows from the top of said two dimensional array and in the right-most four columns of said two dimensional array;
said fifth group's said corresponding four by four block of said two dimensional array frequency coefficients is a fifth four by four block comprising said two dimensional array frequency coefficients in both the eighth through eleventh rows from the top of said two dimensional array and in the left-most four columns of said two dimensional array;
said sixth group's said corresponding four by four block of said two dimensional array frequency coefficients is a sixth four by four block comprising said two dimensional array frequency coefficients in both the eighth through eleventh rows from the top of said two dimensional array and in the right-most four columns of said two dimensional array;
said seventh group's said corresponding four by four block of said two dimensional array frequency coefficients is a seventh four by four block comprising said two dimensional array frequency coefficients in both the bottom four rows and in the left-most four columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

162. The device of claim 15 1, wherein if said one dimensional array of said one dimensional array frequency coefficients comprises 128 one dimensional array frequency coefficients at positions 0 through 127 in said one dimensional array, said two dimensional array of said two dimensional array frequency coefficients comprises eight columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array; and
an eighth group comprising one dimensional array frequency coefficients at positions 112 through 127 in said one dimensional array.

163. The device of claim 162, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the bottom four rows and in the first four columns of said two dimensional array;
said fourth group's said corresponding four by four block of said two dimensional array frequency coefficients is a fourth four by four block comprising said two dimensional array frequency coefficients in both the bottom four rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the bottom four rows and in the eighth through eleventh columns of said two dimensional array; and
said eighth group's said corresponding four by four block of said two dimensional array frequency coefficients is an eighth four by four block comprising said two dimensional array frequency coefficients in both the bottom four rows and in the right-most four columns of said two dimensional array.

164. The device of claim 151, wherein if said one dimensional array of said one dimensional array frequency coefficients comprises 256 one dimensional array frequency coefficients at positions 0 through 255 in said one dimensional array, said two dimensional array of said two dimensional array frequency coefficients comprises sixteen columns and sixteen rows of said two dimensional array frequency coefficients and said number of groups of sixteen one dimensional array frequency coefficients comprises:
a first group comprising one dimensional array frequency coefficients at positions 0 through 15 in said one dimensional array;
a second group comprising one dimensional array frequency coefficients at positions 16 through 31 in said one dimensional array;
a third group comprising one dimensional array frequency coefficients at positions 32 through 47 in said one dimensional array;
a fourth group comprising one dimensional array frequency coefficients at positions 48 through 63 in said one dimensional array;
a fifth group comprising one dimensional array frequency coefficients at positions 64 through 79 in said one dimensional array;
a sixth group comprising one dimensional array frequency coefficients at positions 80 through 95 in said one dimensional array;
a seventh group comprising one dimensional array frequency coefficients at positions 96 through 111 in said one dimensional array;
an eighth group comprising one dimensional array frequency coefficients at positions 112 through 127 in said one dimensional array;
a ninth group comprising one dimensional array frequency coefficients at positions 128 through 143 in said one dimensional array;
a tenth group comprising one dimensional array frequency coefficients at positions 144 through 159 in said one dimensional array;
an eleventh group comprising one dimensional array frequency coefficients at positions 160 through 175 in said one dimensional array;
a twelfth group comprising one dimensional array frequency coefficients at positions 176 through 191 in said one dimensional array;
a thirteenth group comprising one dimensional array frequency coefficients at positions 192 through 207 in said one dimensional array;
a fourteenth group comprising one dimensional array frequency coefficients at positions 208 through 223 in said one dimensional array;
a fifteenth group comprising one dimensional array frequency coefficients at positions 224 through 239 in said one dimensional array; and
a sixteenth group comprising one dimensional array frequency coefficients at positions 240 through 255 in said one dimensional array.

165. The device of claim 164, wherein:
said first group's said corresponding four by four block of said two dimensional array frequency coefficients is a first four by four block comprising said two dimensional array frequency coefficients in both the top four rows and in the left-most four columns of said two dimensional array;
said second group's said corresponding four by four block of said two dimensional array frequency coefficients is a second four by four block comprising said two dimensional array frequency coefficients in both the top four rows and in the fourth through seventh columns of said two dimensional array;
said third group's said corresponding four by four block of said two dimensional array frequency coefficients is a third four by four block comprising said two dimensional array frequency coefficients in both the fourth through seventh rows four rows and in the first four columns of said two dimensional array;
said fourth group's said corresponding four by four block of said two dimensional array frequency coefficients is a fourth four by four block comprising said two dimensional array frequency coefficients in both the fourth through seventh rows and in the fourth through seventh columns of said two dimensional array;
said fifth group's said corresponding four by four block of said two dimensional array frequency coefficients is a fifth four by four block comprising said two dimensional array frequency coefficients in both the top four rows and in the eighth through eleventh columns of said two dimensional array;
said sixth group's said corresponding four by four block of said two dimensional array frequency coefficients is a sixth four by four block comprising said two dimensional array frequency coefficients in both the top four rows and in the right-most four columns of said two dimensional array;
said seventh group's said corresponding four by four block of said two dimensional array frequency coefficients is a seventh four by four block comprising said two dimensional array frequency coefficients in both the fourth through seventh rows and in the eighth through eleventh columns of said two dimensional array;
said eighth group's said corresponding four by four block of said two dimensional array frequency coefficients is an eighth four by four block comprising said two dimensional array frequency coefficients in both the fourth through seventh rows and in the right-most four columns of said two dimensional array;
said ninth group's said corresponding four by four block of said two dimensional array frequency coefficients is a ninth four by four block comprising said two dimensional array frequency coefficients in the eighth through eleventh rows and in the left-most four columns of said two dimensional array;
said tenth group's said corresponding four by four block of said two dimensional array frequency coefficients is a tenth four by four block comprising said two dimensional array frequency coefficients in both the eighth through eleventh rows and in the fourth through seventh columns of said two dimensional array;
said eleventh group's said corresponding four by four block of said two dimensional array frequency coefficients is an eleventh four by four block comprising said two dimensional array frequency coefficients in the bottom four rows and in the first four columns of said two dimensional array;
said twelfth group's said corresponding four by four block of said two dimensional array frequency coefficients is a twelfth fourth four by four block comprising said two dimensional array frequency coefficients in both the bottom four rows and in the fourth through seventh columns of said two dimensional array;
said thirteenth group's said corresponding four by four block of said two dimensional array frequency coefficients is a thirteenth four by four block comprising said two dimensional array frequency coefficients in both the eighth through eleventh rows and in the eighth through eleventh columns of said two dimensional array;
said fourteenth group's said corresponding four by four block of said two dimensional array frequency coefficients is a fourteenth four by four block comprising said two dimensional array frequency coefficients in both the eighth through eleventh rows and in the right-most four columns of said two dimensional array;
said fifteenth group's said corresponding four by four block of said two dimensional array frequency coefficients is a fifteenth four by four block comprising said two dimensional array frequency coefficients in both the bottom four rows and in the eighth through eleventh columns of said two dimensional array;
said sixteenth group's said corresponding four by four block of said two dimensional array frequency coefficients is a sixteenth four by four block comprising said two dimensional array frequency coefficients in both the bottom four rows and in the right-most four columns of said two dimensional array.

166. A system of transform-based encoding of digital video content, said digital video content comprising a stream of pictures, slices, or macroblocks in the form of blocks of pixels, each of said blocks of pixels having a corresponding two dimensional array of two dimensional array frequency coefficients, wherein, for each of said blocks, said system comprises:
means for scanning said two dimensional array frequency coefficients in each of a number of four by four blocks with a pre-determined scanning order, said number of four by four blocks each comprising 4 columns and 4 rows of said two dimensional array frequency coefficients, said scanning order sequentially starting at 0 and ending at 15; and
producing a one dimensional array of one dimensional array frequency coefficients.

167. The system of claim 166, further comprising means for dividing said two dimensional array of said two dimensional array frequency coefficients into said number of four by four blocks of two dimensional array frequency coefficients.

168. The system of claim 167, further comprising:
means for representing said columns of said number of four by four blocks with a variable n=0, 1, 2, or 3, wherein n=0 is at least one of a first or leftmost column, n=1 is a second column, n=2 is a third column, and n=3 is at least one of a fourth or rightmost column; and
means for representing said rows of said number of four by four blocks with a variable m=0, 1, 2, or 3, wherein m=0 is at least one of a first or top row, m=1 is a second row, m=2 is a third row, and m=3 is at least one of a fourth or bottom row.

169. The system of claim 168, wherein said one dimensional array comprises a number of groups of sixteen one dimensional array frequency coefficients, said number of groups corresponding to said number of said four by four blocks of said two dimensional array frequency coefficients, wherein said sixteen one dimensional array frequency coefficients in each of said groups are represented with a variable p=0, 1, 2, 3, 4, 5, 6, 7, 8, 9, 10, 11, 12, 13, 14, 15, in a numerical sequential order, wherein a first one dimensional array frequency coefficient in said each of said groups is represented by p=0 and a sixteenth one dimensional array frequency coefficient in said each of said groups is represented by p=15.

170. The system of claim 169, wherein if said block of pixels is to be encoded in frame mode, said step of scanning said two dimensional array frequency coefficients in each of said number of four by four blocks comprises:
means for assigning a scanning order=0 to a two dimensional array frequency coefficient located at n=0 and m=0;
means for assigning a scanning order=1 to a two dimensional array frequency coefficient located at n=1 and m=0;
means for assigning a scanning order=2 to a two dimensional array frequency coefficient located at n=0 and m=1;
means for assigning a scanning order=3 to a two dimensional array frequency coefficient located at n=0 and m=2;
means for assigning a scanning order=4 to a two dimensional array frequency coefficient located at n=1 and m=1;
means for assigning a scanning order=5 to a two dimensional array frequency coefficient located at n=2 and m=0;
means for assigning a scanning order=6 to a two dimensional array frequency coefficient located at n=3 and m=0;
means for assigning a scanning order=7 to a two dimensional array frequency coefficient located at n=2 and m=1;
means for assigning a scanning order=8 to a two dimensional array frequency coefficient located at n=1 and m=2;
means for assigning a scanning order=9 to a two dimensional array frequency coefficient located at n=0 and m=3;
means for assigning a scanning order=10 to a two dimensional array frequency coefficient located at n=1 and m=3;
means for assigning a scanning order=11 to a two dimensional array frequency coefficient located at n=2 and m=2;
means for assigning a scanning order=12 to a two dimensional array frequency coefficient located at n=3 and m=1;
means for assigning a scanning order=13 to a two dimensional array frequency coefficient located at n=3 and m=2;
means for assigning a scanning order=14 to a two dimensional array frequency coefficient located at n=2 and m=3; and
means for assigning a scanning order=15 to a two dimensional array frequency coefficient located at n=3 and m=3.

171. The system of claim 170, wherein said step of scanning said two dimensional array frequency coefficients in each of said number of four by four blocks further comprises:
means for assigning a one dimensional array frequency coefficient located at p=0 in a corresponding group of sixteen one dimensional array frequency coefficients a value of said two dimensional array frequency coefficient located at n=0 and m=0.
means for assigning a one dimensional array frequency coefficient located at p=1 in said corresponding group of sixteen one dimensional array frequency coefficients a value of said two dimensional array frequency coefficient located at n=1 and m=0;
means for assigning a one dimensional array frequency coefficient located at p=2 in said corresponding group of sixteen one dimensional array frequency coefficients a value of said two dimensional array frequency coefficient located at n=0 and m=1;
means for assigning a one dimensional array frequency coefficient located at p=3 in said corresponding group of sixteen one dimensional array frequency coefficients a value of said two dimensional array frequency coefficient located at n=0 and m=2;
means for assigning a one dimensional array frequency coefficient located at p=4 in said corresponding group of sixteen one dimensional array frequency coefficients a value of said two dimensional array frequency coefficient located at n=1 and m=1;
means for assigning a one dimensional array frequency coefficient located at p=5 in said corresponding group of sixteen one dimensional array frequency coefficients a value of said two dimensional array frequency coefficient located at n=2 and m=0;
means for assigning a one dimensional array frequency coefficient located at p=6 in said corresponding group of sixteen one dimensional array frequency coefficients a value of said two dimensional array frequency coefficient located at n=3 and m=0;
means for assigning a one dimensional array frequency coefficient located at p=7 in said corresponding group of sixteen one dimensional array frequency coefficients a value of said two dimensional array frequency coefficient located at n=2 and m=1;
means for assigning a one dimensional array frequency coefficient located at p=8 in said corresponding group of sixteen one dimensional array frequency coefficients a value of said two dimensional array frequency coefficient located at n=1 and m=2;
means for assigning a one dimensional array frequency coefficient located at p=9 in said corresponding group of sixteen one dimensional array frequency coefficients a value of said two dimensional array frequency coefficient located at n=0 and m=3;
means for assigning a one dimensional array frequency coefficient located at p=10 in said corresponding group of sixteen one dimensional array frequency coefficients a value of said two dimensional array frequency coefficient located at n=1 and m=3;
means for assigning a one dimensional array frequency coefficient located at p=11 in said corresponding group of sixteen one dimensional array frequency coefficients a value of said two dimensional array frequency coefficient located at n=2 and m=2;
means for assigning a one dimensional array frequency coefficient located at p=12 in said corresponding group of sixteen one dimensional array frequency coefficients a value of said two dimensional array frequency coefficient located at n=3 and m=1;
means for assigning a one dimensional array frequency coefficient located at p=13 in said corresponding group of sixteen one dimensional array frequency coefficients a value of said two dimensional array frequency coefficient located at n=3 and m=2;
means for assigning a one dimensional array frequency coefficient located at p=14 in said corresponding group of sixteen one dimensional array frequency coefficients a value of said two dimensional array frequency coefficient located at n=2 and m=3; and
means for assigning a one dimensional array frequency coefficient located at p=15 in said corresponding group of sixteen one dimensional array frequency coefficients a value of said two dimensional array frequency coefficient located at n=3 and m=3.

172. The system of claim 171, further comprising:
means for scanning each of said number of groups of sixteen one dimensional array frequency coefficients in said numerical sequential order, said scanning starting at p=0 and ending at p=15; and
means for producing said two dimensional array of said two dimensional array frequency coefficients.

173. The system of claim 172, wherein, for each of said number of groups of sixteen one dimensional array frequency coefficients, said step of scanning said each of said number of groups of sixteen one dimensional array frequency coefficients further comprises:
means for assigning a two dimensional array frequency coefficient located at n=0 and m=0 in a corresponding four by four block of said two dimensional array frequency coefficients a value of said one dimensional array frequency coefficient located at p=0;
means for assigning a two dimensional array frequency coefficient located at n=1 and m=0 in said corresponding four by four block of said two dimensional array frequency coefficients a value of said one dimensional array frequency coefficient located at p=1;
means for assigning a two dimensional array frequency coefficient located at n=0 and m=1 in said corresponding four by four block of said two dimensional array frequency coefficients a value of said one dimensional array frequency coefficient located at p=2;
means for assigning a two dimensional array frequency coefficient located at n=0 and m=2 in said corresponding four by four block of said two dimensional array frequency coefficients a value of said one dimensional array frequency coefficient located at p=3;
means for assigning a two dimensional array frequency coefficient located at n=1 and m=1 in said corresponding four by four block of said two dimensional array frequency coefficients a value of said one dimensional array frequency coefficient located at p=4;
means for assigning a two dimensional array frequency coefficient located at n=2 and m=0 in said corresponding four by four block of said two dimensional array frequency coefficients a value of said one dimensional array frequency coefficient located at p=5;
means for assigning a two dimensional array frequency coefficient located at n=3 and m=0 in said corresponding four by four block of said two dimensional array frequency coefficients a value of said one dimensional array frequency coefficient located at p=6;
means for assigning a two dimensional array frequency coefficient located at n=2 and m=1 in said corresponding four by four block of said two dimensional array frequency coefficients a value of said one dimensional array frequency coefficient located at p=7;
means for assigning a two dimensional array frequency coefficient located at n=1 and m=2 in said corresponding four by four block of said two dimensional array frequency coefficients a value of said one dimensional array frequency coefficient located at p=8;
means for assigning a two dimensional array frequency coefficient located at n=0 and m=3 in said corresponding four by four block of said two dimensional array frequency coefficients a value of said one dimensional array frequency coefficient located at p=9;
means for assigning a two dimensional array frequency coefficient located at n=1 and m=3 in said corresponding four by four block of said two dimensional array frequency coefficients a value of said one dimensional array frequency coefficient located at p=10;
means for assigning a two dimensional array frequency coefficient located at n=2 and m=2 in said corresponding four by four block of said two dimensional array frequency coefficients a value of said one dimensional array frequency coefficient located at p=11;
means for assigning a two dimensional array frequency coefficient located at n=3 and m=1 in said corresponding four by four block of said two dimensional array frequency coefficients a value of said one dimensional array frequency coefficient located at p=12;
means for assigning a two dimensional array frequency coefficient located at n=3 and m=2 in said corresponding four by four block of said two dimensional array frequency coefficients a value of said one dimensional array frequency coefficient located at p=13;
means for assigning a two dimensional array frequency coefficient located at n=2 and m=3 in said corresponding four by four block of said two dimensional array frequency coefficients a value of said one dimensional array frequency coefficient located at p=14; and
means for assigning a two dimensional array frequency coefficient located at n=3 and m=3 in said corresponding four by four block of said two dimensional array frequency coefficients a value of said one dimensional array frequency coefficient located at p=15.
